(19) United States
(12) Patent Application Publication
(10) Pub. No.: US 2014/0222873 A1
(43) Pub. Date: Aug. 7, 2014

(54) INFORMATION SYSTEM, MANAGEMENT APPARATUS, METHOD FOR PROCESSING DATA, DATA STRUCTURE, PROGRAM, AND RECORDING MEDIUM

(71) Applicant: NEC CORPORATION, Tokyo (JP)

(72) Inventor: Shinji Nakadai, Tokyo (JP)

(73) Assignee: NEC CORPORATION, Tokyo (JP)

(21) Appl. No.: 14/347,627

(22) PCT Filed: Sep. 26, 2012
(86) PCT No.: PCT/JP2012/006149

§ 371 Date: Mar. 26, 2014

(30) Foreign Application Priority Data
Sep. 27, 2011 (JP) 2011-211132

(51) Int. Cl. G06F 17/30

(52) U.S. Cl. CPC G06F 17/30339
USPC 707/803

(57) ABSTRACT

An information system (1) includes a plurality of data storage servers (106) that manage a data constellation in a distributed manner, the plurality of data storage servers (106) respectively having destination addresses, a destination table management unit (400) that assigns a logical identifier to each of the data storage servers (106) on a logical identifier space, correlate a range of values of data in the data constellation with the logical identifier space, and determines a range of the data of each data storage server (106) in correlation with the logical identifier of each data storage server (106), and a destination resolving unit (340) that obtains the logical identifier corresponding to a range of the data which matches an attribute value on the basis of a correspondence relation among the range of the data, the logical identifier, and the destination address of each data storage server (106), and determines the destination address of the data storage server (106) corresponding to the logical identifier as a destination.

### TECHNICAL FIELD

The present invention relates to an information system, a management apparatus, a method for processing data, a data structure, a program, and a recording medium, and particularly to an information system in which a plurality of computers manage data in a distributed manner, a management apparatus which manages the data, a method for processing data, a data structure, a program, and a recording medium.

### BACKGROUND ART

Non-Patent Document 1 discloses an example of a retrieval processing method of data which is distributed to a plurality of computers. A system disclosed in Non-Patent Document 1 divides and stores data in accordance with a range of attribute values of the data in a highly scalable unshared database. Accordingly, this system can perform range retrieval or the like. In addition, the system determines storage destination information on the basis of the attribute values of the data when the data is stored.

Parallel B-tree disclosed therein uses B-tree, typically used for destination management when a single computer accesses internal data thereof, for destination management when accessing data distributed to a plurality of computers. Types thereof include Copy Whole B-tree (CWB) in which all computers accessing data have the same B-tree, Single Index B-tree (SIB) in which only a single computer has overall B-tree, and Fat-Btree positioned therebetween. In Fat-Btree, as for data close to a root of a tree structure, a plurality of computers have the same B-tree in the same manner as in CWB. In addition, as for data close to a leaf, each computer has only an index page including an access path to a leaf page which is uniformly distributed to the respective computers.

A computer which manages the data close to the root stores attribute values for determining separations of an attribute value space and destinations of other computers for the space. A client computer which accesses data first selects any one of computers which manage the root. In addition, the client computer sequentially draws destination information from an attribute value or attribute range of a search target, and thus can reach a computer which manages the leaf.

Further, in the system disclosed in Non-Patent Document 1, since B-tree is operated to balance the tree structure depending on registered data, the tree structure is changed due to registration of new data, and thus an update of B-tree is necessary. For this reason, in a case of CWB, a plurality of other computers are required to update this change of information, and thus a load increases. On the other hand, in a case of SIB, since a single computer holds B-tree, the update of B-tree may be performed only by a single computer, and thus an update load is small. However, all computers which intend to acquire data access a single computer, and thus the access concentrates on the single computer, thereby increasing a load thereon.

As an example of a system which manages data distributed to a plurality of computers, Chord and Koorde which are representative algorithms of a Distributed Hash Table (DHT) are respectively disclosed in Non-Patent Document 2 and Non-Patent Document 3. The DHT uniformizes data between respective nodes by using a hash function. However, in compensation therefor, the DHT is a structured Peer-To-Peer (P2P) in which retrieval such as range retrieval cannot be performed. In addition, as the structured P2P excluding the DHT, there are systems (Non-Patent Documents 4 and 5), which will be described later, in which range retrieval can be performed.

In the above-described parallel B-tree, since the tree structure forming data search paths is correlated with a plurality of computers without change, and the respective computers play different roles, a bias of a load occurs due to the different roles. However, in the structured P2P, the respective computers play substantially the same role, and thus can be operated so that a load is not biased to a specific computer.

Here, a computer which plays a similar role is set as a node. A single computer may play a role of a plurality of similar nodes. There are various methods of ensuring no bias in the structured P2P, and a bias problem or adaptability is different depending on each method. Features of the structured P2P constituted by the similar computers as above include an aspect of correlating a computer storing data with stored data, and an aspect of sending an access request for data to a computer which stores the data.

First, a description will be made of the aspect of correlating a node with data in the former related to the features of the structured P2P. Generally, in the DHT, each node has a value in a finite identifier (ID) space as a logical identifier ID (a destination, an address, or an identifier), and a range in the ID space of data managed by the node is determined on the basis of the ID. An ID of a node which manages data can be obtained using a hash value of data which is desired to be registered or acquired in the DHT. In addition, load distribution is generally achieved by using a hash value of a unique identifier (for example, an IP address and a port) which is attached to the node at random or in advance as an ID of each node. The ID space includes a method of using a ring type, a method of using a hypercube, and the like. Chord, Koorde, and the like described above use the ID space of the method of using the ring type.

In a case of using the ring type, a method of correlating a node with data is called consistent hashing. In the consistent hashing, the ID space has one-dimensional [0,2^{m}) by using any natural number m, and each computer i has a value xi in this ID space as an ID. Here, i is a natural number up to the number N of nodes, and is identified in an order of xi. In addition, the symbol “[” or the symbol “]” indicates a closed interval, and the symbol “(” or the symbol “)” indicates an open interval.

In this case, the node i manages data included in [xi, x(i+1)). However, a computer of i=N manages data included in [0, x0) and [xN, 2^{m}).

Next, a description will be made of the latter aspect related to the features of the structured P2P, that is, the aspect of sending an access request to a computer which stores data. A size (order) of a destination table held by each computer and the number of times (the number of hops) of performing transfer are important indexes in evaluating the performance of an algorithm. The destination table held by each computer is a table of addresses (IP addresses) for communication with other computers. If any node intends to access any data without performing transfer, a destination table of each node is required to include a table of destinations to all of the other nodes. This method is referred to as full mesh in the present specification.

In Chord, both of the order and the number of hops are O(log N) for the number N of nodes. In other words, for the number N of nodes, the order and the number of hops substantially follow a logarithmic function, and thus increases (deterioration) in the order and the number of hops are gradually reduced even if N is increased.

On the other hand, in Koorde, when the order is O(1), the number of hops is O(log N), and when the order is O(log N), the number of hops is O(log N/log log N). The order of O(1) indicates that the order is constant regardless of the number N of nodes. This difference in the order and the number of hops of Chord and Koorde occurs due to a method of a certain node constructing a destination table and a method of transferring an access request for data.

In addition, in both of Chord and Koorde, in relation to the method of constructing a destination table, an ID of a node which constructs the destination table is used, and it is determined whether or not another node which is a candidate of the destination table is registered in the destination table on the basis of a distance from the node. Further, in both of Chord and Koorde, in relation to the method of transferring a data access request, an ID calculated from a hash value of the data is used, and the next destination is determined by referring to the ID and the destination table.

In addition, examples of a destination management system of other data using the structured P2P are disclosed in the Non-Patent Document 4 and Patent Document 1. MAAN disclosed in Non-Patent Document 4 and a technique disclosed in Patent Document 1 relate to a structured P2P which allows range retrieval to be performed. In MAAN, an attribute value of data which is an access target is converted into an ID by using distribution information regarding the data. Further, a destination to which an access request to the data is transferred is determined by referring to the ID and a destination table. Each computer builds a transmission and reception relation on the basis of the ID.

Furthermore, an example of a destination management system of other data is disclosed in Non-Patent Document 5. In a system called Mercury disclosed in Non-Patent Document 5, a transmission and reception relation among a computer which is a destination storing data and other computers is built using an attribute value of the data.

In summary, it is considered that the structured P2P has the following two approaches for achieving the range retrieval.

As for the first approach, a system determines which of the other nodes is stored in a destination table managed by own node (builds a transmission and reception relation) on the basis of a range of attributes of data stored in the node. The system refers to an attribute value of requested data and the destination table when determining a destination of an access request to the data, and transfers the access request to the data to the determined destination.

As for the second approach, the system determines which of the other nodes is stored in a destination table managed by own node (builds a transmission and reception relation) on the basis of an ID of the node, and determines a destination of an access request for data by referring to a value obtained by converting an attribute value of the data into an ID space, and the destination table.

The first approach includes P-Tree, P-Grid, Squid, PRoBe, and the like in addition to Mercury. The second approach includes PriMA KeyS, NL-DHT, in addition to MAAN.

In addition, Patent Document 2 discloses a distributed database system in which each record of data is divided into a plurality of records which are stored in a plurality of storage devices (first processors). In this system, a range, in which key values of all the records of table data which forms data are distributed, is divided into a plurality of sections. In this case, the number of records in each section is made the same, and a plurality of first processors are respectively assigned to a plurality of sections. A central processor accesses the first processor. The key values of the plurality of records of each part of a database held by the first processor and information indicating a storage location of the record are transferred to a second processor assigned with the section of the key value to which each record belongs.

In addition, the key value of the record held thereby and information indicating a storage location of the record are transferred to the first processor assigned with the section to which the key value belongs. The second processor sorts the plurality of transferred key values, and generates a key value table in which the information indicating the storage location of the record which is received together with the sorted key value is registered, as a sorting result. With the configuration, in the system disclosed in Patent Document 2, efficiency of a sorting process in the distributed database system is improved by reducing a burden on the central processor which accesses the first processor.

### RELATED DOCUMENT

### Patent Document

[Patent Document 1] Japanese Unexamined Patent Publication No. 2008-234563
[Patent Document 2] Japanese Unexamined Patent Publication No. H5-242049

### Non-Patent Document

[Non-Patent Document 1] Yuta NAMIKI, and three others, “Distributed Retrieval on PostgreSQL with a Fat-Btree Index”, The Database Society of Japan, 2007, Letters Vol. 6, No. 2, p. 61 to 64
[Non-Patent Document 2] Ion Stoica, and four others, “Chord: A Scalable Peer-to-peer Lookup Service for Internet Applications”, Proceedings of SIGCOMM'01, USA, ACM Press New York, 2001, p. 1 to 12
[Non-Patent Document 3] M. Frans Kaashoek, and one other, “Koorde: A simple degree-optimal distributed hash table”, Proceedings in 2nd International Peer to Peer Systems Workshop IPTPS (2003), 2003, vol. 2735, p. 98 to 107
[Non-Patent Document 4] Min Cai, and three others, “MAAN: A Multi-Attribute Addressable Network for Grid Information Services”, Proceedings of the Fourth International Workshop on Grid Computing (GRID'03), 2003, p. 1 to 8
[Non-Patent Document 5] Ashwin R. Bharambe, and two others, “Mercury: Supporting Scalable Multi-Attribute Range Queries”, SIGCOMM (Special Interest Group on Data Communication) 2004 Conference Papers, USA, 2004, p. 353 to 366

### DISCLOSURE OF THE INVENTION

In the above-described system disclosed in Patent Document 2, in a case where a distribution of records stored in the first processors changes over time, and thus a load on each processor changes, it is considered that the first processor is installed more or stops being used. In this case, there is a problem in that the records are required to be moved between almost all the first processors in the entire database in order to uniformize the number of records in the plurality of processors, and thus the records are frequently moved.

In addition, in the destination management method related to the above-described first approach, in a case where a destination table is changed in order to change a range of data stored in a node, there is a problem in that an update (changing in a transmission and reception relation between nodes) of the destination table in each node or an accompanying process for maintaining communication reachability is necessary, and there are high probabilities that a necessary process may be required to be temporarily stopped during changing of a communication path, and the changing may be treated as a communication path failure.

The reason is as follows. If data is registered in a plurality of nodes, a distribution of the data varies. In addition, in a case where a range is changed so that data between the nodes is distributed in a nearly uniform data amount in accordance with the variation in the distribution of the data, the destination table which stores which of the other nodes are to be connected is also required to be changed due to this change.

An object of the present invention is to provide a technique of realizing load distribution of each node while suppressing a load increase due to a movement of data even if there is a variation in a distribution of data in a system in which the data is divided into ranges.

According to the present invention, there is provided an information system which includes a plurality of nodes that manage a data constellation in a distributed manner, the plurality of nodes respectively having destination addresses being identifiable on a network; an identifier assigning unit that assigns logical identifiers to the plurality of nodes on a logical identifier space; a range determination unit that correlates a range of values of data in the data constellation with the logical identifier space, and determines a range of the data managed by each of the nodes in correlation with the logical identifier of each of the nodes; and a destination determination unit that obtains, when searching for a destination of a node which stores any data having any attribute value or the attribute range, a logical identifier corresponding to a range of the data which matches at least a part of the attribute value or the attribute range, on the basis of a correspondence relation among the range of the data, the logical identifier, and the destination address, with respect to each of the nodes, and determines the destination address of the node corresponding to the logical identifier as a destination.

According to the present invention, there is provided a method for processing data of a management apparatus which manages a plurality of nodes that manages a data constellation in a distributed manner, the plurality of nodes respectively having destination addresses being identifiable on a network, in which the method for processing data includes: assigning, the management apparatus, logical identifiers to the plurality of nodes on a logical identifier space; correlating, the management apparatus, a range of values of data in the data constellation with the logical identifier space, and determines a range of the data managed by each of the nodes in correlation with the logical identifier of each of the nodes; and obtaining, when searching for a destination of a node which stores any data having any attribute value or any attribute range, a logical identifier corresponding to a range of the data which matches at least a part of an attribute value or an attribute range, on the basis of a correspondence relation among the range of the data, the logical identifier, and the destination address, with respect to each of the nodes, and determine the destination address of the node corresponding to the logical identifier as a destination.

According to the present invention, there is provided a data structure of a destination table which is referred to when determining destinations of a plurality of nodes which manage a data constellation in a distributed manner, in which the plurality of nodes respectively have destination addresses being identifiable on a network, in which the destination table includes correspondence relations among destination addresses of the plurality of nodes which manage the data constellation in a distributed manner, logical identifiers assigned to the respective nodes on a logical identifier space, and ranges of values of data managed by the respective nodes, in which the destination table includes correspondence relations between destination addresses of the plurality of nodes which manage the data constellation in a distributed manner, logical identifiers assigned to the respective nodes on a logical identifier space, and ranges of data managed by the respective nodes, and in which, in relation to the ranges of the data of each of the nodes, a range of values of the data in the data constellation is correlated with the logical identifier space, and a range of the data corresponding to the logical identifier of each node is assigned to each node.

According to the present invention, there is provided a program for a computer realizing a management apparatus which manages a plurality of nodes that manage a data constellation in a distributed manner, the plurality of nodes respectively having destination addresses being identifiable on a network, in which the program causes the computer to execute: a procedure for assigning logical identifiers to the plurality of nodes on a logical identifier space; a procedure for correlating a range of values of data in the data constellation with the logical identifier space so as to determine a range of the data managed by each of the nodes in correlation with the logical identifier of each node; and a procedure for obtaining, when searching for a destination of a node which stores any data having any attribute value or the attribute range, a logical identifier corresponding to the range of the data which matches at least a part of the attribute value or the attribute range, on the basis of a correspondence relation among the range of the data, the logical identifier, and the destination address, with respect to each of the nodes so as to determine the destination address of the node corresponding to the logical identifier as a destination.

According to the present invention, there is provided a computer readable program recording medium recording the program thereon.

According to the present invention, there is provided a management apparatus which manages a plurality of nodes that manage a data constellation in a distributed manner, the plurality of nodes respectively having destination addresses being identifiable on a network, in which the management apparatus includes an identifier assigning unit that assigns logical identifiers to the plurality of nodes on a logical identifier space; a range determination unit that correlates a range of values of data in the data constellation with the logical identifier space, and determines a range of the data managed by each of the nodes in correlation with the logical identifier of each of the nodes; and a destination determination unit that obtains, when searching for a destination of a node which stores any data having any attribute value or the attribute range, a logical identifier corresponding to a range of the data which matches at least a part of the attribute value or the attribute range, on the basis of a correspondence relation among the range of the data, the logical identifier, and the destination address, with respect to each of the nodes, and determines the destination address of the node corresponding to the logical identifier as a destination.

According to the present invention, there are provided an information system, a management apparatus, a method for processing data, a data structure, a program, and a recording medium, capable of realizing load distribution of each node while suppressing a load increase due to a movement of data even if there is a variation in a distribution of data in a system in which the data is divided into ranges.

In addition, any combination of the above constituent elements is effective as an aspect of the present invention, and conversion results of expressions of the present invention between a method, a device, a system, a recording medium, a computer program, and the like are also effective as an aspect of the present invention.

Further, various constituent elements of the present invention are not necessarily required to be present separately and independently, and may be one in which a single member is formed by a plurality of constituent elements, one in which a plurality of members form a single constituent element, one in which a certain constituent element is a part of another constituent element, one in which a part of a certain constituent element overlaps a part of another constituent element, and the like.

Furthermore, a plurality of procedures are sequentially described in the method and the computer program of the present invention, but the order of the description does not limit an order of a plurality of procedures to be executed. For this reason, in a case of performing the method and the computer program of the present invention, the order of the plurality of procedures may be changed within the scope without departing from the content thereof.

Moreover, a plurality of procedures of the method and the computer program of the present invention are not limited to being executed at different respective timings. For this reason, another procedure may occur during execution of a certain procedure, and an execution timing of a certain procedure may overlap a part of or the overall execution timing of another procedure.

### BRIEF DESCRIPTION OF THE DRAWINGS

The above-described object, and other objects, features and advantages will become apparent from preferred exemplary embodiments described below and the following accompanying drawings.

FIG. 1 is a functional block diagram illustrating a configuration of an information system according to an exemplary embodiment of the present invention.

FIG. 2 is a block diagram illustrating a configuration example of computers of the information system according to the exemplary embodiment of the present invention.

FIG. 3 is a block diagram illustrating a configuration example of computers of the information system according to the exemplary embodiment of the present invention.

FIG. 4 is a functional block diagram illustrating a configuration of the information system according to the exemplary embodiment of the present invention.

FIG. 5 is a block diagram illustrating a communication protocol stack between servers in a general purpose distributed system.

FIG. 6 is a block diagram illustrating a communication protocol stack between servers in the information system according to the exemplary embodiment of the present invention.

FIG. 7 is a functional block diagram illustrating a main part configuration of the information system according to the exemplary embodiment of the present invention.

FIG. 8 is a functional block diagram illustrating a main part configuration of the information system according to the exemplary embodiment of the present invention.

FIG. 9 is a diagram illustrating a data access sequence of the information system according to the exemplary embodiment of the present invention.

FIG. 10 is a diagram illustrating a data access sequence of the information system according to the exemplary embodiment of the present invention.

FIG. 11 is a diagram illustrating an ID destination table of the information system according to the exemplary embodiment of the present invention.

FIG. 12 is a diagram illustrating an attribute destination table of the information system according to the exemplary embodiment of the present invention.

FIG. 13 is a diagram illustrating a range table of the information system according to the exemplary embodiment of the present invention.

FIG. 14 is a diagram illustrating a notification destination table of the information system according to the exemplary embodiment of the present invention.

FIG. 15 is a flowchart illustrating an example of procedures of a smoothing process of the information system according to the exemplary embodiment of the present invention.

FIG. 16 is a flowchart illustrating an example of procedures of a load distribution plan calculation process of the information system according to the exemplary embodiment of the present invention.

FIG. 17 is a flowchart illustrating an example of procedures of a data access request reception process of the information system according to the exemplary embodiment of the present invention.

FIG. 18 is a flowchart illustrating a continuation of the procedures of the data access request reception process of FIG. 17.

FIG. 19 is a diagram illustrating an attribute value or an attribute range and a range of the information system according to the exemplary embodiment of the present invention.

FIG. 20 is a flowchart illustrating an example of procedures of a range autonomous update process of the attribute destination table of the information system according to the exemplary embodiment of the present invention.

FIG. 21 is a flowchart illustrating an example of procedures of a data adding or deleting process of the information system according to the exemplary embodiment of the present invention.

FIG. 22 is a flowchart illustrating an example of procedures of a data retrieval process of the information system according to the exemplary embodiment of the present invention.

FIG. 23 is a flowchart illustrating an example of procedures of a single destination resolving process of the information system according to the exemplary embodiment of the present invention.

FIG. 24 is a flowchart illustrating an example of procedures of an attribute range destination resolving process of the information system according to the exemplary embodiment of the present invention.

FIG. 25 is a flowchart illustrating an example of procedures of a single destination resolving process of an information system according to an exemplary embodiment of the present invention.

FIG. 26 is a flowchart illustrating a continuation of the procedure for the single destination resolving process of FIG. 25.

FIG. 27 is a flowchart illustrating an example of procedures of an attribute range destination resolving process of the information system according to the exemplary embodiment of the present invention.

FIG. 28 is a flowchart illustrating a continuation of the procedure for the attribute range destination resolving process of FIG. 27.

FIG. 29 is a flowchart illustrating an example of procedures of a finger entry destination resolving process of the information system according to the exemplary embodiment of the present invention.

FIG. 30 is a diagram illustrating an attribute destination table of an information system according to an exemplary embodiment of the present invention.

FIG. 31 is a flowchart illustrating an example of procedures of a range update process of the information system according to the exemplary embodiment of the present invention.

FIG. 32 is a flowchart illustrating an example of procedures of a range endpoint acquisition process of the information system according to the exemplary embodiment of the present invention.

FIG. 33 is a flowchart illustrating an example of procedures of a single destination resolving process of the information system according to the exemplary embodiment of the present invention.

FIG. 34 is a flowchart illustrating an example of procedures of a hierarchy range specifying process of the information system according to the exemplary embodiment of the present invention.

FIG. 35 is a flowchart illustrating an example of procedures of a range confirmation process of own node of the information system according to the exemplary embodiment of the present invention.

FIG. 36 is a flowchart illustrating an example of procedures of a destination search process of a finger node of the information system according to the exemplary embodiment of the present invention.

FIG. 37 is a flowchart illustrating an example of procedures of a range destination resolving process of the information system according to the exemplary embodiment of the present invention.

FIG. 38 is a flowchart illustrating an example of procedures of a range confirmation process of own node of the information system according to the exemplary embodiment of the present invention.

FIG. 39 is a flowchart illustrating an example of procedures of a range destination search process of a finger node of the information system according to the exemplary embodiment of the present invention.

FIG. 40 is a flowchart illustrating an example of procedures of a range confirmation process of a successor node of the information system according to the exemplary embodiment of the present invention.

FIG. 41 is a diagram illustrating changing of a range of data in each node of an information system in an example of the present invention.

FIG. 42 is a diagram illustrating changing of a range of data in each node of the information system in the example of the present invention.

FIG. 43 is a diagram illustrating changing of a range of data in each node of the information system in the example of the present invention.

FIG. 44 is a diagram illustrating changing of a range of data in each node of the information system in the example of the present invention.

FIG. 45 is a diagram illustrating changing of a range of data in each node of the information system in an example of the present invention.

FIG. 46 is a diagram illustrating changing of a range of data in each node of the information system in the example of the present invention.

FIG. 47 is a diagram illustrating changing of a range of data in each node of the information system in the example of the present invention.

FIG. 48 is a diagram illustrating a sequence of data access between respective nodes of the information system in the example of the present invention.

FIG. 49 is a diagram illustrating a hierarchy of the nodes of the information system in an example of the present invention.

FIG. 50 is a diagram illustrating a hierarchy of the nodes of the information system in the example of the present invention.

FIG. 51 is a diagram illustrating a hierarchy of the nodes of the information system in the example of the present invention.

FIG. 52 is a diagram illustrating changing of a range of multi-dimensional attribute data of each node of the information system in an example of the present invention.

FIG. 53 is a diagram illustrating changing of a range of multi-dimensional attribute data of each node of the information system in the example of the present invention.

FIG. 54 is a diagram illustrating changing of a range of multi-dimensional attribute data of each node of the information system in the example of the present invention.

FIG. 55 is a diagram illustrating changing of a range of multi-dimensional attribute data of each node of the information system in the example of the present invention.

FIG. 56 is a diagram illustrating changing of a range of multi-dimensional attribute data of each node of the information system in the example of the present invention.

FIG. 57 is a diagram illustrating an ID destination table of an information system according to an exemplary embodiment of the present invention.

FIG. 58 is a flowchart illustrating an example of an operation of a management apparatus of the information system according to the exemplary embodiment of the present invention.

FIG. 59 is a flowchart illustrating an example of an operation of the management apparatus of the information system according to the exemplary embodiment of the present invention.

FIG. 60 is a functional block diagram illustrating a configuration of a preprocessing unit of the information system according to the present exemplary embodiment.

FIG. 61 is a diagram illustrating an example of a space-filling curve server information table of the information system according to the exemplary embodiment of the present invention.

FIG. 62 is a functional block diagram illustrating a main part configuration of the information system according to the exemplary embodiment of the present invention.

FIG. 63 is a flowchart illustrating an example of an operation of the information system according to the exemplary embodiment of the present invention.

### DESCRIPTION OF EXEMPLARY EMBODIMENTS

Hereinafter, exemplary embodiments of the present invention will be described with reference to the drawings. In addition, throughout all the drawings, the same constituent elements are given the same reference numerals, and description thereof will not be repeated.

An information system of the present invention performs destination management during access to data which is distributed to and is stored in a plurality of nodes, and enables a data access process such as, for example, range retrieval which requires continuity and ordering, to be efficiently performed. In addition, the information system of the present invention can perform highly scalable destination management which allows access to data stored in a plurality of storage destinations, even if a storage destination is added.

In other words, the information system of the present invention can solve the above-described problem of reduction in performance or reliability due to a variation in a data distribution of a node.

### First Exemplary Embodiment

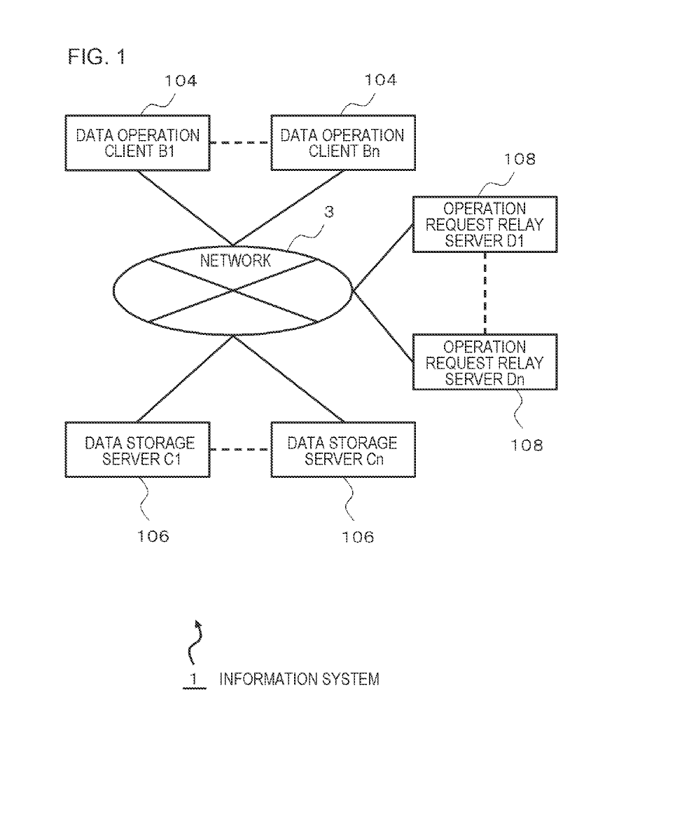

FIG. 1 is a block diagram illustrating a configuration of an information system 1 according to an exemplary embodiment of the present invention.

The information system 1 according to the exemplary embodiment of the present invention includes a plurality of computers which are connected to each other through a network 3, for example, a plurality of data operation clients 104 (in FIG. 1, indicated by data operation clients B1 to Bn in which n is hereinafter a natural number and may have different values in other kinds of computers), a plurality of data storage servers 106 (in FIG. 1, data storage servers C1 to Cn), and a plurality of operation request relay servers 108 (in FIG. 1, indicated by operation request relay servers D1 to Dn).

The data storage server 106 includes at least one node, and stores a data constellation in each node in a distributed manner. The data storage server 106 manages access to data stored in each node in response to a request from an application or a client. A destination which can be specified on the network, for example, an IP address is assigned to each node of the data storage server 106.

In addition, in a case where the information system 1 is used as not a database system but a data stream system or a Publish/Subscribe (Pub/Sub) system, not data itself but a conditional expression or the like is stored in the data storage server 106.

In this case, in the data stream, data may be treated as a range, and a conditional expression may be treated as a value. For example, if the number of dimensions of an attribute is D, a Subscribe conditional expression having a D-dimensional attribute range may be treated as data having a 2D-dimensional attribute value, and data having a D-dimensional attribute value may be treated as a 2D-dimensional attribute range. When data is registered, Subscribe conditional expressions which are 2D-dimensional attribute values and are included in a 2D-dimensional attribute range corresponding to the data are enumerated, and the conditional expressions are notified of the registration of the data. Alternatively, in a case where a Subscribe conditional expression is used as an attribute range, and data is treated as an attribute value, the attribute range may be divided so as to be stored in a plurality of nodes, and each attribute range may be further divided into the units of data storage unit (for example, a block or the like) in each node. In addition, the Subscribe attribute range may be stored in each block, when data in an attribute range is registered in a certain block, whether or not that data is included in the corresponding attribute range may be monitored and whether or not a notification thereof is sent may be determined.

The data operation client 104 includes at least one node, and receives a data access request from an application program or a user so as to operate data stored in the data storage server 106 in response to the request. The data operation client 104 has a function of specifying a node which stores access-requested target data.

The operation request relay server 108 includes at least one node, and has a function of transferring an access request received from the data operation client 104 between nodes and allowing the access request to arrive at a target node.

For example, the data storage server 106 which receives an access request for data which is not managed by own node functions as the operation request relay server 108.

In addition, in a case where an algorithm of a destination resolving unit, which will be described later, is an algorithm which does not perform transfer between nodes as in the DHT but performs communication in full mesh, the operation request relay server 108 is not necessary.

The information system 1 according to the present exemplary embodiment is realized by any combination of hardware and software of any computer which includes a central processing unit (CPU), a memory, a program loaded to the memory and realizing the constituent elements of each figure, and a storage unit such as a hard disk storing the program, and a network connection interface. In addition, it can be understood by those skilled in the art that a method and a device realizing the same may have various modifications.

Each drawing described below illustrates not a configuration in the hardware unit but a block in the function unit. Further, in each drawing, a configuration of a part which is not related to the essence of the present invention is not illustrated.

Further, each of the servers and clients forming the information system 1 according to the present exemplary embodiment may be a virtualized computer such as a virtual machine, or a server group such as cloud computing which provides a service to users over a network.

The information system 1 of the present invention is applicable to an application such as a database which provides data distributed to and stored in different computers as a table structure in which at least a one-dimensional attribute range can be retrieved, and provides a data access function to a variety of application software.

In a relational database which can be referred to and operated by a computer, there is a row (tuple) formed by a plurality of columns (attributes). In a case where the present exemplary embodiment is applied as a primary index, the present exemplary embodiment is applied to one or more attributes serving as a key of a row. In a case where the present exemplary embodiment is applied as a secondary index, the present exemplary embodiment is applied to one or more attributes other than the key of the row. These indexes are set in advance as a single index for a single attribute or composite indexes for a plurality of attributes, for fast retrieval of a designated column. Examples of a plurality of attributes include longitude and latitude, temperature and humidity, or a price, a manufacturer, a model number, the release date, a specification, and the like of a product.

In addition, the information system is also applicable to an application of a message transmission and reception form such as Pub/Sub for setting detection or notification of data occurrence by designating a condition regarding a range of one-dimensional or more attributes in relation to a message or an event transmitted to the distributed computers. Alternatively, the information system is also applicable to a data stream management system which models an occurring event as a row (tuple) formed by columns (attributes), and executes a continuous query for retrieval thereof.

As a form of using the information system 1 of the present exemplary embodiment as a relational database, there are a form of online transaction processing (OLTP) and a form of online analytical processing (OLAP). The form of OLTP is a use form in which, for example, a client accesses a shopping mall of a web site, and inputs a plurality of conditions for product retrieval, for example, a price range, the release date, and the like, thereby retrieving the corresponding product.

In addition, a frequency of retrieval requests or the like from clients to a web site is tens of thousands per second. On the other hand, the form of OLAP is a use form in which, for example, in order to grasp trends in sales from overall data stored by the OLTP in the past, a manager of a web site designates a plurality of conditions such as an age of a purchaser, a purchase price, and a purchase time period so as to acquire the number thereof. Further, the form of being used as Pub/Sub or the data stream management system is a use form in which, if a range of latitude and longitude, and the like of which a notification is desired to be received is designated, a notification can be received when data included in the attribute range is generated.

The information system 1 of the present exemplary embodiment can be used in a distributed environment which includes a plurality of computers (for example, the data storage servers 106 of FIG. 1) managing data having a one-dimensional or more attribute. In this environment, the information system 1 of the present exemplary embodiment may determine a destination as follows when a computer (the data storage server 106 or the operation request relay server 108) corresponding to a one-dimensional or more attribute value is determined. Alternatively, the information system 1 of the present exemplary embodiment may determine a destination when a plurality of computers (the data storage servers 106 or the operation request relay servers 108) are determined with respect to a space corresponding to a one-dimensional or more attribute in a case of range retrieval or the like.

First, an identifier (hereinafter, referred to as a logical identifier ID) which is unique in a finite logical identifier ID space is assigned in advance to a server (the data storage server 106) storing data. In addition, each server (the data storage server 106) performs data movement and range change with a server (the data storage server 106) having a close logical identifier ID, for load distribution of a data amount for each attribute. This range change is reflected in a destination table for each attribute, managed by other nodes, in accordance with transmission and reception dependencies between nodes determined on the basis of the logical identifier IDs of the nodes.

When a computer (the data storage server 106 or the operation request relay server 108) corresponding to an attribute value is determined, or a plurality of computers (the data storage servers 106 or the operation request relay servers 108) corresponding to an attribute space are determined, the determination may be performed by referring to the destination table for each attribute. Accordingly, a load is not biased to a specific computer (the data storage server 106) even if a distribution of data varies. In addition, it is possible to uniformly store data in the computers (the data storage servers 106) in order of attribute values without increasing the degree which is the number of transmission and reception relations formed between nodes. Therefore, it is possible to perform flexible retrieval such as range retrieval.

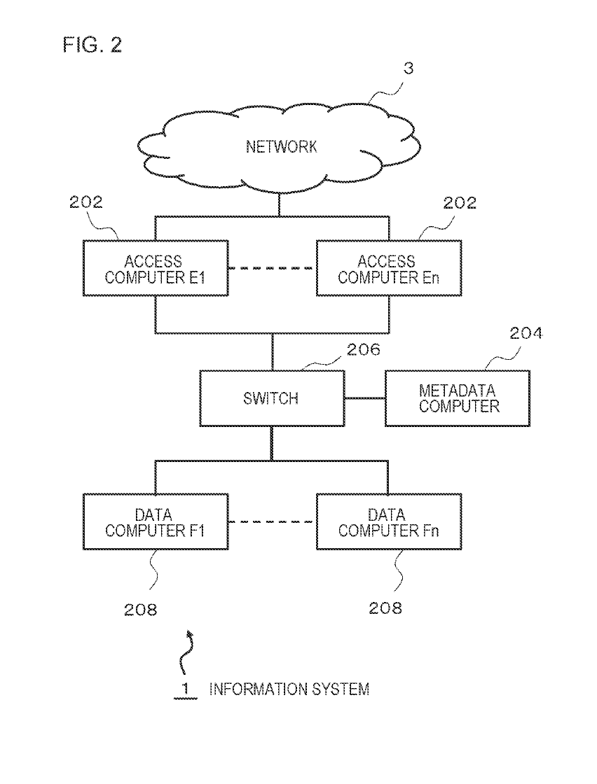

The information system 1 according to the present exemplary embodiment may have a configuration in which, for example, as illustrated in FIG. 2, a plurality of data computers 208 (in FIG. 2, indicated by data computers F1 to Fn) which mainly stores data and accesses computers 202 (in FIG. 2, indicated by access computers E1 to En) which mainly issue a request for an operation of data, the data computers 208 and the accesses computers 202 are connected to each other through a switch 206, and all of which are connected to each other through the network 3. In addition, the information system may have a configuration in which a metadata computer 204 which holds information (schema) regarding a structure of data stored in the data computers 208 is further provided.

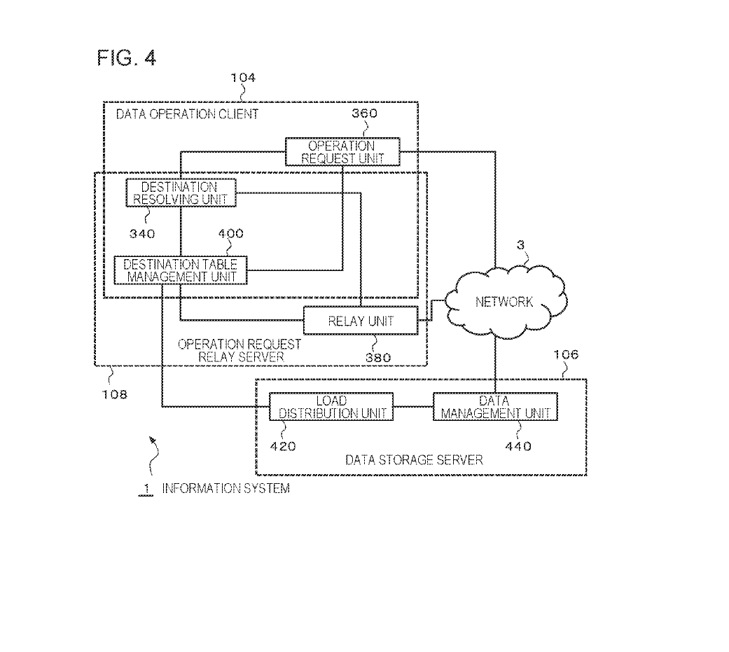

FIG. 4 is a functional block diagram illustrating a configuration of the information system 1 of the present exemplary embodiment.

The information system 1 of the present exemplary embodiment includes a plurality of nodes (the data storage servers 106) which manage a data constellation in a distributed manner, each of the plurality of nodes (the data storage servers 106) having a destination address being identifiable on the network; an identifier assigning unit (the destination table management unit 400) which assigns logical identifiers to the plurality of nodes (the data storage servers 106) on a logical identifier space; a range determination unit (the destination table management unit 400) which correlates a range of values of data in the data constellation with the logical identifier space and determines a range of the data managed by each node (the data storage server 106) in correlation with the logical identifier of each node (the data storage server 106); and a destination determination unit (the destination resolving unit 340) which obtains, when searching for a destination of a node (the data storage server 106) which stores any data having any attribute value or any attribute range, a logical identifier corresponding to a range of the data which matches at least a part of the attribute value or the attribute range on the basis of a correspondence relation among the range of the data, the logical identifier, and the destination address, with respect to each node (the data storage server 106), and determines the destination address of the node (the data storage server 106) corresponding to the logical identifier as a destination.

Specifically, as illustrated in FIG. 4, the information system 1 of the present exemplary embodiment includes the destination resolving unit 340, an operation request unit 360, a relay unit 380, the destination table management unit 400, a load distribution unit 420, and a data management unit 440.

In the present exemplary embodiment, the destination resolving unit 340, the operation request unit 360, and the destination table management unit 400 are included in each node of the data operation client 104. In addition, the destination resolving unit 340, the relay unit 380, and the destination table management unit 400 are included in each node of the operation request relay server 108. The load distribution unit 420 and the data management unit 440 are included in each node of the data storage server 106.

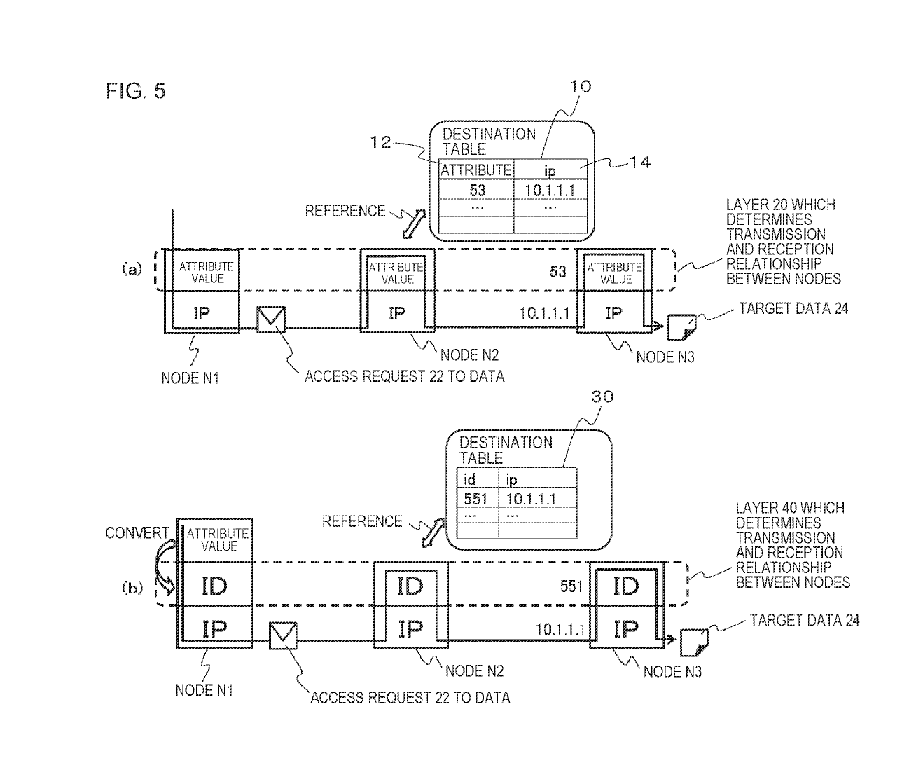

FIG. 5 is a block diagram illustrating a communication protocol stack between the servers.

FIG. 5(a) is a diagram illustrating an example of a distributed system using a destination table which correlates an attribute value of data stored in a node with a communication address of the node in a destination resolving process performed by the data operation client 104.

In this example, a connection relation between computers is described in a destination table 10 held by each node. Each node has the destination table 10 including destinations of the other nodes. Which node is included in the destination table 10 of any node (N1, N2, N3, . . . ) is determined on the basis of an attribute distribution of stored data.

In this case, for load distribution, a distribution of the nodes in the logical identifier ID space adaptively varies depending on the attribute distribution. Accordingly, a connection relation between the nodes is determined. In other words, a layer which determines a transmission and reception relation between the nodes is a part indicated by the reference numeral 20 of FIG. 5(a). On the basis of a data access request 22 from an application program, the destination resolving unit (not illustrated) resolves a destination to a data storage location (the node N3 in FIG. 5(a)) by referring to the destination table 10 formed by a pair of an attribute value 12 and a communication address (IP address 14). Accordingly, the data access request 22 is transferred to the data storage destination, and thus the application program can access target data 24.

FIG. 5(b) is a diagram illustrating an example of a distributed system that converts an attribute value of data stored in the node (N1, N2, N3, . . . ) into a logical identifier ID and uses a destination table 30 which correlates the logical identifier ID with a communication address IP of the node in a destination resolving process performed by the data operation client 104.

In this example, in a case where an attribute value is converted into a logical identifier ID so as to be uniformized, this conversion is required to be changed depending on an attribute distribution. In other words, a layer which determines a transmission and reception relation between the nodes is a part indicated by the reference numeral 40 of FIG. 5(b). On the basis of the data access request 22 from the application program, the destination resolving unit (not illustrated) converts an attribute value of data into a logical identifier ID, and resolves a destination to a data storage location (the node N3 in FIG. 5(b)) by referring to the destination table 30 formed by a pair of the logical identifier ID and the communication address IP. Accordingly, the data access request 22 is transferred to the data storage destination, and thus the application program can access the target data 24.

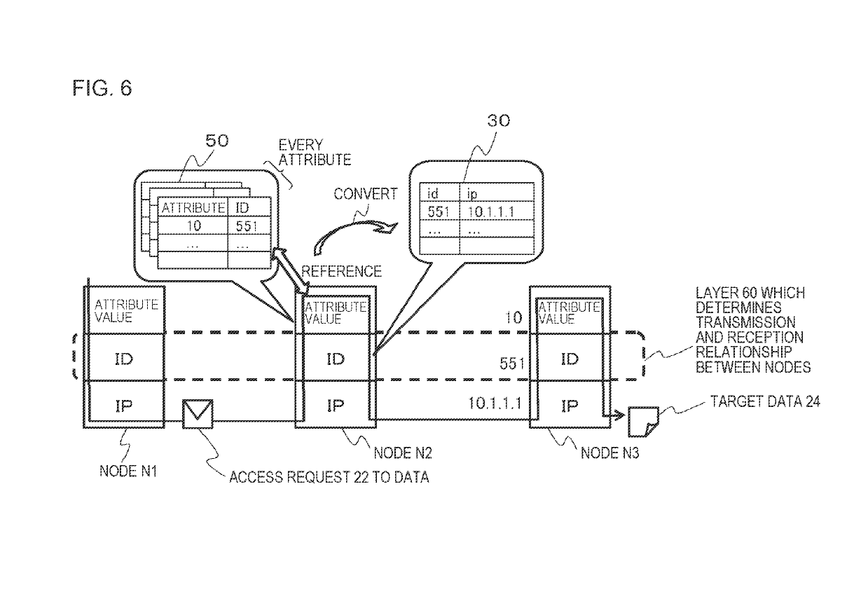

FIG. 6 is a block diagram illustrating a communication protocol stack between the servers of the information system 1 of the present exemplary embodiment.

In the information system 1 of the present exemplary embodiment of FIG. 6, in the destination resolving process performed by the data operation client 104, not only the ID destination table 30 for determining a connection relation between the nodes (N1, N2, N3, . . . ) but also a correspondence between a range (range) in an attribute space and the communication address IP for each accessed attribute is held as an attribute destination table 50. A destination resolving unit (not illustrated) resolves a destination to the data storage location (in FIG. 6, the node N3) by referring to the ID destination table 30 and the attribute destination table 50. In other words, a layer which determines a transmission and reception relation between the nodes is a part indicated by the reference numeral 60 of FIG. 6. Accordingly, the data access request 22 from the application is transferred to the data storage destination, and thus the application program can access the target data 24.

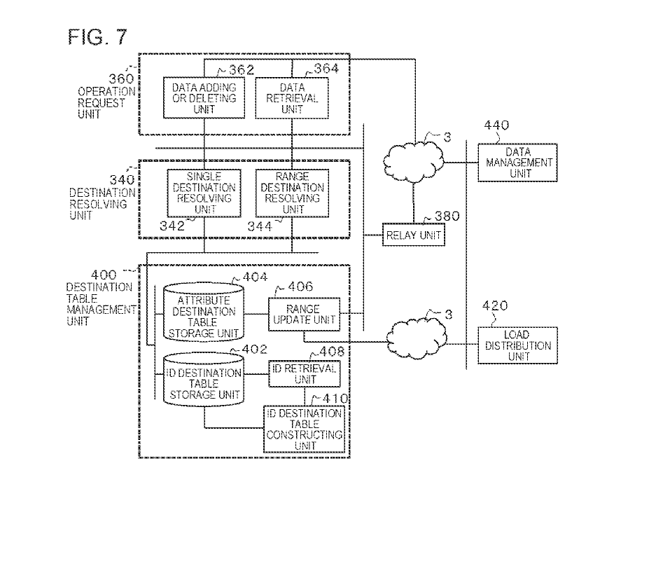

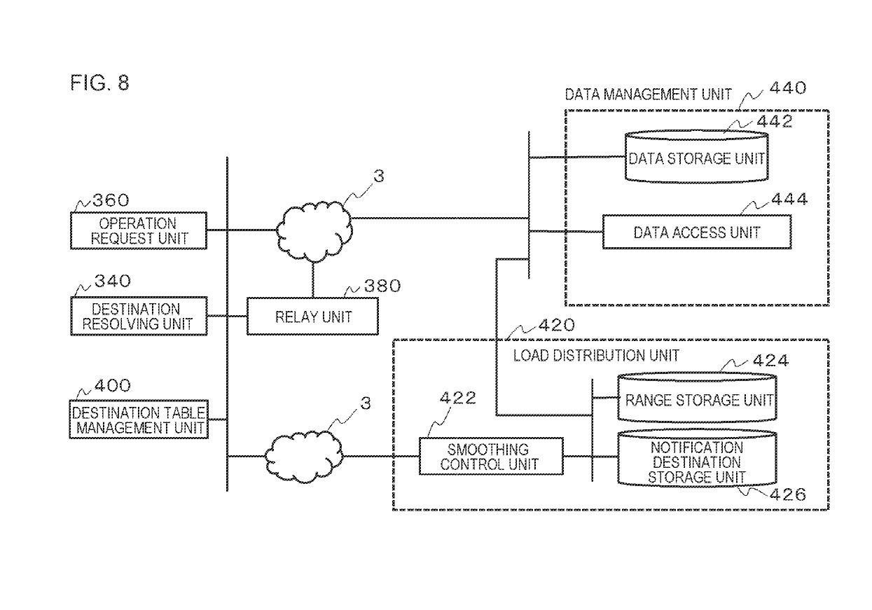

Next, details of a configuration of the information system 1 of the present exemplary embodiment will be described with reference to FIGS. 7 and 8.

FIGS. 7 and 8 are functional block diagrams illustrating a main part configuration of the information system 1 of the present exemplary embodiment.

As described above, the operation request unit 360, the destination resolving unit 340, and the destination table management unit 400 illustrated in FIG. 7 are included in each node of the data operation client 104 of FIG. 4. The destination table management unit 400 is also included in each node of the operation request relay server 108 of FIG. 4. In addition, the load distribution unit 420 and the data management unit 440 illustrated in FIG. 8 are included in each node of the data storage server 106 of FIG. 4.

As illustrated in FIG. 7, the destination table management unit 400 includes an ID destination table storage unit 402, an attribute destination table storage unit 404, a range update unit 406, an ID retrieval unit 408, and an ID destination table constructing unit 410.

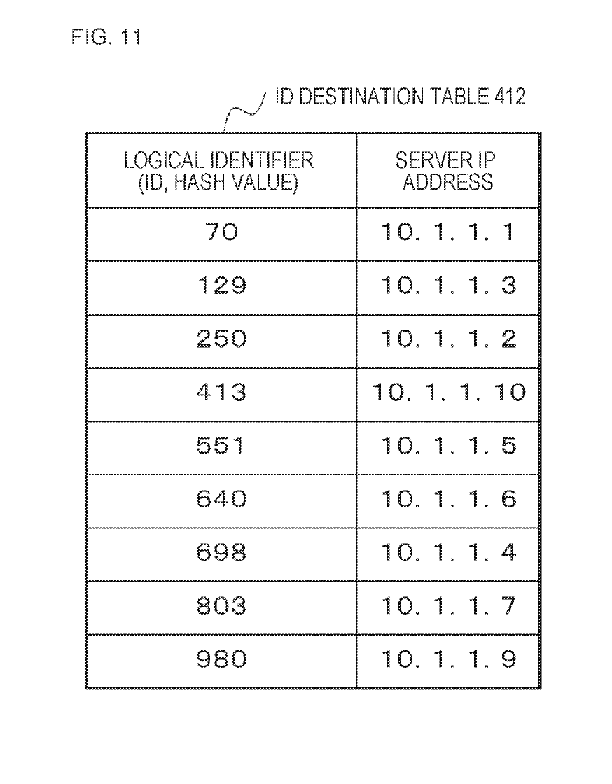

The ID destination table storage unit 402 stores an ID destination table 412 illustrated in FIG. 11.

As illustrated in FIG. 11, the ID destination table 412 stores a logical identifier ID (hash value) in correlation with a communication address (in the figure, a server IP address). The communication address is a communication address of a computer (node) which is a destination when communication is performed between a plurality of computers (node) which are connected to the network and store a data constellation having an attribute, through the network. In the present exemplary embodiment, the logical identifier ID is assigned to each node so as to be uniquely and stochastically uniformly distributed in a finite hash space (for example, 2 to the power of 160). Details thereof will be described later.

In addition, information regarding the node stored in the ID destination table storage unit 402 of FIG. 7 is different depending on an algorithm of the destination resolving unit 340. In a full mesh algorithm which does not have the relay unit 380, as illustrated in FIG. 11, any node has logical identifier IDs and communication addresses of all the nodes as the ID destination table 412. In addition, information regarding its own node may not be included in the ID destination table 412.

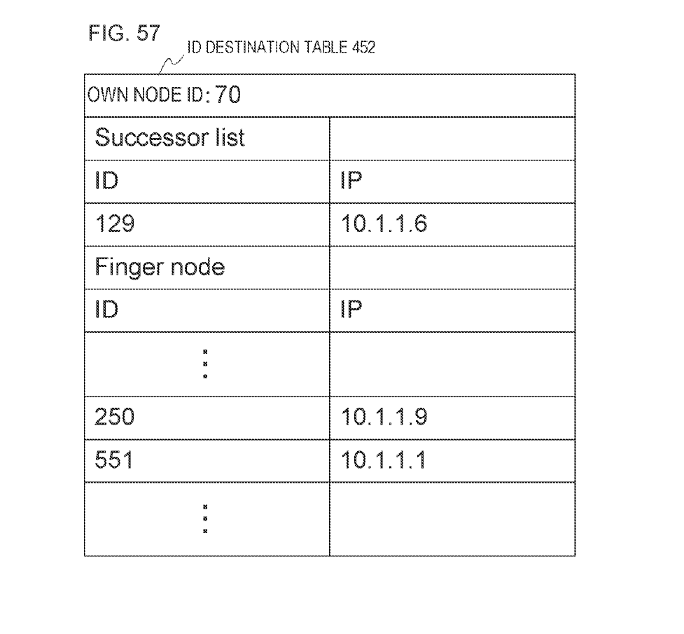

In a Chord algorithm of a subsequent exemplary embodiment, as illustrated in FIG. 57, in the logical identifier ID space, an ID destination table 452 includes a successor node corresponding to a logical identifier ID greater than that of its own node as a SuccessorList, and further includes a plurality of nodes which are spaced apart from its own node by a distance of the power of 2 as finger nodes. Here, a comparison between the logical identifier IDs of the respective nodes and calculation of a distance between the nodes are respectively performed by processes of a comparison calculation and distance calculation, which are generally defined in the Consistent Hashing.

In addition, a Koorde algorithm of the subsequent exemplary embodiment, a successor node, and a plurality of nodes, as finger nodes, having logical identifier IDs which are integer multiples of the logical identifier ID of its own node are included.

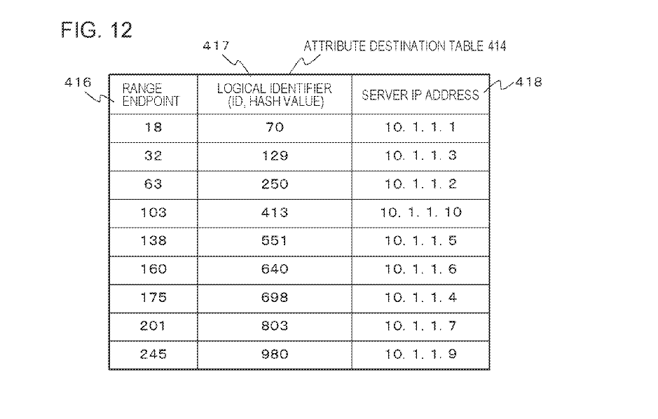

In addition, the attribute destination table storage unit 404 of FIG. 7 stores an attribute destination table 414 illustrated in FIG. 12. The attribute destination table 414 may be provided for each attribute. As illustrated in FIG. 12, the attribute destination table 414 stores a logical identifier 417 or a communication address (server IP address 418) of each node in correlation with a range endpoint 416 of any range which is a partial space that is managed by the corresponding node in the attribute space.

In the present exemplary embodiment, by using the ID destination table 412 (FIG. 11) and the attribute destination table 414 (FIG. 12), correspondence relations among destinations of a plurality of nodes (the data storage servers 106 or the operation request relay servers 108 of FIG. 4), logical identifier IDs which are stochastically uniformly assigned to the respective nodes (the data storage servers 106 or the operation request relay servers 108) on the logical identifier space, and ranges of attributes of data managed by the nodes (the data storage servers 106 or the operation request relay servers 108) can be stored in both of the ID destination table storage unit 402 and the attribute destination table storage unit 404. However, each node has a data amount of a fraction of the number of nodes as a stochastic expected value, but it may not be secured that each node exactly has a data amount of a fraction of the number of nodes. A load on each node is stochastically uniformly assigned.

Referring to FIG. 7 again, the range update unit 406 updates the attribute destination table 414 of own node m in accordance with changing of a range which is a partial space within an attribute space which can be processed by other nodes. For example, as will be described later, in a case where a range is changed by the load distribution unit 420 (FIG. 8) of the data storage server 106, a notification of the range change is transmitted from the load distribution unit 420 to the range update unit 406 through the network 3. Alternatively, a notification of the range change transmitted from the node (the data storage server 106 of FIG. 4) is transmitted to the range update unit 406 through the relay unit 380 (the operation request relay server 108 of FIG. 4).

Alternatively, also in a case where the ID destination table 412 (FIG. 11) and the attribute destination table 414 (FIG. 12) with respect to another node due to failures in this node is required to updated in the relay unit 380, the relay unit 380 may notify the range update unit 406 of this change.

The range update unit 406 updates the attribute destination table 414 in response to the notification of the range change transmitted from another node (the data storage server 106 or the operation request relay server 108).

In addition, the range update unit 406 may periodically perform life-and-death monitoring (health check) on each node (the data storage server 106) so as to check whether or not a range of each attribute is changed, and may update the attribute destination table 414 in an asynchronous manner.

With this configuration, in a case where a range is changed on the data storage node (the data storage server 106) side, even if the change is delivered to the client (the data operation client 104) side in an asynchronous manner, it is possible to maintain consistency of data between both of the two (between the data operation client 104 and the data storage server 106) or between the nodes (between the data operation clients 104, or between the data storage servers 106).

The ID retrieval unit 408 retrieves a destination so that a request for accessing the data managed by a node corresponding to a certain logical identifier ID in the hash space can be processed. The ID retrieval unit 408 retrieves and determines a destination (a communication address or the like of the node) which should process the request by referring to the ID destination table 412 stored in the ID destination table storage unit 402, in response to the request.

Each node has a value in a finite identifier (ID) space as a logical identifier ID (a destination, an address, or an identifier), and the ID destination table constructing unit 410 determines an ID space of data managed by the node on the basis of the ID. An ID of a data which manages data can be obtained using a hash value of a key of data which is desired to be registered or acquired in the DHT. In addition, a hash value of a unique identifier (for example, an IP address and a port) which is attached to the node at random or in advance may be used as the ID of each node. Accordingly, load distribution can be achieved. The ID space includes a method of using a ring type, a method of using a HyperCube, and the like. Chord, Koorde, and the like described above use the ID space of the method of using the ring type.

In the consistent hashing which is a method of correlating a node with data in a case of using the ring type, the ID space has one-dimensional [0, 2^{m}) by using any natural number m, and each node i has a value xi in this ID space as an ID. Here, i is a natural number up to the number N of nodes, and is identified in an order of xi.

In this case, the node i manages data included in [xi, x(i+1)). However, a computer of i=N manages data included in [0, x0) and [xN, 2^{m}).

In addition, in a case of an algorithm (for example, a Chord or Koorde algorithm) which needs the relay unit 380 without including information regarding all nodes in the ID destination table 412, the ID destination table constructing unit 410 determines whether or not any other node is included in the ID destination table 412 of own node m so as to create or update the ID destination table 412 while using the ID retrieval unit 408, and stores the ID destination table in the ID destination table storage unit 402.

As illustrated in FIG. 7, the destination resolving unit 340 includes a single destination resolving unit 342 and a range destination resolving unit 344.

The single destination resolving unit 342 acquires a destination (for example, a communication address) of a computer (the node of the data storage server 106 of FIG. 4) to which an operation request regarding data should be transmitted while referring to the attribute destination table 414 (FIG. 12) stored in the attribute destination table storage unit 404, by using a one-dimensional or more attribute value of the given data as an input.

The range destination resolving unit 344 acquires a plurality of destinations (for example, communication addresses) of computers (the nodes of the data storage server 106 of FIG. 4) to which an operation request regarding data should be transmitted while referring to the attribute destination table 414 (FIG. 12), by using a one-dimensional or more attribute range of the given data as an input.

In addition, in the present exemplary embodiment, the information system 1 is configured to include both of the single destination resolving unit 342 and the range destination resolving unit 344, but is not particularly limited, and may include either one thereof.

The information system 1 of the present exemplary embodiment may include a reception unit (operation request unit 360) which receives an access request to the data and an attribute value or an attribute range related to the data which is an access target along with the access request; and a transfer unit (relay unit 380) which transfers the access request and the attribute value or the attribute range for the data received by the operation request unit 360 to the node (the data operation client 104 of FIG. 4 or the operation request relay server 108 of FIG. 4). The destination determination unit (the destination resolving unit 340) determines a destination of a node for accessing data having the attribute value or the attribute range when the operation request unit 360 receives the access request, and delivers the destination to the relay unit 380. The relay unit 380 transfers the access request and the attribute value or the attribute range for the data to the node (the data operation client 104 or the operation request relay server 108) corresponding to the destination determined by the destination resolving unit 340.

As illustrated in FIG. 7, the operation request unit 360 includes a data adding or deleting unit 362 and a data retrieval unit 364.

The data adding or deleting unit 362 has a function of providing a data adding or deleting operation service to an external application program, or a program forming a database system. The data adding or deleting unit 362 receives a request for adding or deleting data having a certain attribute value, accesses the relay unit 380 or the data management unit 440 (included in the data storage server 106 of FIG. 4) of a destination node resolved by the single destination resolving unit 342 through the network 3, and executes the requested process so as to return a result thereof to a request source.

The data retrieval unit 364 has a function of providing a data retrieval operation service. The data retrieval unit 364 receives a data retrieval request for a certain attribute range in the attribute space, accesses the relay unit 380 or the data management unit 440 of a plurality of destination nodes resolved by the range destination resolving unit 344 through the network 3, and executes the requested process so as to return a result thereof to a request source. In any case, when a notification of range change is included in the result, the range update unit 406 of the destination table management unit 400 is instructed to update a range.

The relay unit 380 receives a data access request for a certain attribute value or a certain attribute range, from the operation request unit 360 of another node of the data operation client 104 of FIG. 4 or the relay unit 380 of another node of the operation request relay server 108 of FIG. 4. In addition, for response thereto, the relay unit 380 acquires a destination node resolved by the single destination resolving unit 342 in relation to the attribute value, and acquires one or more destination nodes resolved by the range destination resolving unit 344 in relation to the certain attribute range in the attribute space. Further, the relay unit 380 instructs the range update unit 406 to update a range in a case where a notification of range change is included in a result obtained by accessing the node of the data storage server 106 of FIG. 4 or another node of the operation request relay server 108 of FIG. 4.

In addition, in a case where a data access unit 444 of a certain node (the data storage server 106) recognizes that a range recognized by a node (the operation request relay server 108) which performs a relay process by referring to the attribute destination table 414 is different from a range recognized by a node (the data operation client 104 or the operation request relay server 108) which receives the range, a notification of range change is returned from the data access unit 444 to the node (the data operation client 104) which has executed data access. The relay unit 380 also has a function of receiving and then transferring the notification of range change to a redirect destination.

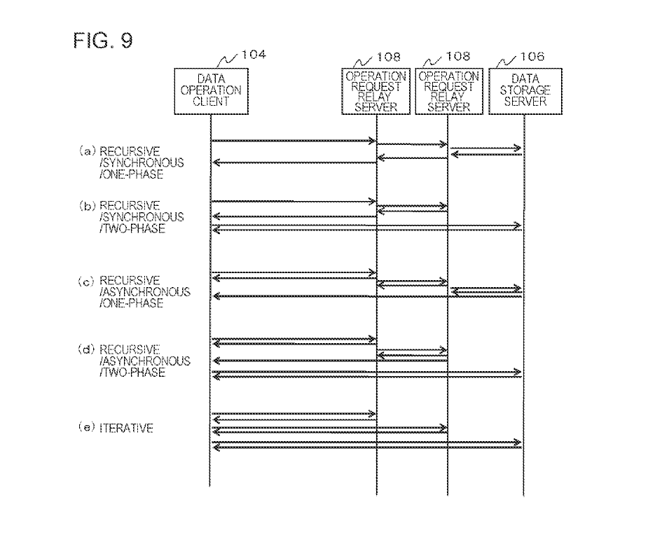

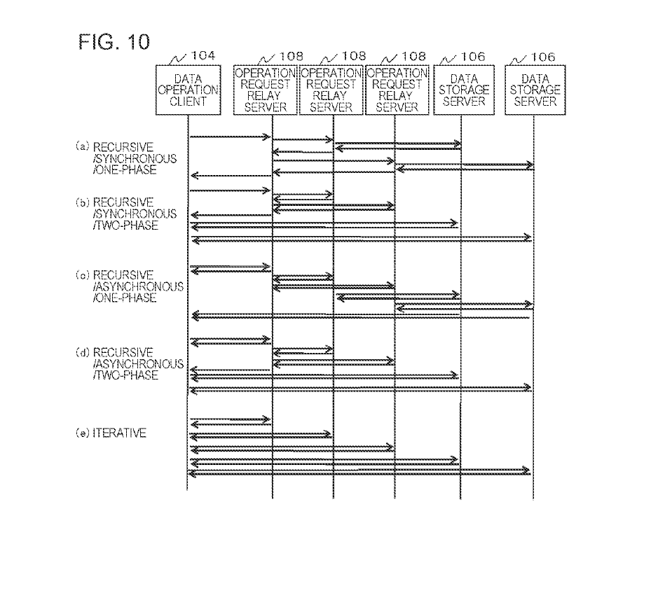

The relay unit 380, which participates when the operation request unit 360 accesses data of the data storage server 106, has several functions and sequences. A sequence of the data adding or deleting unit 362 is illustrated in FIG. 9, and a sequence of the data retrieval unit 364 is illustrated in FIG. 10. As illustrated in FIGS. 9 and 10, the sequence has an iterative pattern (FIGS. 9(e) and 10(e)) and a recursive pattern (FIGS. 9(a) to 9(d) and FIGS. 10(a) to 10(d)) when roughly classified.

In the iterative pattern (FIGS. 9(e) and 10(e)), the operation request unit 360 of the data operation client 104 iteratively acquires a communication address of the next operation request relay server 108 or data storage server 106 from the operation request relay server 108. In the recursive pattern (FIGS. 9(a) to 9(d) and FIGS. 10(a) to 10(d)), the operation request relay server 108 which receives a request from the data operation client 104 recursively performs another communication in order to perform a requested process.

In addition, the recursive pattern includes an asynchronous type (FIGS. 9(c) and 9(d) and FIGS. 10(c) and 10(d)) and a synchronous type (FIGS. 9(a) and 9(b) and FIGS. 10(a) and 10(b)). In the asynchronous type (FIGS. 9(c) and 9(d) and FIGS. 10(c) and 10(d)), the operation request relay server 108 returns a response indicating reception of a request to the data operation client 104 or the operation request relay server 108 which has transmitted the request. In the synchronous type (FIGS. 9(a) and 9(b) and FIGS. 10(a) and 10(b)), a process of a requester is blocked without returning a response.

In addition, the recursive pattern includes a one-phase type (FIGS. 9(a) and 9(c) and FIGS. 10(a) and 10(c)) and a two-phase type (FIGS. 9 (b) and 9(d) and FIGS. 10 (b) and 10(d)). In the one-phase type (FIGS. 9(a) and 9(c) and FIGS. 10(a) and 10(c)), when the operation request relay server 108 specifies a data storage server 106 which is a storage destination of requested data, the operation request relay server 108 directly performs a data access process. In the two-phase type (FIGS. 9 (b) and 9(d) and FIGS. 10 (b) and 10(d)), the operation request relay server 108 does not directly perform the data access process, and returns a communication address of that data storage server 106 to the data operation client 104, and the data operation client 104 performs the data access process on that data storage server 106.

In the present exemplary embodiment, the recursive, synchronous, and two-phase types (FIG. 9(b)) will be mainly described, but any type may be used. In these types, an operation is as follows. For example, a delay unit (here, temporarily referred to as a relay unit 380a) of a certain node receives a request from a relay unit (here, temporarily referred to as a relay unit 380b) of another node or the operation request unit 360, and inquires the destination resolving unit 340 about a communication address of a relay unit (here, temporarily referred to as a relay unit 380c) which is to be accessed next, or the data storage server 106.

In addition, in a case where the communication address of the relay unit 380c is returned, the relay unit 380a of the node transmits a data access request to the relay unit 380c having the returned communication address. Further, the relay unit 380a returns the returned communication address of the data storage server 106 to the relay unit 380b or the operation request unit 360 which has transmitted the request. In a case where the communication address of the data storage server 106 is returned, the relay unit 380a returns the communication address of the data storage server 106 to the relay unit 380b or the operation request unit 360 which has transmitted the request.

As illustrated in FIG. 8, the data management unit 440 includes a data storage unit 442 and the data access unit 444.

The data storage unit 442 includes a storage unit which stores a part of the data which is stored in and/or of which a notification is sent to the information system 1. In addition, the data storage unit 442 has a function of returning a data amount or a data quantity having a designated attribute in response to a request from the load distribution unit 420, and of performing inputting and outputting of data in response to an instruction for moving the data to other nodes.

The data access unit 444 receives a request such as acquisition, addition, deletion or retrieval of data stored in the data storage unit 442 of the identical node, from the operation request unit 360 or the relay unit 380, and performs the corresponding process on the data storage unit 442 so as to return a result thereof to a request transmission source.

The data access unit 444 further has a function of determining whether or not a request is proper by referring to a range storage unit 424 of the load distribution unit 420, before accessing data in response to a request from the operation request unit 360 or the relay unit 380. This determination is performed by determining whether or not an attribute value or an attribute range designated in the requested data access is included in an attribute range of the data stored in the data storage unit 442 of the identical node. In other words, the data access unit 444 determines whether or not a range recognized by the node which has performed the data access by referring to the attribute destination table 414 of the attribute destination table storage unit 404 is different from a range recognized by the data access unit itself. In addition, the data access unit 444 may have a function of storing information for identifying a node which transmits a request, in a notification destination storage unit 426 of the load distribution unit 420.

Further, in a case where the ranges do not match each other as a result of the above determination, the data access unit 444 notifies the node which is a request source, of a notification of range change and a redirect destination, in relation to access to the improper range. The data access unit 444 compares a range recognized by itself with an attribute value of the access-requested data, and determines an adjacent node which manages data in a range including an attribute corresponding to the access-requested data on the basis of a comparison result. A notification of the determined adjacent node is sent as a redirect destination.

The redirection destination is a communication address of a destination of a node which is expected to manage the access-requested data. As described above, the data access unit 444 has a function of performing control so that the attribute destination table 414 of the node which is a request source is updated to a value which is sent through the notification of range change.

As will be described later, a range managed by each node may be updated in order to smooth a load, and the updated content thereof is reflected in the attribute destination table 414 of each node in an asynchronous manner between the nodes. For this reason, there is a probability that the attribute destination tables 414 managed by the respective nodes may be different from each other. Therefore, there is a probability that, during access, a range which is managed by a node recognized by an access request source does not match a range which is actually stored in the node. For this reason, if access is allowed in this state, there is a probability that, even when nodes which are two different request sources access the same data, each of the nodes recognizes the other nodes as a data managing node, and thus an inconsistent data process may be performed between the nodes on the access side.

As in the present exemplary embodiment, a client which is a request source or a node which has transferred an access request transfers a redirect destination access request, and thus a data access request can arrive at a correct node after a range is updated.

In addition, in a case where the information system 1 is used as not a database system but a data stream system or a Pub/Sub system, not data but a conditional expression or the like is stored in the data storage unit 442.

For example, the data access unit 444 accesses the data storage unit 442 of a plurality of nodes in which a continuous query received by the data retrieval unit 364 or an attribute range designated in a Subscribe condition is stored as a conditional expression. In addition, in relation of a data registration request (Publish request) received by the data adding or deleting unit 362, the data access unit 444 accesses the data storage unit 442 of a node including a given attribute value, and acquires a conditional expression of an attribute range stored therein. Further, on the basis of the obtained continuous query or Subscribe condition, the data access unit 444 performs a notification process or execution of the continuous query corresponding to content thereof.

In addition, as above, in a case where the information system 1 is used as the data stream system or the Pub/Sub system, data is not recorded on the data storage unit 442, and thus a data amount of an attribute serving as a criterion of load distribution cannot be acquired. Therefore, in this case, a replacement with a data amount of a certain attribute is made, and a data quantity which is requested to be registered in the data storage unit 442 per unit time is used.

Alternatively, for example, D-dimensional attribute range designated in a continuous query or a Subscribe condition which is received by the data retrieval unit 364 is treated as a 2D-dimensional attribute value, and the data access unit 444 accesses the data storage unit 442 of a node which stores the attribute value. In addition, in relation to a data registration request (Publish request) received by the data adding or deleting unit 362, the data access unit 444 treats a given D-dimensional attribute value as a 2D-dimensional attribute range, accesses the data storage unit 442 of a plurality of nodes which manage the range, and acquires a conditional expression of the D-dimensional attribute range which is the 2D-dimensional attribute value stored therein. Further, on the basis of the obtained continuous query or Subscribe condition, the data access unit 444 performs a notification process or execution of the continuous query corresponding to content thereof.

Furthermore, in this case, the conditional expression is registered in the data storage unit 442, and thus an amount of conditional expressions held by each node serves as a criterion of load distribution.

As illustrated in FIG. 8, the load distribution unit 420 includes a smoothing control unit 422, the range storage unit 424, and the notification destination storage unit 426.

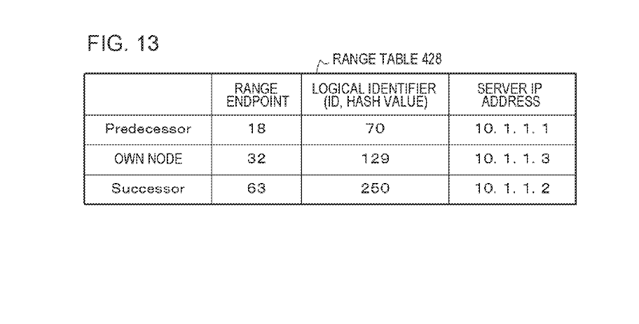

The range storage unit 424 stores a range table 428 (FIG. 13) which stores an endpoint of a range for each attribute of data stored in the data storage unit 442 of the data management unit 440 of the identical node m, together with logical identifier IDs or server IP addresses of own node m, and a successor node and predecessor node of the own node m. Here, the successor node is an adjacent node corresponding to a logical identifier ID which is greater than that of the own node m. The predecessor node is an adjacent node corresponding to a logical identifier ID smaller than that of the own node m.

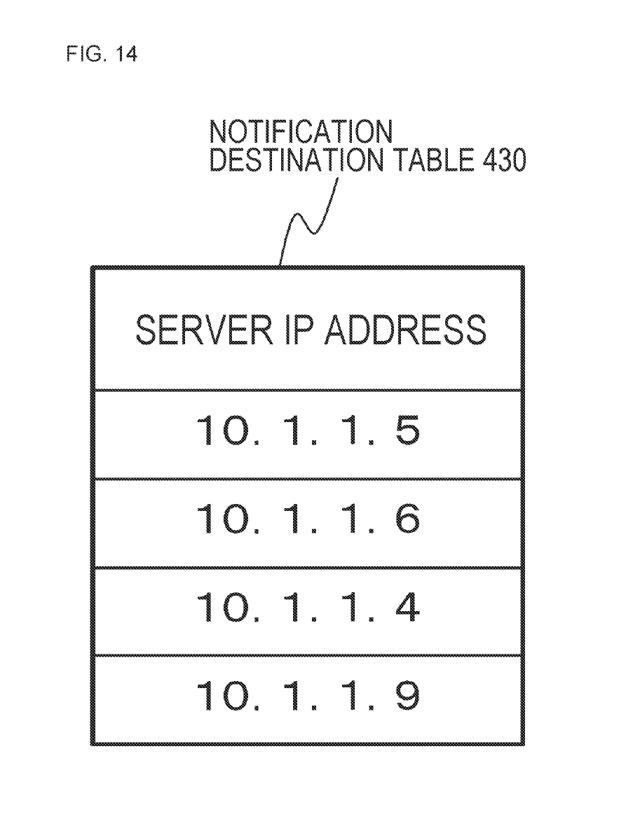

The notification destination storage unit 426 stores a notification destination table 430 (FIG. 14) which stores information (for example, an IP address) for identifying another node to which a notification of change should be sent when the changing to a range of data stored in the data storage unit 442 of the data management unit 440 of a certain node m occurs. A method of selecting a node (another node to which a notification of the change should be sent by each node m) on which information is included in the notification destination table 430 is different depending on each algorithm. Details thereof will be described later.

The smoothing control unit 422 moves at least a part of the data so that a load of the data is distributed between nodes whose logical identifier IDs are adjacent to each other, and manages a range due to the movement.

The smoothing control unit 422 compares a data amount of a certain attribute or a data quantity stored in the data storage unit 442 of the data management unit 440 of the identical node m with a data amount or a data quantity of the same attribute stored in the data storage unit 442 of another node, issues an instruction for moving the data stored in the data storage unit 442 between the nodes on the basis of a result thereof. In addition, the above-described range update unit 406 (FIG. 7) updates a range of attributes of the moved data in accordance with the movement of the data performed by the smoothing control unit 422. Further, when the data movement and the range update are performed, the smoothing control unit 422 notifies a specific node which may communicate with this node, of the range update. As a notification destination, for example, a node included in the notification destination table 430 may be used. As above, even in a case where a distribution of data varies due to the data movement by the smoothing control unit 422, a range is dynamically updated in accordance with the variation, and the update information is rapidly reflected, by the notification of range change, in the attribute destination table 414 of each node, thereby solving the performance deterioration problem during access to data.

As illustrated in FIG. 13, the range table 428 holds a range endpoint ap (“18” in the figure) of the predecessor node, a range endpoint am (“32” in the figure) of the own node m, and a range endpoint as (“63” in the figure) of the successor node. In addition, a range is assigned to each node m in a range (ap, am] which is greater than the range endpoint ap of the predecessor node and is equal to the range endpoint am of the own node m.

Here, in a case where a range is assigned to each node min the range (ap, am], a range is assigned to the successor node of each node m in a range (am, as].

In the present exemplary embodiment, the assignment of a range to the own node m and the assignment of a range of the successor node are necessary in a process of determining a range of data attributes registered in each node m, and thus the range table 428 includes range endpoints of the nodes (the predecessor node, the own node m, and the successor node) which are required to specify these ranges. However, in a case of determining a range of data attributes registered in each node min a rule different from the present exemplary embodiment, the range table 428 may include necessary information on nodes according to the rule.

In addition, the range table 428 of FIG. 13 includes the communication address along with the range endpoint, but is not limited thereto. For example, only the range endpoint for each attribute may be stored in the range table 428, and the communication addresses of the predecessor node, the own node m, and the successor node may be stored in another management table so as to be managed.

The notification destination table 430 of FIG. 14 may store information which is required for the corresponding node to perform communication. For example, a replacement with a communication address (an IP address, a port number, or the like) may be made, and the notification destination storage unit 426 of FIG. 7 may store a logical identifier ID of a node which can be correlated with the communication address.

In addition, in the present exemplary embodiment, as described above, the information of which a notification is sent from the data access unit 444 of FIG. 8 is registered in the notification destination table 430 of FIG. 14, but is not limited thereto, and a notification destination may be given in advance. Further, in the data stream system or the Pub/Sub system, the smoothing control unit 422 may not move data stored in the data storage unit 442, but may perform a process of appropriately dividing an attribute range thereof and moving the divided attribute range between the nodes in relation to a requested continuous query or a Subscribe condition.

In the above-described configuration, a method for processing data for a management apparatus (the data operation client 104 of FIG. 4) according to the exemplary embodiment of the present invention will be described below.

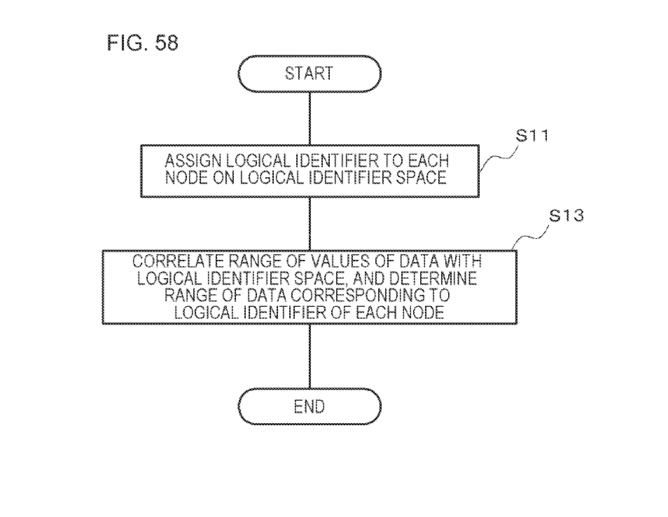

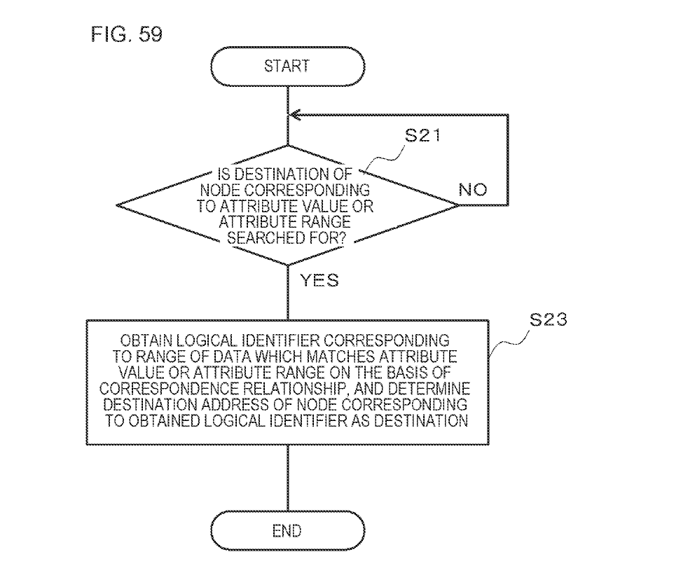

FIGS. 58 and 59 are flowcharts illustrating an example of an operation of the data operation client 104 according to the exemplary embodiment of the present invention. Hereinafter, a description thereof will be made with reference to FIGS. 4, 58 and 59.

The method for processing data according to the exemplary embodiment of the present invention is a method for processing data for a management apparatus (the data operation client 104 of FIG. 4) which manages a plurality of nodes (the data storage servers 106) that manage a data constellation in a distributed manner, the plurality of data storage servers 106 respectively having destination addresses (IP addresses) being identifiable on a network, in which the data operation client 104 assigns logical identifier IDs to the plurality of data storage servers 106 on a logical identifier space (step S11 of FIG. 58), and correlates a range of values of data in the data constellation with the logical identifier space so as to determine a range of the data managed by each of the data storage servers 106 in correlation with the logical identifier ID of each of the data storage servers 106 (step S13 of FIG. 58). In addition, when searching for a destination of the data storage server 106 which stores any data having any attribute value or any attribute range (YES in step S21 of FIG. 59), the data operation client 104 obtains a logical identifier ID corresponding to the range of data which matches at least a part of the attribute value or the attribute range on the basis of a correspondence relation among the range of the data, the logical identifier ID, and the destination address of each of the data storage servers 106, and determines the destination address of the data storage server 106 corresponding to the logical identifier ID as a destination (step S23 of FIG. 59).

Further, the method for processing data according to the exemplary embodiment of the present invention is a method for processing data of a terminal apparatus (a terminal (not illustrated) provided with a service from an external application program) which is connected to the management apparatus (the data operation client 104) and accesses data through the data operation client 104, in which the terminal apparatus notifies the data operation client 104 of an access request for data having an attribute value or an attribute range, and accesses, through the data operation client 104, a destination of the data storage server 106 which manages data in a range which matches at least a part of the access-requested attribute value or attribute range on the basis of correspondence relations among destination addresses of a plurality of data storage servers 106, logical identifiers assigned to the respective data storage servers 106, and ranges of data managed by the respective data storage servers 106, so as to operate the data.

Furthermore, a computer program according to the exemplary embodiment of the present invention causes a computer which realizes the data management apparatus (the data operation client 104 of FIG. 4) of the present exemplary embodiment, to execute: a procedure for assigning logical identifiers to a plurality of nodes (the data storage servers 106 of FIG. 4) on the logical identifier space; a procedure for correlating a range of values of data in a data constellation with the logical identifier space, and determining a range of the data managed by each of the data storage servers 106 in correlation with the logical identifier of each of the data storage servers 106; and a procedure for obtaining, when searching for a destination of a data storage server 106 which stores any data having any attribute value or any attribute range, a logical identifier corresponding to a range of the data which matches at least apart of the attribute value or the attribute range, on the basis of a correspondence relation among the range of the data, the logical identifier, and a destination address of each of the data storage servers 106, and determining the destination address of the data storage server 106 corresponding to the logical identifier as a destination.

The computer program according to the present exemplary embodiment may be recorded on a computer readable recording medium. The recording medium is not particularly limited, and may use media with various forms. In addition, the program may be loaded from the recording medium to a memory of a computer, and may be downloaded to the computer through a network and then be loaded to the memory.

An operation of the information system 1 of the present exemplary embodiment configured in this way will now be described. Each process will be described in the following order.

(1) A process in which each node (the data storage server 106) smoothes a load (load smoothing process)

(2) A process in which the node (the data operation client 104) receives a data access request from an application program (the data access request reception process)

(3) A process in which the node (the data operation client 104) updates a range in the attribute destination table 414 (range update process)

(4) A process in which the node (the data operation client 104) performs data access in response to the received data access request (a data adding or deleting process, and a data retrieval process)

(5) A process until the node (the data operation client 104) finds a destination of a node (the data storage server 106, or, the operation request relay server 108 until a target node is found on the way) which stores target data (the destination resolving process)

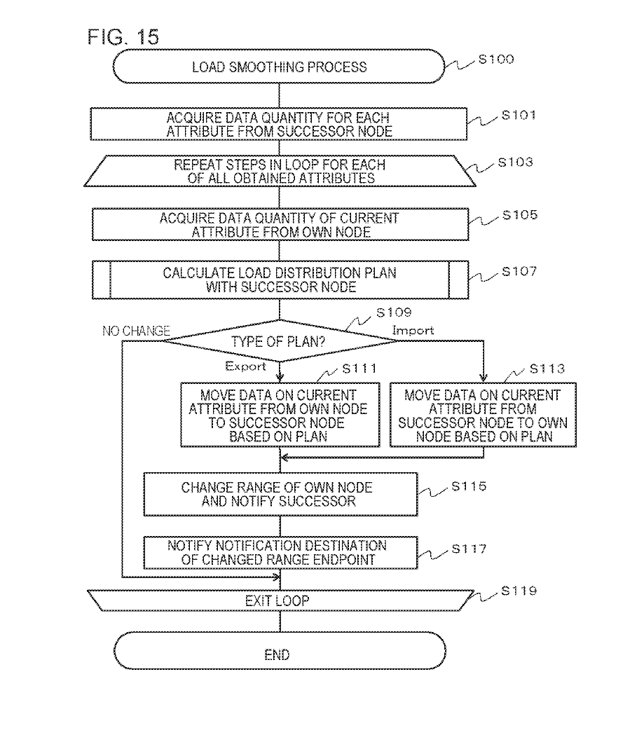

First, a description will be made of the load smoothing process in the information system 1 of the present exemplary embodiment. FIG. 15 is a flowchart illustrating an example of procedures of the load smoothing process S100 between adjacent nodes in the information system 1 of the present exemplary embodiment. The smoothing process S100 is performed by the smoothing control unit 422 (FIG. 8) of the load distribution unit 420 of the data storage server 106 (FIG. 4). Hereinafter, a description thereof will be made with reference to FIGS. 8 and 13 to 15.

In addition, the smoothing process S100 is automatically performed when the information system 1 of the present exemplary embodiment is activated, or is periodically and automatically performed, or is performed by a manual operation of a user of the information system 1 or in response to a request from an application.

First, the smoothing control unit 422 of the load distribution unit 420 of the node m (the data storage server 106) acquires a data amount or a data quantity (in the figure, indicated by “data quantity”) of every attribute for all attributes stored in the data storage unit 442 of the data management unit 440 of a successor node, from the successor node whose communication address is stored in the range table 428 (FIG. 13) stored in the range storage unit 424 of the own node m (step S101).

Specifically, the smoothing control unit 422 of the node m inquires the successor node. In addition, the successor node refers to the data storage unit 442 of the data management unit 440 of its own node, and acquires a data amount or a data quantity of every attribute for data for each of all attributes stored therein. Further, the successor node returns this information to the node m.

Next, the smoothing control unit 422 performs a loop process between steps S103 and S119 on each of the plurality of obtained attributes. If the process for each of all the attributes is completed, the loop process exits.

In the loop process, the smoothing control unit 422 acquires a data amount or a data quantity (in the figure, indicated by “data quantity”) on the current attribute from the own node (step S105), and calculates a load distribution plan with the successor node (step S107). The load distribution plan process will be described later.

If there is no change plan (“no change” in step S109), the flow proceeds to the process for the next attribute. If there is a plan to import data to the own node from the successor node (Import in step S109), the smoothing control unit 422 moves the data from the data storage unit 442 of the successor node to the data storage unit 442 of the own node on the basis of that plan (step S113). If there is a plan to export the data from the own node to the successor node (Export in step S109), the smoothing control unit 422 moves the data from the data storage unit 442 of the own node to the data storage unit 442 of the successor node on the basis of that plan (step S111).

In a case where the data is imported or exported in step S113 or S111, a range of the own node is changed accordingly, and thus the smoothing control unit 422 changes the range endpoint of the own node in the range table 428 (FIG. 13) stored in the range storage unit 424 (step S115). In addition, the successor node is notified of the change of the range endpoint of the own node, so as to change the range endpoint of the predecessor node (corresponding to the own node) in the range storage unit 424 of the successor node. Further, the change of the range endpoint of the own node allows information on the updated range endpoint to be also transmitted to the nodes corresponding to the communication addresses stored in the notification destination table 430 (FIG. 14) of the notification destination storage unit 426, as a notification of the range change (step S117).

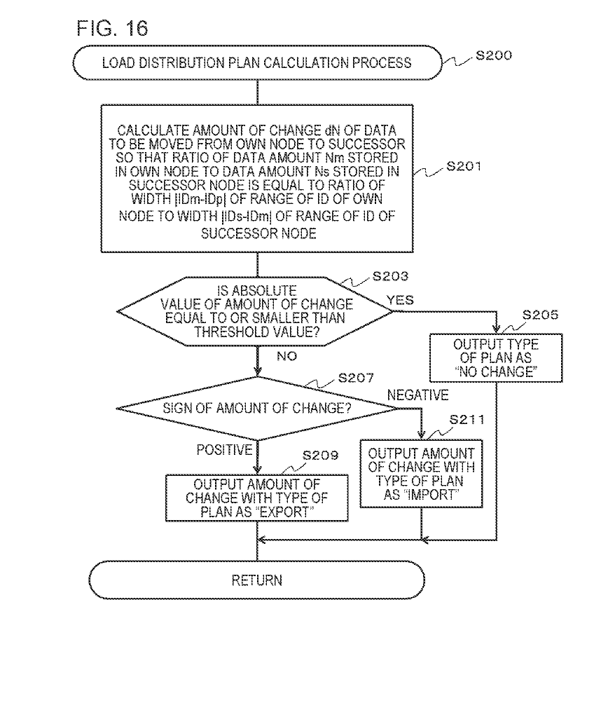

FIG. 16 is a flowchart illustrating an example of procedures of the load distribution plan calculation process (S200) in step S107 of FIG. 15.

First, an amount of change dN of data to be moved is obtained on the basis of a data amount or a data quantity (in the figure, indicated by “data amount”) with an adjacent node (step S201). Here, a data amount or a data quantity stored in the data storage units 442 of the own node and the successor node are denoted by Nm and Ns, respectively. In addition, intervals of ranges of logical identifier IDs managed by the own node and the successor node are respectively denoted by |IDm−IDp| and |IDs−IDm|. In this case, preferably, the smoothing control unit 422 obtains the amount of change dN in which data is to be moved from the own node to the successor node so as to satisfy Nm:Ns=|IDm−IDp|:|IDs−IDm|.

In addition, |IDm−IDp| is calculated by IDm−IDp mod 2^{m} by using the logical identifier ID space 2^{m}, and a solution thereof is non-negative. For example, when 2^{m} is 1024, IDm is 10, and when IDp is 1000, |IDm−IDp| is 34.

Preferably, an amount of change is determined so that data is distributed in accordance with a ratio of |IDm−IDp| to |IDs−IDm| without uniformizing a data amount or a number of data itself of the own node and the successor node. This is because the information system 1 of the present exemplary embodiment assumes scale-out (which is to improve the performance of the overall system by increasing the number of servers (nodes)) in which a node is added. A logical identifier ID of an added node in this case is stochastically uniformly assigned at random in the logical identifier ID space by the ID destination table constructing unit 410.

In addition, data is moved from a node corresponding to a successor with respect to the logical identifier ID assigned to the added node. For this reason, there is a high probability that a node with a wide interval of a logical identifier ID range moves data to the added node. In addition, also when a range of attributes is determined, a wide range is made to be managed by a node having a wide interval of a logical identifier ID range according to a width of the logical identifier ID range, and thus a range of data can be stochastically uniformly determined even in the system which assumes the scale-out.

For example, the smoothing control unit 422 may calculate the amount of change dN by using the following Expression (1).

[Math. 1]

dN=(Nm|IDs−IDm|−Ns|IDm−IDp|)/|IDs−IDp| Expression (1)

In this case, if an absolute value of the amount of change dN is equal to or less than a predetermined positive threshold value (YES in step S203), the smoothing control unit 422 outputs a plan type as “no change” and returns the load distribution plan (step S205), and the flow returns to step S109 of FIG. 15.

If the absolute value of the amount of change dN is greater than the threshold value (NO in step S203), and a sign of the amount of change dN is positive (“positive” in step S207), the plan type is output as “Export”, and the load distribution plan is returned together with the plan type and the amount of change dN (step S209), and the flow returns to step S109 of FIG. 15. If the sign thereof is negative (“negative” in step S207), the smoothing control unit 422 outputs the plan type as “Import”, and returns the load distribution plan together with the plan type and the amount of change dN (step S211), and the flow returns to step S109 of FIG. 15.

The processes in and after step S109 of FIG. 15 are performed on the basis of the load distribution plan calculated in this way.

As above, with the operation of the load distribution unit 420 described with reference to FIGS. 15 and 16, the information system 1 of the present exemplary embodiment can distribute and smooth a load by moving data between the nodes even in a case where a data distribution of the nodes varies due to addition or deletion of data to and from the node (the data storage server 106) or addition or removal of a node (the data storage server 106). In addition, other nodes can be notified of a change of a range due to the data movement.

Next, a description will be made of a process in which the node receives a data access request in the information system 1 of the present exemplary embodiment.

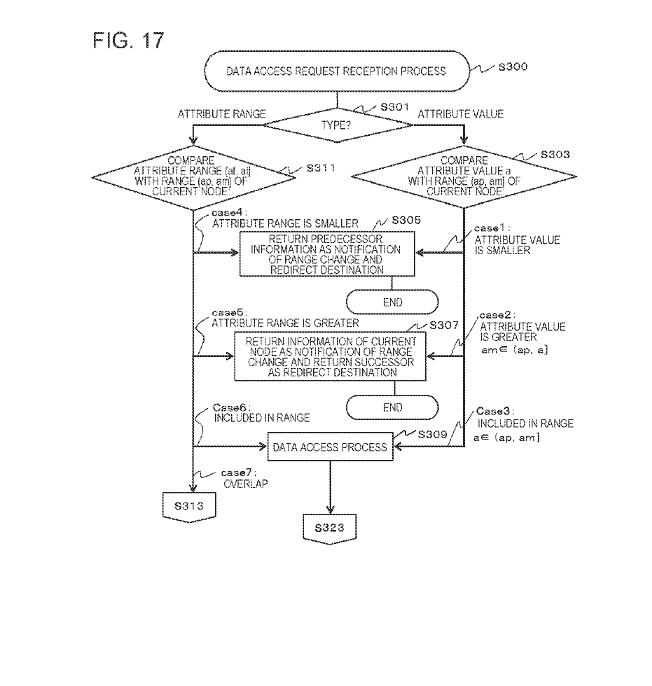

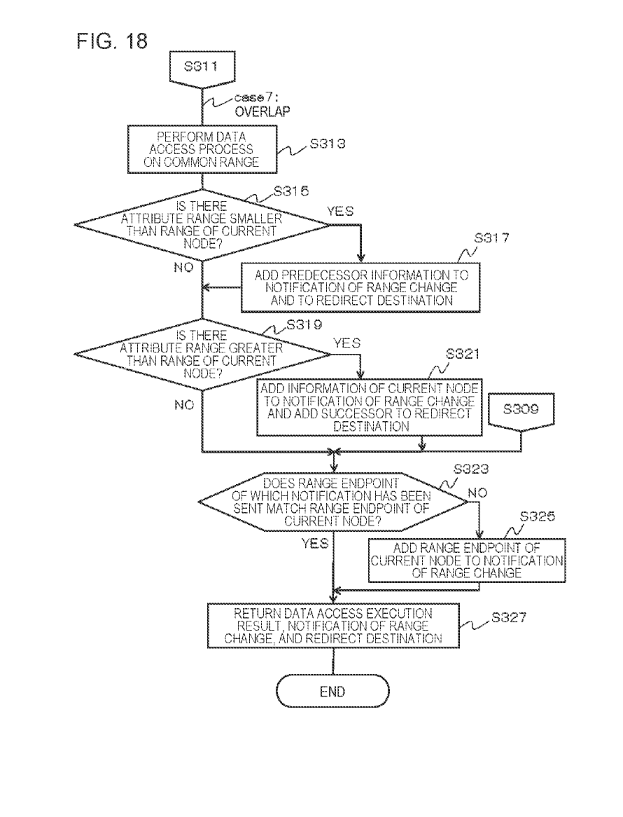

FIGS. 17 and 18 are flowcharts illustrating an example of procedures of the data access request reception process S300 of the information system 1 of the present exemplary embodiment. A description thereof will be made with reference to FIGS. 4, 8, 13, 17 and 18.

The data access request reception process S300 is performed by the data access unit 444 of the data management unit 440 of the node (the data storage server 106 of FIG. 4) of the information system 1 according to the present exemplary embodiment. In addition, this process S300 starts when the data access unit 444 receives a data access request and a range endpoint of a node along with the data access request which are transmitted from the operation request unit 360 of the data operation client 104 (FIG. 4) or transferred from the relay unit 380 of the operation request relay server 108 (FIG. 4). Further, the range endpoint of a node which is sent along with the access request is a range endpoint of a node which is managed by the node which is an access request source. In this process S300, it is verified whether or not the range endpoint of the node managed by the access request source matches a range endpoint managed by its own node. Therefore, the range endpoint of the node is received from the access request source.

In addition, in this process S300, the data access unit 444 determines whether or not the request is proper while referring to the range table 428 (FIG. 13) of the range storage unit 424, and performs a process on data stored in the data storage unit 442, for example, a process such as addition, deletion, or retrieval of data, when the request is proper. Further, in this process S300, a process is also performed in which information necessary to determine a destination to which the access request is transferred through the relay unit 380 is created and returned.

First, the data access unit 444 of the data management unit 440 of the node m which has received an access request discriminates a type of access request (step S301). If the type of access request is an attribute value, the data access unit 444 acquires a range (ap, am] of the own node m by referring to the range table 428 of the range storage unit 424, and compares the attribute value a with the range (ap, am] of the own node m (step S303).

If the attribute value a is smaller (case 1 in step S303), the data access unit 444 acquires the logical identifier ID and the range endpoint of the predecessor node by referring to the range table 428 of the range storage unit 424, and includes information on the predecessor node in a notification of range change. In addition, the data access unit 444 acquires the communication address of the predecessor node by referring to the range table 428 of the range storage unit 424, and sets the communication address of the predecessor node as a redirect destination (transfer destination).

Further, the data access unit 444 returns the information on the predecessor node to the node of the operation request unit 360 or the relay unit 380 which has received the access request, as a notification of range change and a redirect destination (step S305), and finishes this process.

If the attribute value a is greater (amε(ap,a]) (case 2 in step S303), in the same manner as in step S305, the data access unit 444 acquires the logical identifier ID and the range endpoint of the own node m and the communication address of the successor node, returns the information on the own node m as a notification of range change and the communication address of the successor node as a redirect destination, to the node of the operation request unit 360 or the relay unit 380 which has received the access request (step S307), and finishes this process. If the attribute value a is included in the range (aε(ap,am]) (case 3 in step S303), the data access unit 444 performs a process on data stored in the data storage unit 442 (step S309), and the flow proceeds to step S323 of FIG. 18.

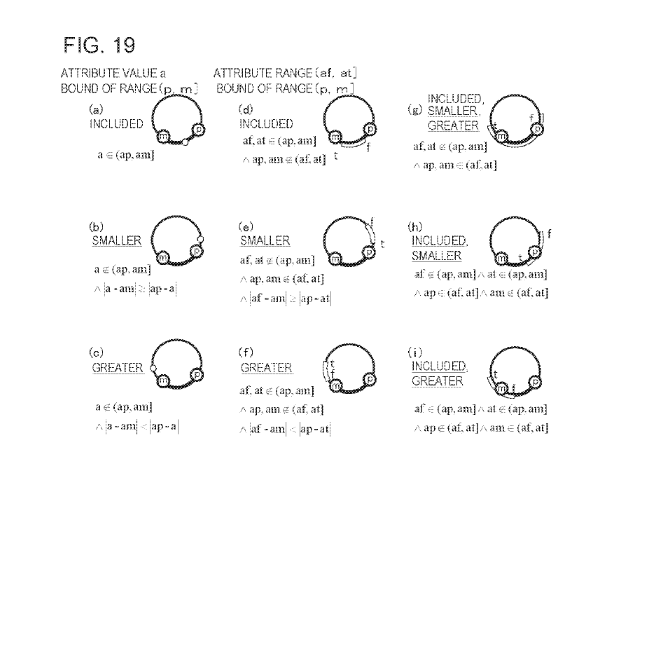

Here, the above-described comparison between the attribute value a and the range (ap, am] is summarized in FIGS. 19(a) to 19(c) and is illustrated along with conceptual diagrams. The term “smaller” mentioned here is not a comparison operation indicating that a value of an attribute value itself is small. That is, the term indicates a state in which a probability that the attribute value a is not included in the range (ap, am] and is stored on the counterclockwise side of the ring when viewed from the range (ap, am], that is, in the predecessor node, is higher than a probability that the attribute value is stored on the clockwise side of the ring, that is, on the successor node side.

For example, a description will be made of a case where a difference |a−am| between the attribute value a and the range endpoint am of the own node m is greater than |ap−a|. The difference |a−am| between the attributes used here is also non-negative. For example, a difference between signed char type numerical values −110 and 100, having [−128,127], is ((−110)−(100)) mod 256=46. Also in a case of a character string attribute, it is possible to realize the same differential process in any rule which gives the first and last continuities in dictionary order.

Referring to FIG. 17 again, in step S301, if the type is an attribute range, the data access unit 444 compares an attribute range (af, at] with the range (ap, am] of the node m (step S311). If the attribute range (af, at] is smaller than the range (ap, am] (case 4 in step S311), the data access unit 444 refers to the range table 428 of the range storage unit 424 and acquires the logical identifier ID, the range endpoint, and the communication address of the predecessor node. In addition, the data access unit 444 returns the logical identifier ID and the range endpoint of the predecessor node as a notification of range change and the communication address of the predecessor node as a redirect destination, to the operation request unit 360 or the relay unit 380 which has received the access request (step S305), and finishes this process.

If the attribute range (af, at] is greater than the range (ap, am] (case 5 in step S311), the data access unit 444 returns the logical identifier ID and the range endpoint of the own node m as a notification of range change and the communication address of the successor node as a redirect destination, to the operation request unit 360 or the relay unit 380 which has received the access request (step S307), and finishes this process.

If the attribute range (af, at] is included in the range (ap, am] (case 6 in step S311), the data access unit 444 performs a process on data stored in the data storage unit 442 (step S309), and the flow proceeds to step S323 of FIG. 18.

If the attribute range (af, at] and the range (ap, am] have a common part and overlap each other ((af,ad]∩(ap,am]≠empty set) (case 7 in step S311), the flow proceeds to step S313 of FIG. 18. In addition, the data access unit 444 performs a process on the data stored in the data storage unit 442 in relation to the common range ((af,at]∩(ap,am]) (step S313).

After step S313, if there is the attribute range (af, at] smaller than the range (ap, am] of the own node m, in the range other than the common range (apε(af,at]) (YES in step S315), the data access unit 444 adds the logical identifier ID and the range endpoint of the predecessor node to the notification of range change and the communication address thereof to the redirect destination (step S317), and the flow proceeds to step S319. If there is no attribute range smaller than the range of the own node m (NO in step S315), the flow proceeds to the next step S319.

In addition, if there is the attribute range (af, at] greater than the range (ap, am] of the own node m (amε(af,at]) (YES in step S319), the data access unit 444 adds the logical identifier ID and the range endpoint of the own node m to the notification of range change and the successor node to the redirect destination (step S321), and the flow proceeds to step S323. If there is no attribute range greater than the range of the own node m (NO in step S319), the flow proceeds to the next step S323.

Further, if the range endpoint of which a notification has been sent from the request source does not match the range endpoint of the own node m (NO in step S323), the data access unit 444 adds the range endpoint of the own node m to the notification of range change (step S325), and the flow proceeds to step S327. If the range endpoint of which the notification has been sent matches the range endpoint of the own node m (YES in step S323), the flow proceeds to step S327. The data access unit 444 returns the notification of range change and the redirect destination to the call source along with a data access execution result (step S327), and finishes this process.

In addition, if the data access process is performed in step S309, and the range endpoint of which the notification has been sent matches the range endpoint of the own node m (YES in step S323), the data access unit 444 does not return the notification of range change and the redirect destination in step S327. Further, the data access execution result includes, for example, a result of whether the data access is right or wrong, and a retrieval result in a case of data retrieval.

Here, the above-described comparison between the attribute range (af, at] and the range (ap, am] is summarized in FIGS. 19(d) to 19(i) and is illustrated along with conceptual diagrams.

As above, with the operation of the data access unit 444 described with reference to FIGS. 17 and 18, in the information system 1 of the present exemplary embodiment, the node (the data storage server 106) can access requested data on the basis of a data access request from an application program or the like, which has been received and transferred by the node (the data operation client 104). Further, it is also determined whether or not the data access request is proper, and a notification of a result thereof can be sent.

Next, a description will be made of a process in which the node updates a range in the information system 1 of the present exemplary embodiment.

This range update process is performed by the range update unit 406 (FIG. 7) of the destination table management unit 400 of the data operation client 104 (FIG. 4). The range update process includes a process which is performed when a notification of range change is received from the operation request unit 360 (FIG. 7) of the data operation client 104, the relay unit 380 (FIG. 7) of the operation request relay server 108 (FIG. 4), or the load distribution unit 420 (FIG. 8) of the data storage server 106 (FIG. 4); and a process which is autonomously executed by the range update unit 406 without depending on other constituent elements.

In the former process which is performed when a notification of range change is received from another constituent element, an update process is performed on the attribute destination table 414 (FIG. 12) on the basis of information on a logical identifier ID, an attribute, and a range endpoint included in the notification of range change.

A description will be made of a difference between functions in the processes with different triggers.

For example, a notification of range change from the load distribution unit 420 of the data storage server 106 is performed when an actual range change is performed in the data management unit 440 of the data storage server 106, and is thus effective since freshness of the information of the attribute destination table 414 (FIG. 12) of the data operation client 104 or the operation request relay server 108 can be increased.

However, a response time or a throughput of a data access request from the data operation client may deteriorate in a case where the attribute destination table 414 of the attribute destination table storage unit 404 of a plurality of other nodes such as the data storage servers 106 or the operation request relay servers 108 are synchronously updated, and thus the attribute destination table 414 of the attribute destination table storage unit 404 thereof is made not to be referred to through the destination resolving unit 340 by the operation request unit 360 or the relay unit 380 at that time.

Therefore, preferably, the attribute destination table 414 of each node is asynchronously updated, and the operation request unit 360 or the relay unit 380 is operated in an asynchronous manner with different nodes or different processes. However, in this case, a range may be updated immediately after a destination is resolved by the destination resolving unit 340. For this reason, when the operation request unit 360 or the relay unit 380 accesses the relay unit 380 or the data management unit 440 of another node, the fact that a destination resolving result is not proper is required to be received. In addition, the operation request unit 360 or the relay unit 380 receives the fact, and a redirect to an appropriate destination is required.

However, the notification of range change from the operation request unit 360 or the relay unit 380 is processed during execution of a request from an application program, and thus an update during the execution causes deterioration in a response time to the application program or a throughput. For this reason, it is suitably desirable to perform a process for increasing freshness of the information of the attribute destination table 414 in response to a range changing instruction from the above-described load distribution unit 420 or by the range update unit 406 itself performing the range update.

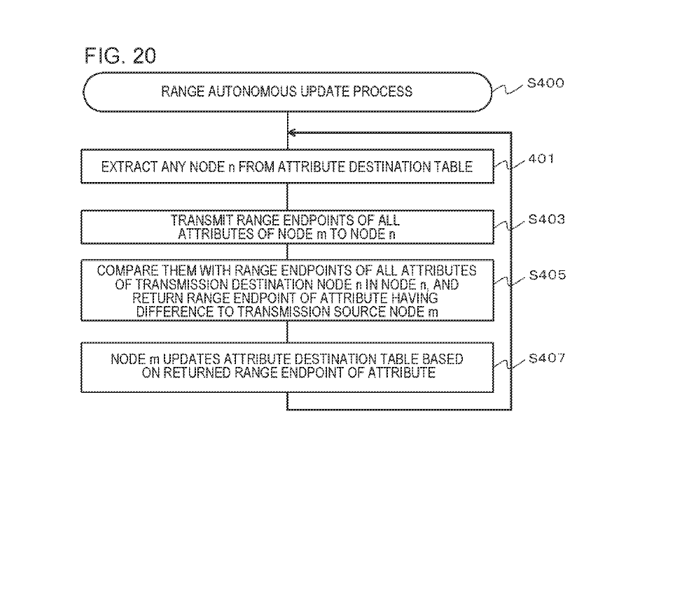

FIG. 20 is a flowchart illustrating an example of procedures of the range update process S400 in the information system 1 of the present exemplary embodiment. Hereinafter, a description thereof will be made with reference to FIGS. 4, 7, 12 and 20.

This range update process S400 is performed by the range update unit 406 (FIG. 7) of the destination table management unit 400 of the node (the data operation client 104 of FIG. 4) of the information system 1 according to the present exemplary embodiment. In this process S400, the range update unit 406 itself autonomously updates the range of the attribute destination table 414 (FIG. 12), and thus it is possible to increase freshness of the information of the attribute destination table 414.

This process S400 is automatically performed when the information system 1 of the present exemplary embodiment is activated, or is periodically and automatically performed, or is performed by a manual operation of a user of the information system 1 or in response to a request from an application program.

A certain node m (the data operation client 104) extracts any node n (the data storage server 106) from the attribute destination table 414 stored in the attribute destination table storage unit 404 (FIG. 7) of the destination table management unit 400 (step S401). In addition, the range endpoints of the node n in the attribute destination table 414 of all the attributes managed by the own node m are transmitted to the node n (step S403). The transmission destination node n compares the received range endpoint of each attribute with a range endpoint of the attribute which is actually stored in the transmission destination node n, and returns information on a range endpoint having a difference to the node m (step S405). The node m updates the range of the node n in the attribute destination table 414 of the own node m on the basis of the returned range endpoint of the attribute of the node n (step S407).

With the above range autonomous update process S400, in a case where the node side of the data storage server 106 changes a range, even if the range change is sent to the node side of the data operation client 104, it is possible to maintain consistency of data between both of the two (between the data operation client 104 and the data storage server 106) or between the nodes (between the data operation clients 104, or between the data storage servers 106). This process S400 is performed periodically, and thus the node of each data operation client 104 can increase freshness of the information of the attribute destination table 414.

As above, with the operation of the range update unit 406 described with reference to FIG. 20, the information system 1 of the present exemplary embodiment can update the information of the attribute destination table 414 by checking the range of the node (the data storage server 106) on the basis of a returned result. In other words, in the present exemplary embodiment, as described above, even if the data storage server 106 autonomously moves data, thus a range managed by each node is changed, and a notification of the change is sent to the data operation client 104 in an asynchronous manner, it is possible to realize matching between the data operation client 104 and the data storage server 106.

Next, a description will be made of a process of adding, deleting, or retrieving data in response to a data access request from an application program in the data operation client 104 of the information system 1 of the present exemplary embodiment.

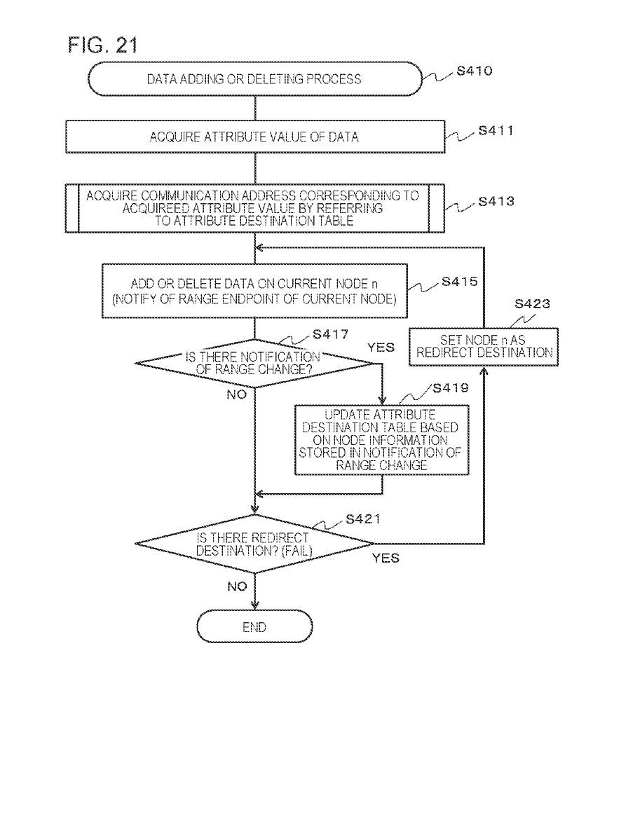

First, a description will be made of a data adding or deleting process in the information system 1 of the present exemplary embodiment. FIG. 21 is a flowchart illustrating an example of procedures of the data adding or deleting process S410 in the information system 1 of the present exemplary embodiment. This data adding or deleing process S410 is performed by the data adding or deleting unit 362 (FIG. 7) of the operation request unit 360 of the data operation client 104 (FIG. 4). Hereinafter, a description thereof will be made with reference to FIGS. 4, 7, 9, 12 and 21.

In addition, here, in the same manner as the recursive two-phase type (FIG. 9(b), FIG. 9(d), or the like), or the iterative type (FIG. 9(e), or the like) illustrated in FIG. 9, a description will be made only of a form of being divided into a process of specifying a node (the data storage server 106 of FIG. 4) from an attribute value and a process of performing data access process on the node (the data storage server 106). Further, in the following description, the description will be made of a case where data on which the data adding or deleting process is performed is designated as an attribute value, but an attribute range may be designated. In a case where the attribute range is designated, the same process as a data retrieval process described later is performed. However, not a data retrieval process but a data adding or deleting process is performed in step S437.

This process S410 starts when the node m (the data operation client 104) receives an access request for adding or deleting data, which is received from an application program or is transferred from a node of another data operation client 104 or the operation request relay server 108.

First, the data adding or deleting unit 362 (FIG. 7) of the operation request unit 360 of the node m (the data operation client 104) acquires an attribute value of the data to be added or deleted, designated in the access request (step S411). In addition, the data adding or deleting unit 362 notifies the single destination resolving unit 342 (FIG. 7) of the destination resolving unit 340, of the acquired attribute value, and acquires a communication address of a node n corresponding to the attribute value from the single destination resolving unit 342 (step S413).

At this time, in relation to the attribute value of which the notification is sent from the data adding or deleting unit 362, the single destination resolving unit 342 acquires the communication address of the node n corresponding to the attribute value by referring to the attribute destination table 414 (FIG. 12) stored in the attribute destination table storage unit 404 of the destination table management unit 400, and returns the communication address to the data adding or deleting unit 362. A destination resolving process by the single destination resolving unit 342 will be described later.

In addition, the data adding or deleting unit 362 performs data access for adding or deleting the data on the acquired node n (step S415). At this time, the data adding or deleting unit 362 notifies the node n, of a range endpoint of the attribute of the own node m.

In this case, the data access request process S300 described with reference to FIGS. 17 and 18 is performed in the node n. As a result of the data access request process S300, a data access execution result, a notification of range change, or a redirect destination is returned from the node n to the node m. In addition, the data adding or deleting unit 362 of the node m receives an execution result of performing the data adding or deleting process, from the node n.

In a case where a notification of range change is included in the execution result (YES in step S417), the data adding or deleting unit 362 acquires information on a logical identifier ID and a range endpoint of the node included in the notification of range change. In addition, the data adding or deleting unit 362 notifies the range update unit 406 (FIG. 7) of the destination table management unit 400 of the own node m, of these information, so as to instruct the attribute destination table 414 (FIG. 12) of the corresponding attribute to be updated (step S419), and the flow proceeds to step S421.

If a notification of range change is not included in the execution result (NO in step S417), the flow proceeds to step S421. In addition, if a redirect destination is included in the execution result (YES in step S421), the data access process on the node n fails. Therefore, the redirect destination is set to the next node n which is the access destination (step S423), and the flow returns to step S415 where the data adding or deleting unit 362 performs the data access process on the node n.

On the other hand, if a redirect destination is not included in the execution result (NO in step S421), this process finishes. In addition, a method of acquiring a communication address by referring to the attribute destination table 414 in step S413 is different depending on an algorithm of the destination resolving unit 340 as will be described later.

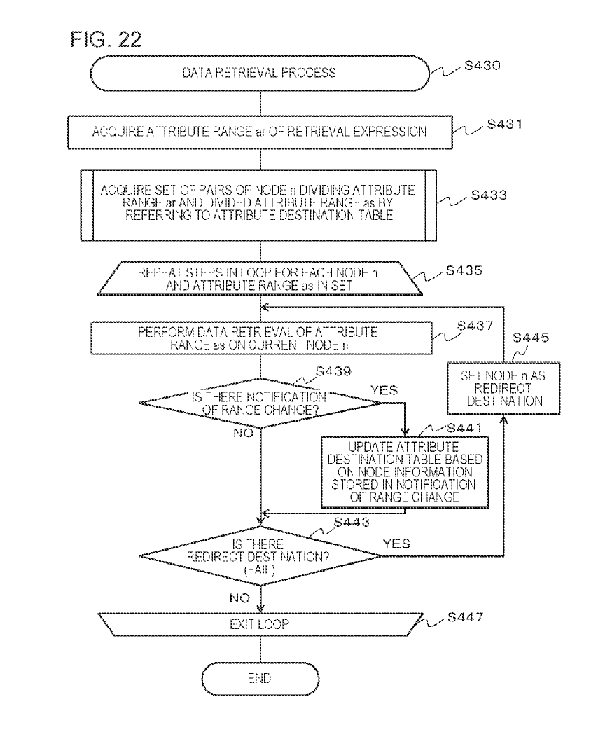

Next, a description will be made of a data retrieval process in the information system 1 of the present exemplary embodiment. FIG. 22 is a flowchart illustrating an example of procedures of the data retrieval process S430 in the information system 1 of the present exemplary embodiment. This data retrieval process S430 is performed by the data retrieval unit 364 (FIG. 7) of the operation request unit 360 of the data operation client 104 (FIG. 4). Hereinafter, a description thereof will be made with reference to FIGS. 4, 7, 9, 12 and 22.

Also here, in the same manner as the recursive two-phase type (FIG. 9(b), FIG. 9(d), or the like), or the iterative type (FIG. 9(e), or the like) illustrated in FIG. 9, a description will be made only of a form of being divided into a process of specifying a plurality of nodes (the data storage servers 106 of FIG. 4) from an attribute range and a process of performing data access process on the node (the data storage server 106).

In addition, in the following description, the description will be made of a case where an attribute range is designated in a retrieval expression, but an attribute value may be designated. In a case where the attribute value is designated, the same process as the data adding or deleting process described with reference to FIG. 21 is performed. However, not a data adding or deleting process but a data retrieval process is performed in step S415.

This process S430 starts when the node m (the data operation client 104) receives an access request for retrieval of data, which is received from an application program or is transferred from a node of another data operation client 104 or the operation request relay server 108.

First, the data retrieval unit 364 of the operation request unit 360 of the node m (the data operation client 104) acquires an attribute range ar of data to be retrieved, designated in the access request (step S431). In addition, the data retrieval unit 364 notifies the range destination resolving unit 344 (FIG. 7) of the destination resolving unit 340, of the acquired attribute range ar, and acquires a plurality of pairs of an attribute range as which is a subset of the attribute range ar and a corresponding node n, from the range destination resolving unit 344 (step S433).

At this time, in relation to the attribute range ar of which the notification is sent from the data retrieval unit 364, the range destination resolving unit 344 acquires a plurality of pairs of the attribute range as which is a subset of the attribute range ar and the corresponding node n by referring to the attribute destination table 414 (FIG. 12) stored in the attribute destination table storage unit 404 of the destination table management unit 400, and returns the pairs thereof to the data retrieval unit 364. A destination resolving process by the range destination resolving unit 344 will be described later.

In addition, the data retrieval unit 364 performs a loop process between steps S435 and S447 on each of the node n and the attribute range as of the plurality of obtained results. If a process for each of all the nodes n is completed, the loop process exits, and this process S430 also finishes.

When the loop process starts, first, with respect to the current node n, data in the attribute range as of this node n is retrieved (step S437). At this time, the data retrieval unit 364 notifies the current node n of a range endpoint of the attribute of the own node m.

In this case, the data access request process S300 described with reference to FIGS. 17 and 18 is performed in the node n. As a result of the data access request process S300, a data access execution result, a notification of range change, or a redirect destination is returned from the node n to the node m. Here, as the data access execution result, retrieved data is returned. In addition, the data retrieval unit 364 of the node m receives an execution result of performing the data retrieval process, from the node n.

In a case where a notification of range change is included in the execution result (YES in step S439), the data retrieval unit 364 acquires information on a logical identifier ID and a range endpoint of the node included in the notification of range change. In addition, the data retrieval unit 364 instructs the range update unit 406 (FIG. 7) of the destination table management unit 400 of the node m to update the attribute destination table 414 (FIG. 12) of the attribute to be updated (step S441), and the flow proceeds to step S443.

If a notification of range change is not included in the execution result (NO in step S439), the flow proceeds to step S443. In addition, if a redirect destination is included in the execution result (YES in step S443), the data access on the node n fails. Therefore, the redirect destination is set as the next node n (step S445), and the flow returns to step S437 where data access in the attribute range as is performed. On the other hand, if a redirect destination is not included in the execution result (NO in step S443), this process finishes. In addition, a method of acquiring a communication address by referring to the attribute destination table 414 in step S433 is different depending on an algorithm of the destination resolving unit 340 as will be described later.

As above, with the operation of the operation request unit 360 described with reference to FIGS. 21 and 22, the information system 1 of the present exemplary embodiment can perform a process corresponding to the access request for data from the application program.

Next, a description will be made of a destination resolving process of searching for a destination of a node which stores data in the information system 1 of the present exemplary embodiment. This destination resolving process is performed by the destination resolving unit 340 (FIG. 7) of the data operation client 104 (FIG. 4). In addition, in the present exemplary embodiment, an algorithm of the destination resolving unit 340 is of a full mesh type.

The destination resolving process includes a single destination resolving process performed by the single destination resolving unit 342 (FIG. 7) and a range destination resolving process. The single destination resolving process is a process of searching for a destination of a single node which stores data on the attribute value. The range destination resolving process is performed by the range destination resolving unit 344 (FIG. 7) and is a process of searching for destinations of a plurality of nodes which store data on the attribute range.

In addition, this destination resolving process starts when an attribute value or an attribute range is received as a destination resolving process request from the operation request unit 360 of the node m (the data operation client 104) which currently performs the above-described data adding or deleting process or data retrieval process, the destination resolving process request is transferred from the destination resolving unit 340 of another node through the relay unit 380, or the like.

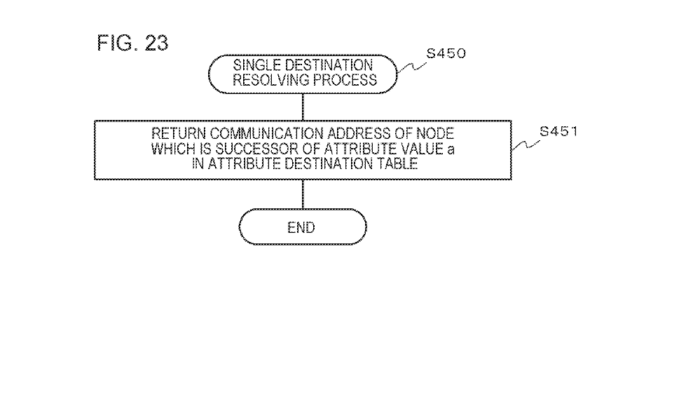

First, a description will be made of the single destination resolving process performed by the single destination resolving unit 342 of the destination resolving unit 340. FIG. 23 is a flowchart illustrating an example of procedures of the single destination resolving process S450 in the information system 1 of the present exemplary embodiment. Hereinafter, a description thereof will be made with reference to FIGS. 4, 7, 12 and 23.

First, the single destination resolving unit 342 of the destination resolving unit 340 of the node m (the data operation client 104) acquires a communication address of a node which is a successor of the attribute value a designated from a call source by referring to the attribute destination table 414 (FIG. 12) stored in the attribute destination table storage unit 404 of the destination table management unit 400, and returns the communication address to the call source (step S451).

Next, a description will be made of the range resolving process performed by the range destination resolving unit 344 of the destination resolving unit 340.

In this range destination resolving process, the range destination resolving unit 344 of the destination resolving unit 340 of the node m (the data operation client 104) refers to the attribute destination table 414 (FIG. 12) stored in the attribute destination table storage unit 404 of the destination table management unit 400, and divides the designated attribute range (af, at] into a plurality of parts by using the range endpoints registered in the attribute destination table 414 so as to obtain a plurality of pairs of the attribute range and the node used in the division.

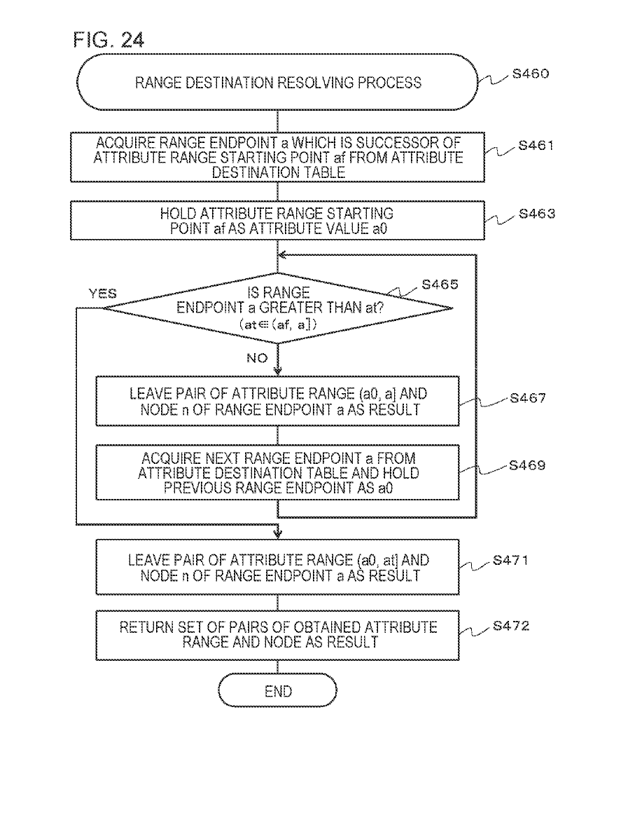

A specific example of the range destination resolving process will be described below. FIG. 24 is a flowchart illustrating an example of procedures of the range destination resolving process S460 in the information system 1 of the present exemplary embodiment. Hereinafter, a description thereof will be made with reference to FIGS. 4, 7, 12 and 24.

First, the range destination resolving unit 344 of the destination resolving unit 340 of the node m (the data storage server 106) acquires a range endpoint a which is a successor node of the starting point af of the attribute range (af, at], from the attribute destination table 414 stored in the attribute destination table storage unit 404 (step S461), and holds the starting point af of the attribute range as an attribute value a0 (step S463). In addition, the range destination resolving unit 344 compares the attribute value a with the terminal point at of the attribute range, and, in a case where the attribute value a is smaller than the terminal point at of the attribute range (NO in step S465), leaves a pair of the attribute range (a0, a] and the node n of this range endpoint a (step S467) as a resultant. Further, the range destination resolving unit 344 acquires the next range endpoint a from the attribute destination table 414, and holds the previous range endpoint which then sets as a0 (step S469). Furthermore, the flow returns to step S465, and the next attribute value a is compared with the terminal point at of the attribute range.

If the attribute value a is greater than the terminal point at of the attribute range (YES in step S465), the range destination resolving unit 344 leaves a pair of the attribute range (a0, at] and the node n of the range endpoint a (step S471) as a resultant, and returns a plurality of obtained pairs thereof to the call source (step S472) as a resultant.

As above, with the operation of the destination resolving unit 340 described with reference to FIGS. 23 and 24, the information system 1 of the present exemplary embodiment can specify a node corresponding to the access-requested destination from the attribute value of access-requested data.

As described above, according to the present invention, there are provided an information system, a data management method, a method for processing data, a data structure, and a program, which maintain performance and reliability even if a data distribution of nodes varies.

Especially, in order to realize range retrieval, the information system 1 according to the exemplary embodiment of the present invention assigns the logical identifier ID which is stochastically uniform to a node which is a data storage destination, and manages the destination table including a range for each attribute and the logical identifier ID of the node which is a storage destination, in addition to the logical identifier ID and a destination address of the node which is a storage destination. In addition, the node which is a storage destination changes the range for load distribution on the basis of adjacency of the logical identifier ID. The destination table for each attribute is updated due to the change. Further, a destination address of the node which is a storage destination, necessary in a data access process, is determined by referring to the destination table in response to a data access request.

Accordingly, according to the information system 1 of the exemplary embodiment of the present invention, it is possible to achieve an effect of reducing a load which occurs due to life-and-death monitoring (health check) for maintaining communication reachability between nodes, or a probability of system failures due to frequent changes of connection between the nodes.

This is because, in the information system 1 of the present exemplary embodiment, a node (the data storage server 106) managed in the destination table which is managed by each node (the data operation client 104 or the operation request relay server 108) does not vary even if a distribution of data registered in the nodes (the data storage servers 106) varies.

The reason is that, in the information system 1 of the present invention, the destination table (the attribute destination table 414) is constructed for each attribute separately from the destination table (the ID destination table 412) indicating a transmission and reception relation which is constructed using a relation between the logical identifier IDs of the nodes. In addition, the reason is that, in the information system 1 of the present exemplary embodiment, the distribution variation can be flexibly handled by changing the destination table (the attribute destination table 414), and thus the destination table (the ID destination table 412) in which a transmission and reception relation is built is not required to be changed.

As a technique for handling a load increase by increasing the number of storage destinations such as a computer, a disk, and a memory which form a system, there is a method (consistent hashing) in which a concentrated element such as a specific computer managing a tree structure is not provided, but an address (ID) of a data storage destination is determined using a hash value, and a storage destination is determined from the hash value of data by referring to the address. However, such a method is not suitable for range retrieval which requires ordering or consistency of data. Although a storage destination is determined using an attribute value as a logical identifier ID of the storage destination, a load on the storage destination depends on a distribution of the attribute, and thus if the logical identifier ID of the storage destination is made to be adaptive, a variation in a distribution of any attribute influences a load on another attribute when a plurality of attributes are treated. In addition, in a method of determining a computer by using a range of attribute values of data, uniformity of a load is a problem to be solved. In a method of determining an ID so that an attribute value is suitable for stochastic uniformity of storage destinations, by using distribution information of a distribution, a problem occurs in a case where the distribution varies.

As described above, it is considered that the structured P2P has the following two approaches for achieving the range retrieval.

As for the first approach, a system determines which of the other nodes is stored in a destination table managed by the own node (builds a transmission and reception relation) on the basis of a range of attributes of data stored in the node. The system refers to an attribute value of requested data and the destination table when determining a destination of an access request to the data, and transfers the access request to the data to the determined destination.

As for the second approach, the system determines which of the other nodes is stored in a destination table managed by the own node (builds a transmission and reception relation) on the basis of an ID of the node, and determines a destination of an access request for data by referring to a value obtained by converting an attribute value of the data into an ID space, and the destination table.

In the above-described first approach, there is a problem in that there are high probabilities that an update (changing in a transmission and reception relation between nodes) of the destination table in each node or an accompanying process for maintaining communication reachability is necessary, and that a necessary process may be required to be temporarily stopped during changing of a communication path, and the changing may be treated as a communication path failure.

The reason is as follows. If data is registered in a plurality of nodes, a distribution of the data varies. In addition, in a case where a range is changed so that data between the nodes is distributed in a nearly uniform data amount in accordance with the variation in the distribution of the data, the destination table which stores which of the other nodes is to be connected is also required to be changed due to the change.

According to the present invention, nodes stored in the destination table of each node do not vary despite a distribution variation of registered data. Therefore, maintaining communication reachability between nodes is reduced, and thus it is possible to reduce a probability of system failures due to frequent changes of connection between the nodes.

In addition, in the above-described first approach, there is a problem in that the destination table of each node does not have stochastic uniformity; thus, efficiency of a data access request transfer process subject to the uniformity is reduced; the number of hops increases, that is, a response time increases or a transfer load is biased; and, therefore, a system is influenced.

The reason is as follows. If data is registered in a plurality of nodes, a distribution of the data varies. In addition, in a case where a range is changed so that data between the nodes is distributed in a nearly uniform data amount in accordance with the variation in the distribution of the data, a stochastic distribution of the logical identifiers stored in the destination table is biased in accordance with the distribution of the attribute.

Further, in the above-described second approach, there is a problem in that the update of distribution information used in the correlation and accompanying rearrangement of data are necessary.

The reason is as follows. The destination table which is constructed on the basis of an ID of a node is statically held on the premise that data is uniformly assigned in an ID space. In addition, an ID of data is calculated using distribution information so the data is uniformly distributed. Therefore, if a distribution of the data varies, the calculated ID of the data is required to be updated. Further, if an ID at the time of storing the data is different from an ID at the time of acquiring the data, the data cannot be acquired. In order to prevent this, the data is required to be rearranged to a new ID.

According to the present invention, since an attribute value is made to match an ID of a node having stochastic uniformity or an ID stored in the destination table, it is possible to prevent a problem of rearrangement due to a variation in correlation between the attribute value and the ID even if the distribution varies, without needing distribution information.

The reason is as follows. The information system of the present invention does not determine a destination on the basis of an ID into which an attribute value is converted using distribution information, and the destination table indicating a transmission and reception relation built using a relation between IDs of nodes, but generates the destination table for each attribute in accordance with a transmission and reception relation between nodes in the destination table, and determines a destination by comparing the destination table with the attribute value. Therefore, information corresponding to a distribution is appropriately updated in accordance with the transmission and reception relation, and thus the destination table for each attribute is updated.

### Second Exemplary Embodiment

An information system according to the exemplary embodiment of the present invention is different from the information system 1 of the above-described exemplary embodiment in that the Chord algorithm of the DHT is used in a destination resolving process. In addition, procedures of a process performed by each constituent element using the drawings in the above-described exemplary embodiment are different in the present exemplary embodiment and the above-described exemplary embodiment, but the same configuration will be described below using the same drawings and the same reference numerals as in the above-described exemplary embodiment.

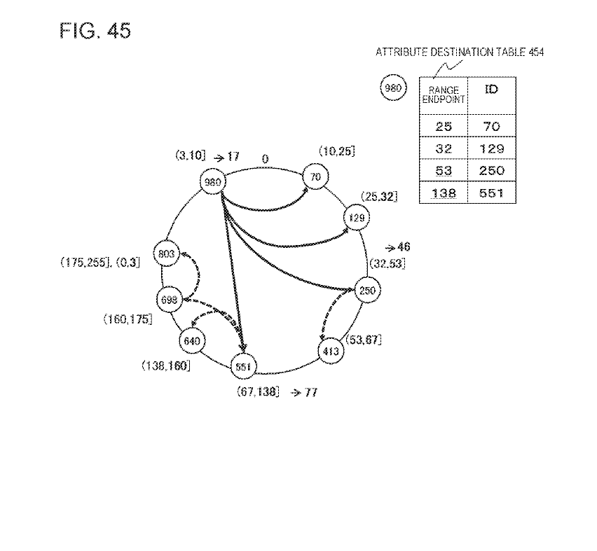

The present exemplary embodiment is different from the above-described exemplary embodiment in terms of process procedures of the destination resolving unit 340 and the range update unit 406, and is also different from the above-described exemplary embodiment in terms of the ID destination table 412 stored in the ID destination table storage unit 402 and the attribute destination table 414 stored in the attribute destination table storage unit 404. In the present exemplary embodiment, an ID destination table 452 (FIG. 57) is stored in the ID destination table storage unit 402, and an attribute destination table 454 (FIGS. 45 to 47) is stored in the attribute destination table storage unit 404. Other configurations may be the same as in the above-described exemplary embodiment.

In the information system 1 according to the exemplary embodiment of the present invention, the ID destination table constructing unit 410 which generates the ID destination table 452 stored in the ID destination table storage unit 402, and the ID retrieval unit 408 builds a transmission and reception relation between nodes on the basis of the Chord algorithm. In addition, not complete matching retrieval using an attribute value of a hash value of data as in the above-described exemplary embodiment, but range retrieval using an attribute value of data can be performed in the present exemplary embodiment.

As in the present exemplary embodiment, if a transmission and reception based on the Chord algorithm is used, there are the following advantages.

First, as compared with a case of the full mesh algorithm, the number of communication addresses of other nodes held by each node is reduced, and thus scalability is good. Second, there are a plurality of communication paths from each node to any other node, and a path is automatically selected by the algorithm and is thus resistant to path failures.

Further, in the present exemplary embodiment, there is an advantage unique to the present exemplary embodiment, of reducing problems in performance or consistency caused by an update load or update deficiency of the attribute destination table 454 which is required to be updated due to a variation in a data distribution. In other words, in the full mesh algorithm of the above-described exemplary embodiment, in a case where a range of data held by a certain node is changed, the node range endpoint is required to be reflected in the attribute destination table 414 in all of the other nodes. However, in the Chord algorithm of the present exemplary embodiment, the number of range endpoints stored in the attribute destination table 454 which is required to be updated is reduced in a transmission and reception relation between nodes generated by the Chord algorithm. For this reason, in the present exemplary embodiment, problems in performance or consistency caused by an update load or update deficiency is further reduced than in the above-described exemplary embodiment.

As above, according to the information system 1 of the present exemplary embodiment, a transmission and reception relation based on the DHT such as Chord is built, and thus a problem caused by update of the attribute destination table formed thereon is reduced.

In the information system 1 of the present exemplary embodiment, each node (the ID destination table constructing unit 410 of the data storage server 106 or the operation request relay server 108) divides a difference of the logical identifiers between own node and the respective other nodes by a size of the logical identifier space to obtain a remainder as a distance between the own node and the respective other nodes in the logical identifier space so as to select: a node having a minimum distance as an adjacent node(successor node); and another node closest to the own node, as a link destination(finger node) of the own node, from among the other nodes to which are assigned the respective logical identifiers more or equal to a distance apart from the own node by an exponentiation of 2.

In addition, each node holds, as a correspondence relation, a first correspondence relation (ID destination table 452) between destination nodes and logical identifier IDs of the destination nodes with a link destination (finger node) which is at least selected by the own node and an adjacent node (successor node) as the destination nodes, and a second correspondence relation (attribute destination table 454) between the logical identifier ID of the destination node and a range for each attribute of data managed by the node.

As described above, in the information system 1 of the present exemplary embodiment, the algorithm of the destination resolving unit performs transfer between nodes as in the DHT, and the data storage server 106 which receives an access request for data which is not managed by the own node functions as the operation request relay server 108.

Hereinafter, an operation of the information system 1 of the present exemplary embodiment will be described.

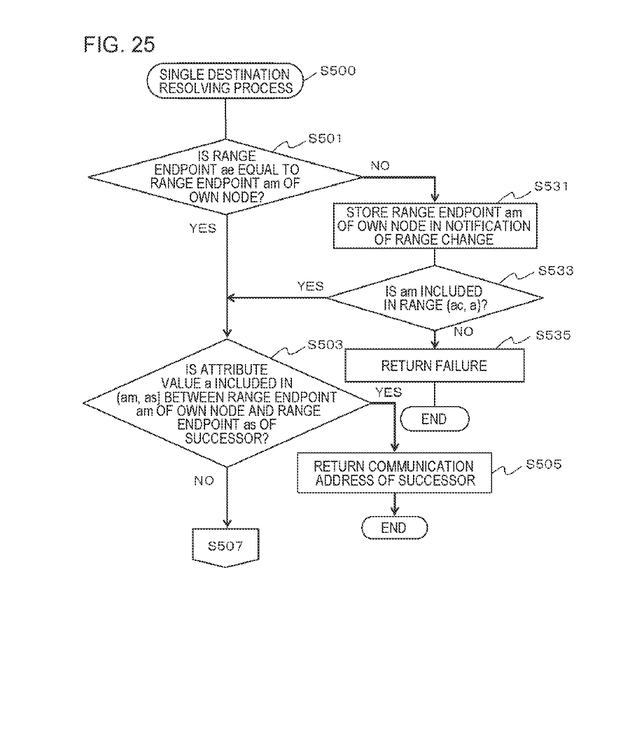

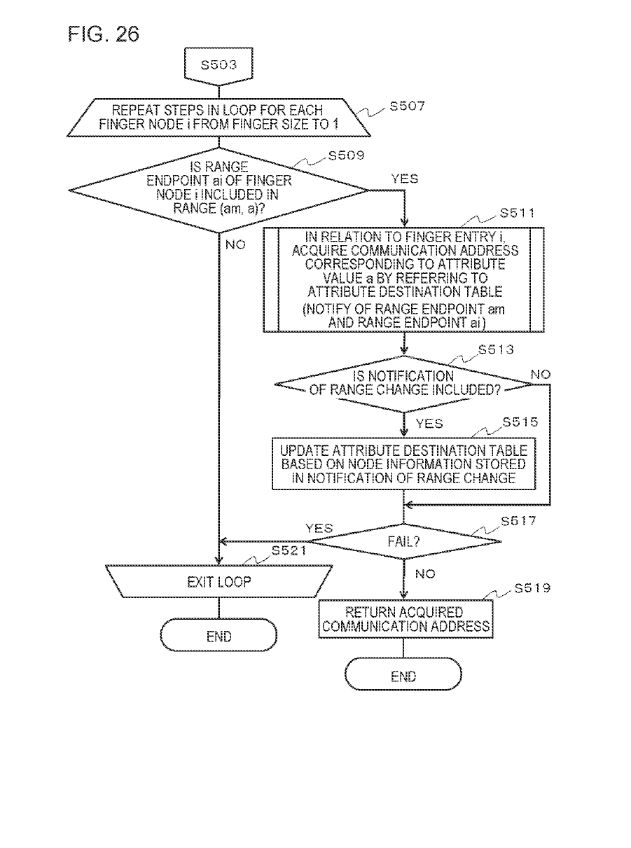

First, a description will be made of a single destination resolving process in the information system 1 of the present exemplary embodiment. FIGS. 25 and 26 are flowcharts illustrating an example of procedures of a single destination resolving process S500 in the information system 1 of the present exemplary embodiment. The present single destination resolving process S500 is performed by the single destination resolving unit 342 (FIG. 7) of the destination resolving unit 340 of the data operation client 104 (FIG. 4). Hereinafter, a description thereof will be made with reference to FIGS. 4, 7, 25 and 26.

The present single destination resolving process S500 may be performed from the data adding or deleting unit 362 (FIG. 7) or the data retrieval unit 364 (FIG. 7) of the own node m (the data operation client 104) and may be performed from the single destination resolving unit 342 of another node (the data operation client 104) through the relay unit 380 (the operation request relay server 108 of FIG. 4).

First, a description will be made of a case where the present single destination resolving process S500 is called by the data adding or deleting unit 362 of the operation request unit 360 of the own node m.

In this case, the data adding or deleting unit 362 notifies the single destination resolving unit 342 of a range endpoint ac of the call source and a range endpoint ae of a call destination recognized by the call source, along with a destination resolving request for acquiring a communication address corresponding to an attribute value a.

The single destination resolving unit 342 of a certain node m (the data operation client 104) determines whether or not the range endpoint ae of the call destination of which the notification is sent is the same as the range endpoint am of the own node m (step S501). Here, in the certain node m, since the present process S500 is called by the data adding or deleting unit 362 of the own node m, the call source is the same as the call destination, and thus the range endpoints ac, ae and am are the same as each other (YES in step S501), and the flow proceeds to step S503.

Next, the single destination resolving unit 342 determines whether or not the attribute value a is included in (am, as] between the range endpoint am of the own node m and the range endpoint as of the successor node (step S503).

If the attribute value a is included (YES in step S503), the single destination resolving unit 342 returns a communication address of the successor node to the call source (step S505), and finishes the present process.

On the other hand, if the attribute a is not included (NO in step S503), the flow proceeds to step S507 of FIG. 26, and a loop process between step S507 and step S521 is performed.

Here, as illustrated in FIG. 57, in the Chord algorithm, the ID destination table 452 includes a successor node corresponding to a logical identifier ID greater than that of the own node m as a successor list in the logical identifier ID space. In addition, the ID destination table 452 includes a plurality of communication addresses of nodes which are spaced apart from the own node m by a distance of the power of 2 as finger nodes. Further, the attribute destination table 454 also includes the information on the successor node and a plurality of finger nodes included in the ID destination table 452.

A process is repeatedly performed on each endpoint until i becomes 1 in order in which a range endpoint ai of the finger entry i in the attribute destination table 454 stored in the attribute destination table storage unit 404 of the destination table management unit 400 is distant from the range endpoint am of the own node m (varies from the size of the finger table to 1). First, it is determined whether or not the range endpoint ai of the node i is included in (am, a) between the range endpoint am of the own node m and the attribute value a (step S509).

In a case where the finger entry i included in (am, a) between the range endpoint am of the node and the attribute value a is found (YES in step S509), the flow proceeds to step S511. Step S509 is repeatedly performed until the entry is found, and the loop process exits when i reaches 1.

The single destination resolving process S450 described in FIG. 23 is performed on a node of the found finger entry i through the relay unit 380, and, as a result, a communication address of a node corresponding to the attribute value a is acquired (step S511). In addition, at this time, the range destination resolving unit 344 notifies the node of the finger entry i, of the range endpoint am of the own node m and the range endpoint ai of the node of the finger entry i stored in the attribute destination table 454 of the own node m, through the relay unit 380.

If a notification of range change is included in the result obtained in step S511 (YES in step S513), the range update unit 406 updates the attribute destination table 454 stored in the attribute destination table storage unit 404 on the basis of the information on the node included in the notification (step S515), and the flow proceeds to step S517. If the notification of range change is not included (NO in step S513), the flow proceeds to step S517.

Here, if a redirect destination is included in the result obtained in step S511, the data access process on the node i fails. If the data access does not fail (NO in step S517), the node of the finger entry i returns the acquired communication address to the call source, that is, the own node m through the relay unit 380 (step S519), and finishes the present process. If the data access fails (YES in step S517), the flow returns to step S509 where the loop process is continuously performed on the next finger entry i.

On the other hand, a description will be made of a case where the single destination resolving process S500 is called through the relay unit 380 of another node different from the own node m.

The single destination resolving unit 342 of a certain node m (the data operation client 104) determines whether or not the range endpoint ae of a call destination of which a notification has been sent is the same as the range endpoint am of the own node (step S501).

Here, since the present process S500 is called from the relay unit 380 of another node different from the own node m, the range endpoint ai of the finger entry i included in the attribute destination table 454 stored in the attribute destination table storage unit 404 of the destination table management unit 400 of the node which is a call source may be different from the range endpoint am of the own node m which is a call destination. Therefore, in this case, since the range endpoint ae of the call source is not the same as the range endpoint am of the own node m (NO in step S501), the range endpoint am is included in information returned to the call source as a notification of range change by the single destination resolving unit 342 (step S531).

Next, if the range endpoint am of the own node m is included in the range (ac, a) (YES in step S533), the flow proceeds to step S503. If the range endpoint am is not included therein (NO in step S533), a failure is returned to the call source (step S535), the present process finishes.

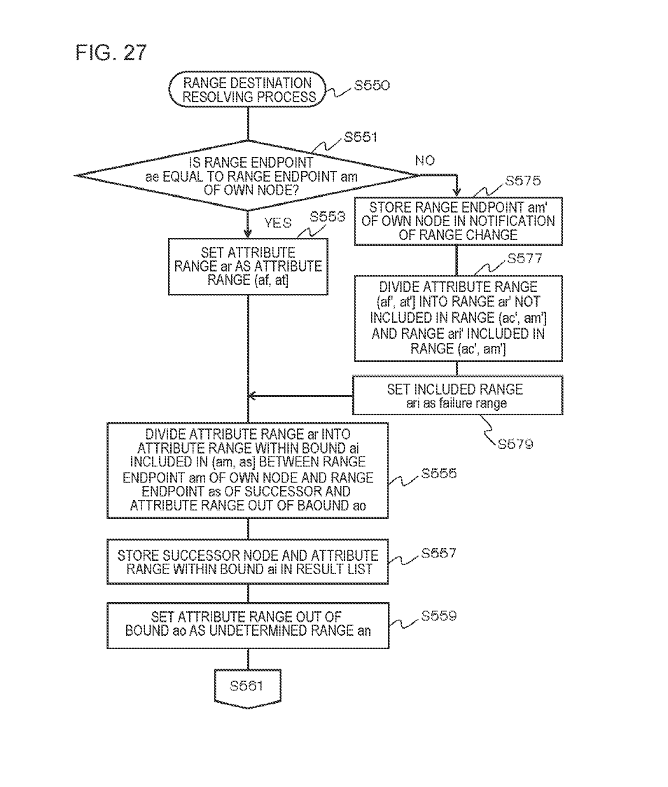

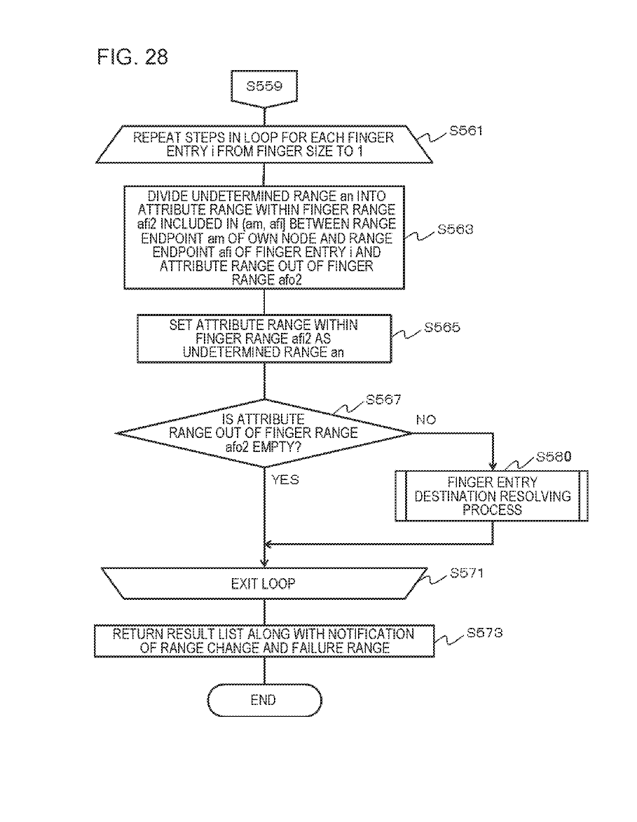

Next, a description will be made of a range destination resolving process in the information system 1 of the present exemplary embodiment. FIGS. 27 and 28 are flowcharts illustrating an example of procedures of a range destination resolving process S550 in the information system 1 of the present exemplary embodiment. The range destination resolving process is performed by the range destination resolving unit 344 of the destination resolving unit 340 of the data operation client 104 (FIG. 4). Hereinafter, a description thereof will be made with reference to FIGS. 4, 7, 27 and 28.

The present range destination resolving process S550 may be performed from the data adding or deleting unit 362 (FIG. 7) or the data retrieval unit 364 (FIG. 7) of the own node m (the data operation client 104) and may be performed from the range destination resolving unit 344 of another node (the data operation client 104) through the relay unit 380 (the operation request relay server 108 of FIG. 4).

First, a description will be made of a case where the range destination resolving process S550 is called by the data retrieval unit 364 (FIG. 7) of the own node m.

In this case, the data retrieval unit 364 notifies the range destination resolving unit 344 of a range endpoint ac of the call source and a range endpoint ae of a call destination recognized by the call source, along with a destination resolving request for acquiring a communication address corresponding to an attribute range (af, at).

The range destination resolving unit 344 of a certain node m (the data operation client 104) determines whether or not the range endpoint ae of the call destination of which the notification is sent is the same as the range endpoint am of the own node m (step S551). Here, in the certain node m, since the present process S500 is called by the data retrieval unit 364 of the own node m, the call source is the same as the call destination, and thus the range endpoints ac, ae and am are the same as each other (YES in step S551), and the flow proceeds to step S553.

Next, the range destination resolving unit 344 sets the attribute range ar as an attribute range (af, at] (step S553). In addition, the range destination resolving unit 344 divides the attribute range ar into an attribute range within bound ai which is included in (am, as] between the range endpoint am of the own node m and the range endpoint as of the successor node and a range-outside attribute range ao (step S555). Further, if there is the attribute range within bound ai, the range destination resolving unit 344 includes and holds the successor node (the communication address and the range endpoint) in a result list (step S557).

Next, the range destination resolving unit 344 sets the attribute range out of bound ao as an undetermined set an (step S559). Subsequently, the flow proceeds to FIG. 28, and a loop process between step S561 and step S571 is performed. In addition, in the present exemplary embodiment, the attribute range may include two ranges, and may be referred to as an “attribute range” or an “attribute range set”.

A process is repeatedly performed on each endpoint until i becomes 1 in order in which the finger entry i in the attribute destination table 454 stored in the attribute destination table storage unit 404 of the destination table management unit 400 is distant from the range endpoint am of the own node m (varies from the size of the finger table to 1).

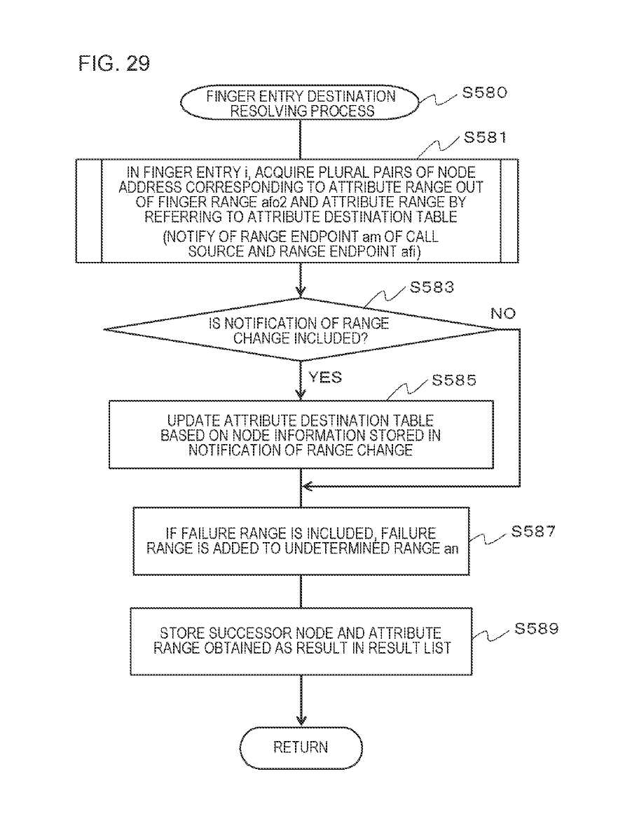

First, the range destination resolving unit 344 divides the undetermined range set an into an attribute range within the finger range afi2, which is included in (am, afi] between the range endpoint am of the own node m and afi of the finger entry i and an attribute range out of the finger range afo2, which is not included therein (step S563). In addition, the range destination resolving unit 344 sets the attribute range within the finger range afi2 as the undetermined range set an (step S565). Further, if the attribute range out of the finger range afo2 is not empty (NO in step S567), the range destination resolving unit 344 performs a finger entry destination resolving process S580 of FIG. 29, which will be described later, (step S580). If the attribute range out of the finger range afo2 is empty (YES in step S567), the flow proceeds to step S571. When the process for each of all the finger entries of the finger table is completed, the present loop process exits (step S571). Furthermore, the range destination resolving unit 344 returns a notification of range change, a failure range, and the result list to a reading source (step S573).

On the other hand, a description will be made of a case where the range destination resolving process S550 is called through the relay unit 380 of another node different from the own node m.

Here, since the present process S550 is called from the relay unit 380 of another node different from the own node m, the range endpoint ai of the finger entry i included in the attribute destination table 454 stored in the attribute destination table storage unit 404 of the destination table management unit 400 of the node which is a call source may be different from the range endpoint am of the own node m which is a call destination.

Here, when “′” is attached to a value of a called node for description, a range endpoint of the call source is ac′=am, and a range endpoint of the call destination recognized by the call source is ae′=afi.

In addition, the range destination resolving unit 344 compares the range endpoint am′ of the own node m with the range endpoint ae′ of which a notification has been sent (step S551). If the range endpoint am′ is different from the range endpoint ae′ (NO in step S551), the range destination resolving unit 344 stores the range endpoint am′ of the own node m in a notification of range change (step S575).

Further, the range destination resolving unit 344 divides the attribute range (af′, at′] into a range ar′ which is not included in the range (ac′, am′] and a range ari′ included therein (step S577). The range destination resolving unit 344 sets the range ari′ included in the range (ac′, am′] as a failure range (step S579). Subsequently, the flow proceeds to step S555, and the above-described procedures are performed in the same manner.

As a result, the notification of range change, the failure range, and the result list are returned from the range destination resolving unit 344 to the call source (step S573), and the present process finishes.

Next, a description will be made of procedures of the finger entry destination resolving process in step S580 of FIG. 28 with reference to FIG. 29.

First, the range destination resolving unit 344 performs the range destination resolving process S460 described in FIG. 24 on the node of the finger entry i through the relay unit 380, and thus acquires a plurality of pairs of a destination (communication address) of a node corresponding to the attribute range out of the finger range afo2 obtained in the range destination resolving process S550 and an attribute range (step S581). In addition, at this time, the range destination resolving unit 344 notifies the node of the finger entry i of the range endpoint am of the call source and the range endpoint afi of the call destination recognized by the call source through the relay unit 380.

Further, if a notification of range change is included (YES in step S583), the call source node which is a source calling the present process updates the attribute destination table 454 stored in the attribute destination table storage unit 404 on the basis of the information on the node included in the notification (step S585), and the flow proceeds to step S587. If the notification of range change is not included (NO in step S583), the flow proceeds to step S587.

If a failure range is included in the result obtained in step S581, the original call source node adds the failure range to the undetermined range an (step S587).

In addition, the original call source node stores the successor node and the attribute range obtained as the result in a result list (step S589), finishes the present process, and returns to the flow of FIG. 28. Subsequently, the same process is performed on the undetermined range set an in relation to the next finger entry i, and a result list which is finally obtained is returned to the call source (step S573).

Due to the above-described process, the information system 1 of the present exemplary embodiment can specify a node corresponding to a destination of an access request from an attribute value of the access-requested data.

As described above, according to the information system 1 of the present exemplary embodiment, a transmission and reception relation between the nodes is built on the basis of the Chord algorithm, and thus the following effects are achieved.

First, as compared with a case of the full mesh algorithm, the number of communication addresses of other nodes held by each node is reduced, and thus scalability is good. Second, there are a plurality of communication paths from each node to any other node, and a path is automatically selected by the algorithm and is thus resistant to path failures.

Further, in the present exemplary embodiment, there is an advantage unique to the present exemplary embodiment, of reducing a performance problem or a consistency problem caused by an update load or update deficiency of the attribute destination table 454 which is required to be updated due to a variation in a data distribution. In other words, in the full mesh algorithm of the above-described exemplary embodiment, in a case where a range of data held by a certain node is changed, the node range endpoint is required to be reflected in the attribute destination table 414 in all of other nodes. However, in the Chord algorithm of the present exemplary embodiment, the number of range endpoints stored in the attribute destination table 454 which is required to be updated is reduced in a transmission and reception relation between nodes generated by the Chord algorithm. For this reason, in the present exemplary embodiment, a performance problem or a consistency problem caused by an update load or update deficiency is further reduced than in the above-described exemplary embodiment.

As above, according to the information system 1 of the present exemplary embodiment, a transmission and reception relation based on the DHT such as Chord is built, and thus a problem caused by the update of the attribute destination table formed thereon is reduced.

Furthermore, according to the present invention, it is possible to cause the number of hops required to transfer a data access request not to be reduced, and to cause a bias of a transfer load not to vary because of a distribution of registered data.

The reason is as follows. In the information system 1 of the present exemplary embodiment, a destination table is constructed for each attribute separately from a destination table indicating a transmission and reception relation built using a relation between IDs of nodes. In addition, a variation in a distribution is reflected through a variation in the destination table, and thus it is not necessary to change the destination table in which the transmission and reception relation is built.

In addition, in the above-described first approach, there is a problem in that, when a plurality of attributes are handled, a data access characteristic of another attribute is influenced by a variation in a distribution of data on a certain attribute, or the number of other nodes registered in the destination table increases in accordance with the number of attributes. In addition, there is a problem in that, if the number of nodes registered in the destination table increases, clusters are closely combined with each other, and thus a failure in a certain node has wide influence, or communication resources (a socket or the like) on the nodes are exhausted.

The reason is as follows. In the information system 1 of the present exemplary embodiment, a destination table is determined on the basis of a distribution of an attribute of stored data. For this reason, if a single destination table is shared between a plurality of attributes, the destination table is updated due to a variation in a distribution of a certain attribute, and this influences the number of hops and the order of other attributes. In addition, if a destination table is provided for each of a plurality of attributes, and other nodes are registered therein, there is no influence, but there is a problem in that a size of the destination table increases in accordance with the number of attributes.

According to the present invention, even when a plurality of attributes are handled for various applications, a destination table formed by different nodes for each attribute is created so as not to increase the number of participating nodes. In addition, a variation in a distribution of data registered for a certain attribute does not influence the performance of acquiring a destination of another attribute through the update of the destination table.

The reason is as follows. In the information system 1 of the present exemplary embodiment, a destination table is constructed for each attribute separately from a destination table indicating a transmission and reception relation built using a relation between IDs of nodes. In addition, in the information system 1 of the present exemplary embodiment, a variation in a certain attribute causes a variation only in a destination table of the attribute, and thus the destination table constructed from IDs is not changed.

### Third Exemplary Embodiment

An information system according to the exemplary embodiment of the present invention is different from the information system of the above-described exemplary embodiment in that the Koorde algorithm of the DHT is used in a destination resolving process. In addition, procedures of a process performed by each constituent element using the drawings in the above-described exemplary embodiment are different in the present exemplary embodiment and the above-described exemplary embodiment, but the same configuration will be described below using the same drawings and the same reference numerals as in the above-described exemplary embodiment.

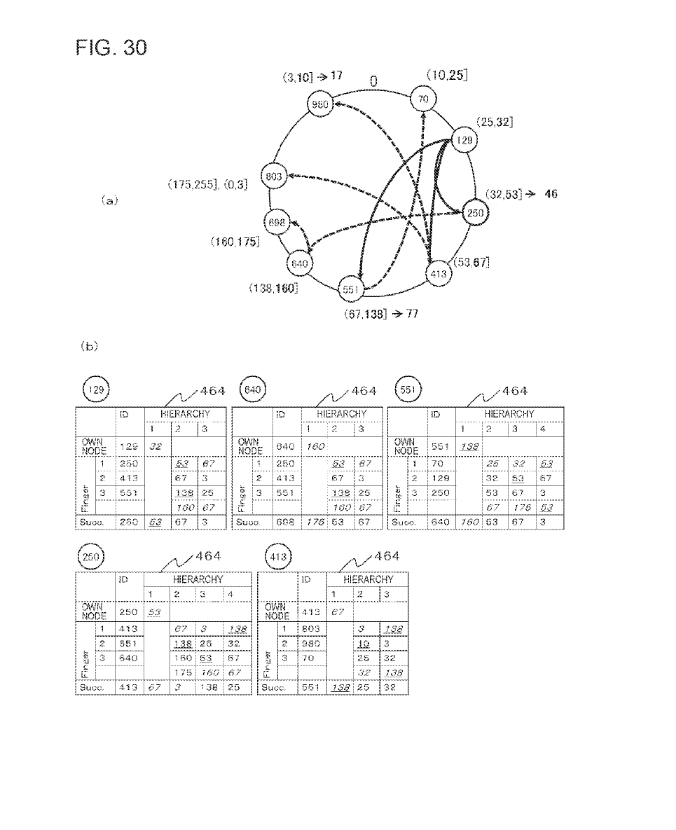

The present exemplary embodiment is different from the above-described exemplary embodiment in terms of process procedures of the destination resolving unit 340 and the range update unit 406, and is also different from the above-described exemplary embodiment in terms of the ID destination table 412 stored in the ID destination table storage unit 402 and the attribute destination table 414 stored in the attribute destination table storage unit 404. In the present exemplary embodiment, an ID destination table 462 (not illustrated) is stored in the ID destination table storage unit 402, and an attribute destination table 464 (FIG. 30) is stored in the attribute destination table storage unit 404. Other configurations may be the same as in the above-described exemplary embodiment.

In the information system 1 according to the present exemplary embodiment, the ID destination table constructing unit 410 which generates the ID destination table 412 stored in the ID destination table storage unit 402, or the ID retrieval unit 408 builds a transmission and reception relation between nodes on the basis of the Koorde algorithm. In addition, not complete matching retrieval using an attribute value of a hash value of data as in the above-described exemplary embodiment, but range retrieval using an attribute value of data can be performed in the present exemplary embodiment.

In addition, in the information system 1 of the present exemplary embodiment, using a transmission and reception relation based on the Koorde algorithm is advantageous in that the number of nodes (order) stored in a destination table of each node is variable unlike in the Chord algorithm. Further, in the same order, the number of hops relayed by the relay unit tends to be reduced. In other words, in the Chord algorithm, the order and the number of hops are O(log 2(N)) for all the number N of nodes. However, in the Koorde algorithm, when the order is k, the number of hops is O(log k(N)), and when k is O(log 2(N)), the number of hops is O(log(N)/log(log(N))) for the order O(log(N)).

In addition, as an advantage unique to the present invention, since the number of nodes in the attribute destination table which is required to be updated in each node of the present invention, it is possible to increase a frequency of confirming an autonomous range change or the number of nodes of which a notification is sent from the smoothing control unit.

In the present exemplary embodiment, unlike in the above-described exemplary embodiment using the Chord algorithm, the type of attribute destination table 464 stored in the attribute destination table storage unit 404 is different. This stems from how the Chord algorithm and the Koorde algorithm use a transmission and reception relation between nodes included in the ID destination table 462 which is generated by the ID destination table constructing unit 410. In any case, in order to specify a node which stores search target data, a storage destination is narrowed down from all data sets at every relay by the relay unit. For example, when a search space becomes a half every relay, 100 nodes are narrowed down to 50 nodes in the first relay, and 50 nodes are narrowed down to 25 nodes, and 25 nodes are narrowed down to 12 nodes, in subsequent relays.

The Chord algorithm and the Koorde algorithm are different from each other in terms of a realization method thereof. In the Chord algorithm, a finger is selected in which a search space of the ID destination table is wide in the relay by the relay unit, and a finger is selected in which the search space is narrow as narrowing-down progresses. In other words, in the Chord algorithm, finger nodes stored in the ID destination table of any node have different functions. A certain finger node has a function of reducing 100 nodes to 50 nodes, and another finger node reduces 25 nodes to 12 nodes.

In contrast, in the Koorde algorithm, a function of reducing a search space, of each finger stored in the ID destination table, is nearly the same in any finger. In other words, in any finger node, all the finger nodes have a function of reducing 100 nodes to 50 nodes in some cases, and all the finger nodes have a function of reducing 50 nodes to 25 nodes in other cases.

Regardless thereof, a search space is reduced from 100 nodes to 50 nodes in the first relay, and, in order to produce narrowing-down for more reduction such as a reduction from 25 nodes to 12 nodes, information corresponding to the number of relays is included in a relay message of a data access request, and the ID destination table is referred to by appropriately updating or referring to the information. The ID reference table is referred to, and thus a property regarding the number of hops for the order is better in complete matching retrieval based on a hash value of data in the Koorde algorithm than in the Chord algorithm. More specifically, information on which leading bit of a hash value of accessed data is taken into consideration is referred to or updated on the basis of the number of relays.

In the information system 1 of the present exemplary embodiment, since Koorde algorithm performs not complete matching retrieval based on an aimed hash value but a process based on ordering of attributes, such as range retrieval based on an attribute range, a method of designing and referring to a destination table, which works in a case of the hash value of which stochastic uniformity is ensured, is required to be changed since the uniformity is not ensured any longer.

In other words, although, in the Koorde algorithm, the ID destination table which does not depend on the number of relays by the relay unit is constructed, and the ID retrieval unit includes a data access request which is relayed so as to refer to the ID destination table which depends on the number of relays, in the present exemplary embodiment, it is necessary to construct an attribute destination table which depends on the number of relays by the relay unit. The reason is as follows. In a case of a hash value, stochastic uniformity is a feature thereof, and when data is allocated on the basis of several bits of arbitrary low-order bits in a state in which several high-order bits are specified and the low-order bits are not specified, an allocation distribution can be expected to be nearly constant regardless of position of the specified bits. However, in a case of an attribute value, there is no distribution information, and thus it cannot be expected.

For example, in a case where there are ten thousand pieces of information (10******) in which 10 is specified up to two bits in a 8-bit hash value, and the next two bits are divided (allocated to finger nodes) into patterns of 00, 01, 10, and 11, a proportion thereof is about 25% in every pattern, and it can be determined from stochastic uniformity of the hash value that this is the same for an allocation distribution in a case of specifying the next two bits of 1011**** in which the high-order four bits are specified to 1011.

In contrast, if an attribute having any distribution, for example, an age is treated as a 8-bit value, a difference between a proportion of allocating the next two bits in a value 10****** (128 to 191) of which the leading bits are specified to 10 and a proportion of allocating the next two bits in a value 0001**** (16 to 31) of which the leading bits are specified to 0001 can be expected from a distribution of the age which is registered data. For this reason, in the present exemplary embodiment, since attribute destination table which depends on the number of relays by the relay unit is required to be constructed, an attribute destination table of the present exemplary embodiment and an operation of an attribute destination table constructed by the range update unit will become apparent.

The attribute destination table 464 of the present exemplary embodiment will be described with reference to tables of FIG. 30.

The attribute destination table 464 includes a successor node which is constructed by the Koorde algorithm and is stored in the ID destination table 462 and a plurality of range endpoints for each finger node. The finger nodes here are ordered, and a node which is a predecessor of an integer multiple of the own node m is set as a finger node 1, and a successor node thereof is set as a finger node 2. In addition, the attribute destination table 464 is classified into hierarchies, and is stored in a state in which a range endpoint can be acquired from a hierarchy and an ID. A range endpoint is stored for each hierarchy in relation to each finger, but when the number of finger nodes is N, it is assumed that, from a finger node N, a range endpoint of a successor node thereof is obtained, and, for convenience, this is referred to as a finger node N′. In this information, a node m may be acquired by increasing the number of finger nodes, but, this case may be determined as the order being incremented by 1.

In addition, a hierarchy range is defined in each hierarchy. A starting point of a hierarchy range in a hierarchy 1 is a range endpoint am of the node, a terminal point thereof is a range endpoint as of the successor node, and thus the hierarchy range is (am, as]. In a hierarchy 2 or higher, a starting point alf of a hierarchy range is a range endpoint of the finger node 1. A terminal point thereof uses a range endpoint als of the successor node or a range endpoint alf′ of the finger N′. Suitably, the terminal point is a value which is spaced farther from the range endpoint of the finger node 1, of the range endpoint als of the successor node and the range endpoint alf′ of the finger N′. In other words, if als is included in (alf, alf′], alf′ may be used, and, conversely, if alf′ is included in (alf, als], als may be used.

In addition, a determination on whether or not a terminal point is included in this hierarchy range corresponds to a process of determining whether or not an imaginary node in the Koorde algorithm is included between own node m and the successor node, but the determination can be performed since range information for each hierarchy which is necessary unlike in the Koorde algorithm is given.

In the information system 1 of the present exemplary embodiment, each node (the ID destination table constructing unit 410 of the data storage server 106 or the operation request relay server 108): obtains a distance between own node and another node as a remainder obtained by a difference between logical identifier IDs of the own node and another node by a size of a logical identifier space in the logical identifier space; sets a node having the minimum distance as an adjacent node (successor node); and selects a node with the shortest distance from a logical identifier ID which remains when a logical identifier ID of an integer multiple of the own node is divided by the size of the logical identifier space, and nodes of a specific number with the shortest distance from the node, as link destinations (finger nodes) of the own node.

In addition, each node holds, as a correspondence relation, a first correspondence relation (ID destination table 462) between destination nodes and logical identifier IDs of the destination nodes with a link destination (finger node) which is at least selected by the own node as the destination node, and a second correspondence relation (attribute destination table 464) between the logical identifier ID of the destination node and a range for each attribute of data managed by the node. The second correspondence relation holds a range for each attribute of data at every hierarchy of the destination node.

As described above, in the information system 1 of the present exemplary embodiment, the algorithm of the destination resolving unit performs transfer between nodes as in the DHT, and the data storage server 106 which receives an access request for data which is not managed by the own node functions as the operation request relay server 108.

Hereinafter, an operation of the information system 1 of the present exemplary embodiment will be described.

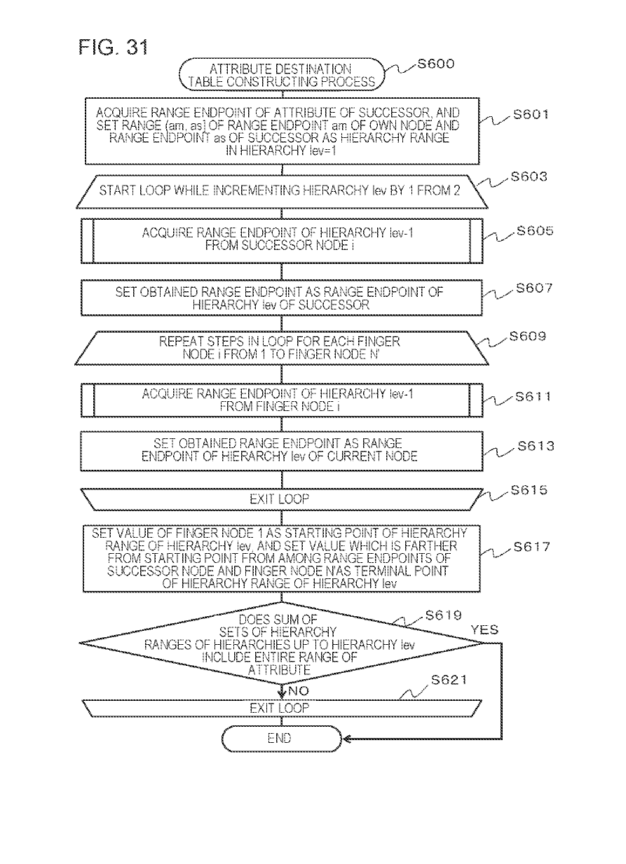

First, a description will be made of a process of constructing the attribute destination table 464 in the information system 1 of the present exemplary embodiment. FIG. 31 is a flowchart illustrating an example of procedures of an attribute destination table constructing process S600 of the present exemplary embodiment. This attribute destination table constructing process S600 is performed by the range update unit 406 (FIG. 7) of the destination table management unit 400 of the data operation client 104 (FIG. 4). Hereinafter, a description thereof will be made with reference to FIGS. 4, 7, 30 and 31.

The present process S600 is performed after a range is assigned to each data storage server when it is defined that an attribute designated from a user is stored in the data management system.

First, the range update unit 406 of a certain node m (the data operation client 104) inquires the successor node about the range endpoint as so as to the range endpoint, in relation to an attribute which constructs the attribute destination table 464. The range update unit 406 stores a range (am, as] with the range endpoint am of the node m in the attribute destination table 464 as a hierarchy range of the hierarchy 1 (step S601).

Next, while a hierarchy lev is incremented from 2 by 1, a loop process between step S603 and step S621 is performed. The range update unit 406 acquires a range endpoint of a hierarchy lev-1 from the successor node i at a hierarchy lev of 2 (step S605). In addition, the range update unit 406 sets the obtained range endpoint as a range endpoint of a node hierarchy lev of the successor node i (step S607).

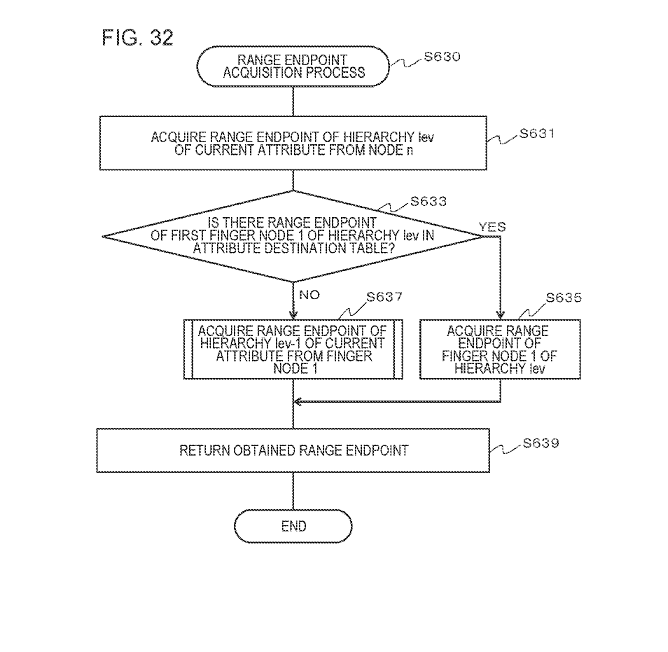

In addition, the loop process between step S609 and step S615 is performed on each of the finger nodes stored in the ID destination table 462. If the process for each of all the finger nodes included in the ID destination table 462 is completed, the present loop process exits (step S615). The range update unit 406 performs a range endpoint acquisition process S630 (FIG. 32) of acquiring a hierarchy range on the hierarchy lev-1 from the finger node i (step S611). The present process will be described with reference to FIG. 32.

A starting point of each hierarchy range obtained from the finger node i in step S611 is stored in the attribute destination table 464 as a range endpoint in the hierarchy of the finger node i (step S613).

At this time, the range endpoint acquisition process S630 is performed in the finger node i called in step S611. FIG. 32 is a flowchart illustrating an example of procedures of the range endpoint acquisition process in the information system 1 of the present exemplary embodiment. In the finger node i, the present process is performed by the range update unit 406 of the destination table management unit 400.

First, the finger node i (the data operation client 104 of FIG. 4) acquires the range endpoint of the hierarchy lev of the attribute from a node n which is a call source (step S631). In addition, in order to return the range endpoint of the hierarchy lev, if there is a range endpoint of the first finger node 1 of the hierarchy lev (YES in step S633), the finger node i acquires the range endpoint from the attribute destination table 464 stored in the attribute destination table storage unit 404 of the destination table management unit 400 (step S635).

If there is no range endpoint (NO in step S633), the first finger node 1 is inquired about the range endpoint of the hierarchy lev-1, and the range endpoint is acquired (step S637). In addition, the results obtained in step S635 and step S637 are returned to the node n which is a call source (step S639).

Referring to FIG. 31 again, the process is repeatedly performed up to the finger node N′, but this is treated in the same manner as a case where the actual finger node N is inquired about a successor node thereof and the successor node is obtained. Subsequently, the starting point of the finger node 1 is set as a starting point of the hierarchy range of the hierarchy lev, and a range endpoint which is the farthest from the starting point from among the range endpoints of the finger node N′ and the successor node of this hierarchy is set as a terminal point of the hierarchy range of the hierarchy lev (step S617).

The loop process is repeatedly performed on the respective hierarchies, and is continuously performed until a sum of sets of the hierarchy ranges up to the hierarchy lev includes the entire attribute space. If the sum of sets of the hierarchy ranges up to the hierarchy lev includes the entire attribute space (YES in step S619), the loop process exits (step S621), and the present process finishes.

Next, a description will be made of a single destination resolving process in the information system 1 of the present exemplary embodiment.

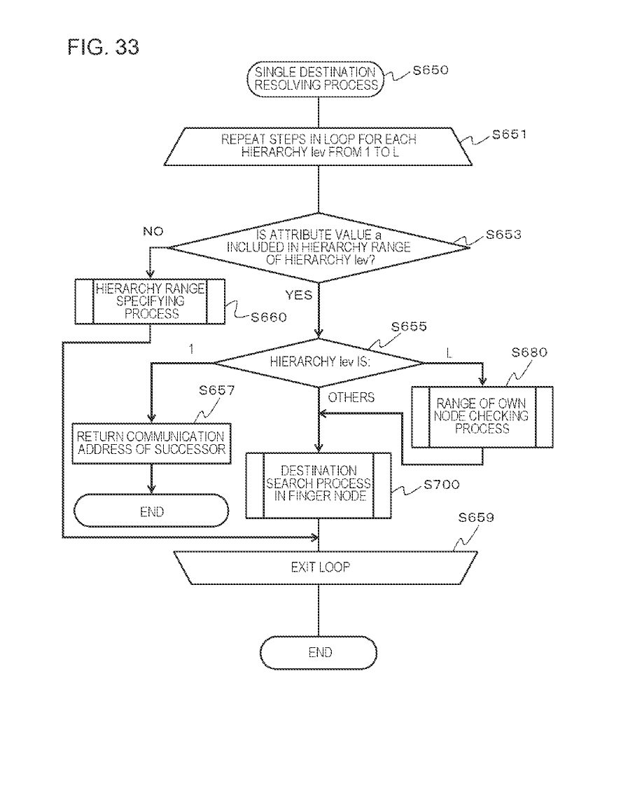

FIGS. 33 to 36 are flowcharts illustrating an example of procedures of a single destination resolving process S650 in the information system 1 of the present exemplary embodiment. The single destination resolving process S650 is performed by the single destination resolving unit 342 (FIG. 7) of the destination resolving unit 340 of the data operation client 104 (FIG. 4). Hereinafter, a description thereof will be made with reference to FIGS. 4, 7 and 33 to 36.

The present single destination resolving process S650 may be performed from the data adding or deleting unit 362 (FIG. 7) or the data retrieval unit 364 (FIG. 7) of the own node m (the data operation client 104) and may be performed from the single destination resolving unit 342 of another node (the data operation client 104) through the relay unit 380 (the operation request relay server 108 of FIG. 4).

Here, a description will be made of a case where the present single destination resolving process S650 is called by the data adding or deleting unit 362 of the operation request unit 360 of the own node m.

In this case, the data adding or deleting unit 362 notifies the single destination resolving unit 342 of a range endpoint ac of the call source and a range endpoint ae of a call destination recognized by the call source, along with a destination resolving request for acquiring a communication address corresponding to an attribute value a.

In the present process S650, a loop process between step S651 and step S659 is performed each hierarchy lev until the hierarchy lev is incremented from 1 by 1 and reaches a given hierarchy L. If the process for each of all the hierarchies lev is completed, the loop process exits, and the present process also finishes.

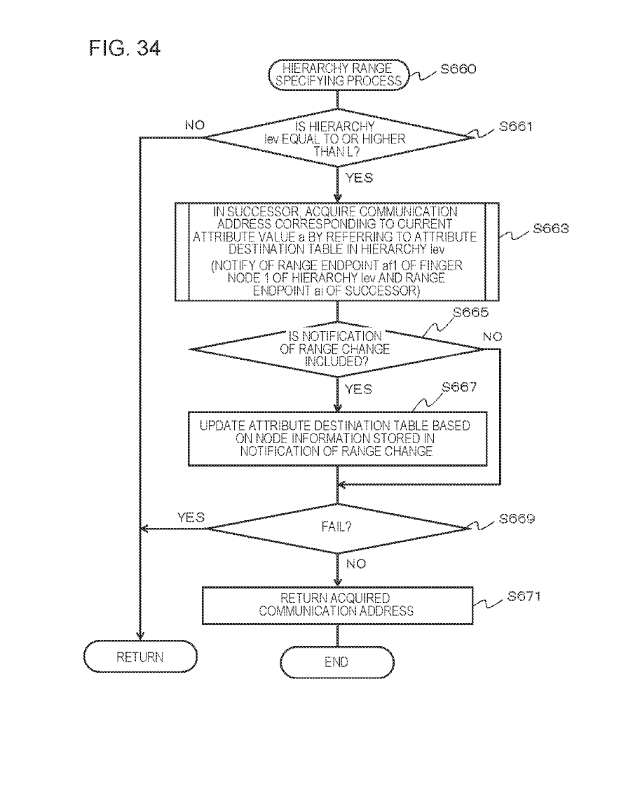

First, the single destination resolving unit 342 of a certain node m (the data operation client 104) determines whether or not a range a is included in a hierarchy range of the hierarchy lev (step S653). If the range a is not included therein (NO in step S653), the flow proceeds to FIG. 34, and a hierarchy range specifying process S660 for specifying a hierarchy range including the attribute value a is performed.

In the hierarchy range specifying process S660 illustrated in FIG. 34, in a case where the hierarchy L is reached (YES in step S661), the single destination resolving unit 342 inquires the successor node of the own node m about a process of obtaining a communication address corresponding to the attribute value a in the hierarchy lev (step S663).

At this time, the single destination resolving unit 342 notifies the successor node of the range endpoint af1 of the first finger node 1 of the hierarchy lev, recognized by the own node m, and the range endpoint ai of the successor node. The successor node refers to the attribute destination table 464, and acquires and returns a communication address corresponding to the attribute value a in the hierarchy lev. At this time, the successor node compares the range endpoint of the attribute destination table 464 and the range endpoint of which a notification has been sent on the basis of the information on the range endpoint of which the notification has been sent, and returns a notification of range change if there is a difference therebetween.

In addition, if the notification of range change is included in the execution result returned from the successor node (YES in step S665), the single destination resolving unit 342 reflects the information on the notification of range change in the attribute destination table 464 for update (step S667), and the flow proceeds to step S669. If the notification of range change is not included therein (NO in step S665), the flow proceeds to step S669.

Here, if a redirect destination is included in the result obtained in step S663, the data access process on the node fails. If the data access is successful (NO in step S669), the obtained result is returned to the call source (step S671), and the single destination resolving process finishes. If the data access fails (YES in step S669), the flow returns to the flow of FIG. 33 in which the hierarchy lev is incremented by 1, the loop process is repeatedly performed on the next hierarchy lev (a hierarchy higher than the hierarchy L), and a determination is performed on whether or not the attribute value is included in a hierarchy range (step S653). In addition, if the hierarchy lev does not reach the hierarchy L (NO in step S661), the flow returns to the flow of FIG. 33 in which the hierarchy lev is incremented by 1, and the loop process is repeatedly performed on the next hierarchy lev.

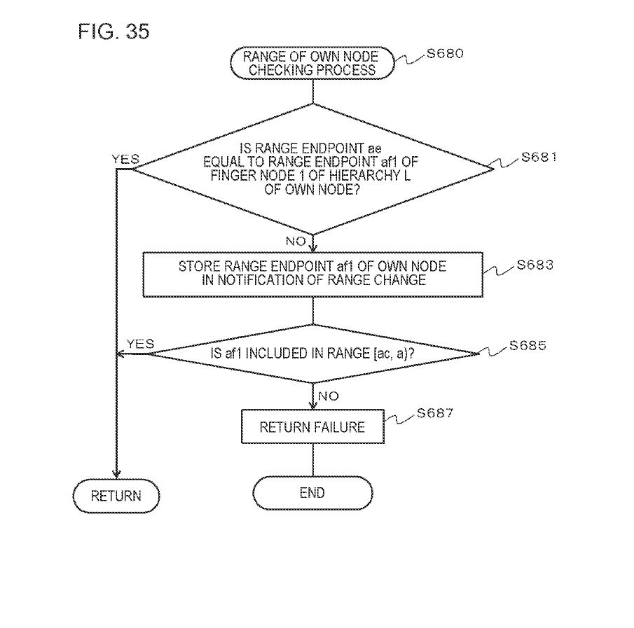

In FIG. 33, if the hierarchy lev including the attribute value a is specified in the process of FIG. 34 (YES in step S653), the flow proceeds to step S655. If the hierarchy lev is 1, the single destination resolving unit 342 returns the communication address of the successor node to the call source (step S657). If the hierarchy lev is L, the flow proceeds to a range checking process S680 of the own node m of FIG. 35.

In the range checking process S680 illustrated in FIG. 35, the single destination resolving unit 342 determines whether or not the range endpoint ae of which a notification has been sent matches the range endpoint af1 of the finger node 1 of the hierarchy L of the own node m (step S681). If they do not match each other (NO in step S681), the range endpoint af1 of the finger node 1 of the hierarchy L of the own node m is stored in a notification of range change (step S683). In addition, it is determined whether or not the range endpoint af1 is included in a range [ac, a) (step S685). If the range endpoint af1 is not included therein (NO in step S685), a failure in resolving a destination is returned to the call source (step S687), the single destination resolving process finishes.

If the range endpoint ae of which a notification has been sent matches the range endpoint af1 (YES in step S681), or if the range endpoint af1 is included in the range [ac, a) (YES in step S685), the flow returns to the flow of FIG. 33 and proceeds to step S700, and the process is continuously performed.

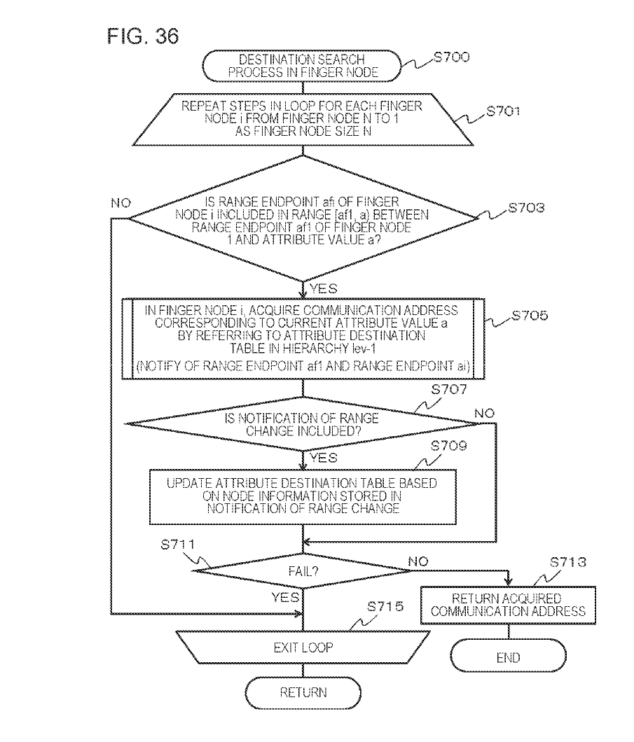

In FIG. 33, if the hierarchy lev is neither 1 nor L in the determination in step S655 (others in step S655), or after the range checking process S680 of the own node of FIG. 35, the flow proceeds to step S700, and a destination search process S700 is performed in a finger node of FIG. 36.

The single destination resolving unit 342 performs a loop process between step S701 and step S715 for each of the finger node i from the finger node N to the finger node 1 when a finger node size is N. If the process for each of all the finger nodes is completed, the present loop process exits.

The single destination resolving unit 342 determines whether or not the range endpoint afi of the finger node i is included in a range [af1, a) of the range endpoint af1 of the finger node 1 and the attribute value a (step S703). If the range endpoint afi is not included therein (NO in step S703), the process is continuously performed on the next finger.

If the range endpoint afi is included therein (YES in step S703), the single destination resolving unit 342 inquires the finger node i about a communication address corresponding to the attribute value a in the hierarchy lev-1 and acquires the communication address (step S705). At this time, the single destination resolving unit 342 notifies the finger node i of the range endpoint af1 and the range endpoint ai recognized by the own node m.

If a notification of range change is included in the result returned from the finger node i (YES in step S707), the single destination resolving unit 342 updates the attribute destination table 464 on the basis of the information on the notification of range change (step S709).

In addition, if an inquiry result in step S705 does not fail (NO in step S711), the address acquired from the finger node i is returned to the call source (step S713), and the single destination resolving process is performed. If the inquiry in step S705 fails (YES in step S711), a process on the next finger node progresses. As above, each node refers to the attribute destination table 464 of a low hierarchy, searches in a range with which finger node of a hierarchy an aimed attribute value is included in each hierarchy, and inquires the finger node through a network so as to finally reach a destination.

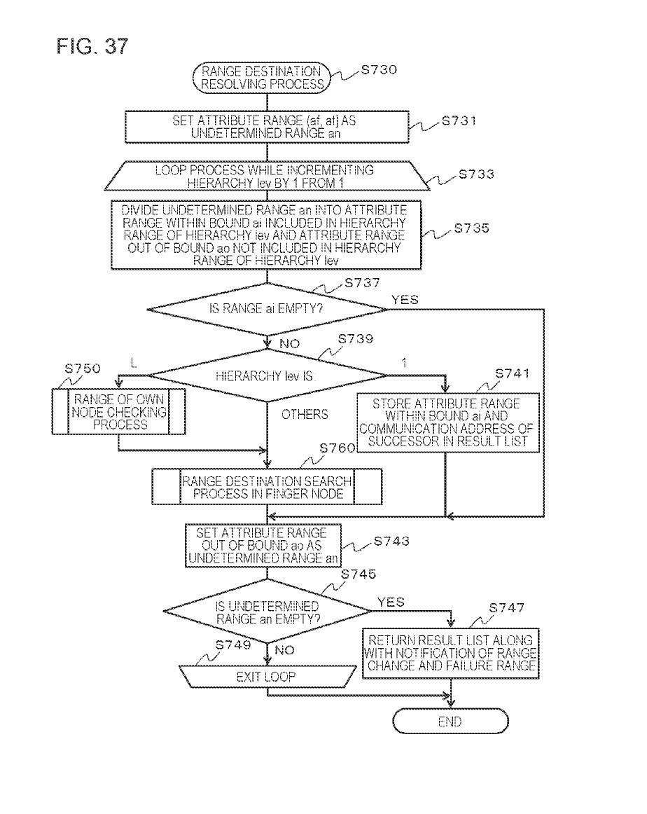

Next, a description will be made of a range destination resolving process in the information system 1 of the present exemplary embodiment. FIGS. 37 to 40 are flowcharts illustrating an example of procedures of a range destination resolving process S730 in the information system 1 of the present exemplary embodiment.

The present range destination resolving process S730 is performed by the range destination resolving unit 344 (FIG. 7) of the destination resolving unit 340 of the data operation client 104 (FIG. 4). Hereinafter, a description thereof will be made with reference to FIGS. 4, 7, and 37 to 40.

The present range destination resolving process S730 may be performed from the data adding or deleting unit 362 (FIG. 7) or the data retrieval unit 364 (FIG. 7) of the own node m (the data operation client 104) and may be performed from the range destination resolving unit 344 of another node (the data operation client 104) through the relay unit 380 (the operation request relay server 108 of FIG. 4).

In these procedures, a range endpoint of a certain hierarchy of which a notification may be sent, but when the data retrieval unit 364 performs a process of acquiring a plurality of communication addresses corresponding to the attribute range (af, at] from the data retrieval unit 364 in a certain node m, this information is not given because of the same node.

Here, a description will be made of a case where the range destination resolving process S730 is called by the data retrieval unit 364 (FIG. 7) of the own node m.

In this case, the data retrieval unit 364 notifies the range destination resolving unit 344 of a range endpoint ac of the call source and a range endpoint ae of a call destination recognized by the call source, along with a destination resolving request for acquiring a communication address corresponding to an attribute range (af, at).

First, the range destination resolving unit 344 of a certain node m (the data operation client 104) sets an undetermined set an as an attribute range (af, at] (step S731). The hierarchy lev is incremented by 1, and a loop process between step S733 and step S749 is performed on each hierarchy lev. If the process for each of all the hierarchies lev is completed, the present loop process is performed, and the present process also finishes. In the present process, the process is repeatedly performed for each hierarchy, and thus the attribute range (af, at] is divided into ranges of the respective hierarchies.

The range destination resolving unit 344 divides, in the hierarchy lev, the determined range set an (attribute range (af, at]) into an attribute range within bound ai which is included in the hierarchy range of the hierarchy lev and an attribute range out of bound ao which is not included therein (step S735).

If the attribute range within bound ai is empty (YES in step S737), the flow proceeds to step S743. If the attribute range within bound ai is not empty (NO in step S737), and the hierarchy lev is 1 (1 in step S739), the range destination resolving unit 344 stores the attribute range within bound ai and the successor node in a result list (step S741). In addition, the range destination resolving unit 344 sets the attribute range out of bound ao as an undetermined range set an (step S743). If the undetermined range set an is an empty set (YES in step S745), the result list is returned to the call source (step S747), and the range destination resolving process finishes. If the undetermined range set an is not an empty set (NO in step S745), the range destination resolving unit 344 increments the hierarchy lev by 1, and performs the loop process of the next hierarchy on the undetermined range set an.

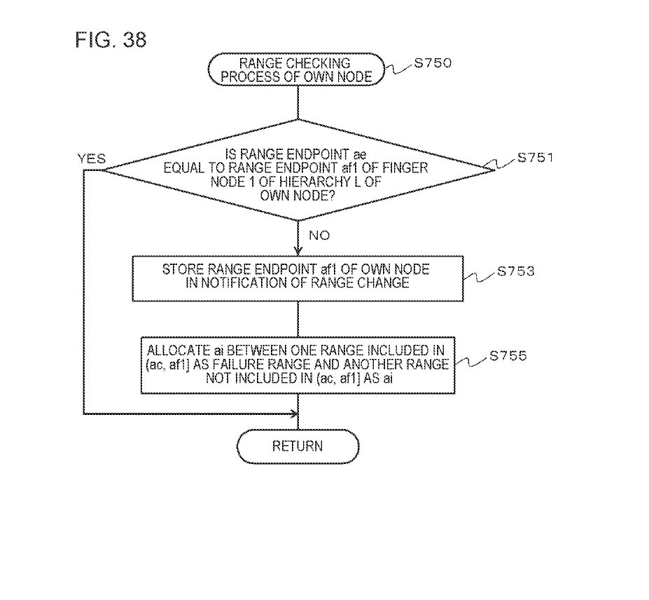

If the hierarchy lev is a hierarchy L in the determination in step S739, the flow proceeds to a range checking process S750 of the own node of FIG. 38. In the range checking process S750 of the own node of FIG. 38, first, the range destination resolving unit 344 determines whether or not the range endpoint ae is the same as the range endpoint af1 of the first finger node 1 of the hierarchy L of the own node m (step S751). If the range endpoint ae is not the same as the range endpoint af1 (NO in step S751), the range destination resolving unit 344 stores the range endpoint af1 of the own node m in a notification of range change (step S753). Subsequently, the range destination resolving unit 344 divides the attribute range within bound ai into a range included in (ac, af1] and a range which is not included therein. In addition, the range destination resolving unit 344 sets the range included in (ac, af1] as a failure range, and sets the range not included in (ac, af1] as ai (step S755). If the range endpoint ae is the same as the range endpoint af1 (YES in step S751), or after step S755, the present process S750 finishes, and the flow returns to the flow of FIG. 37 and proceeds to step S760.

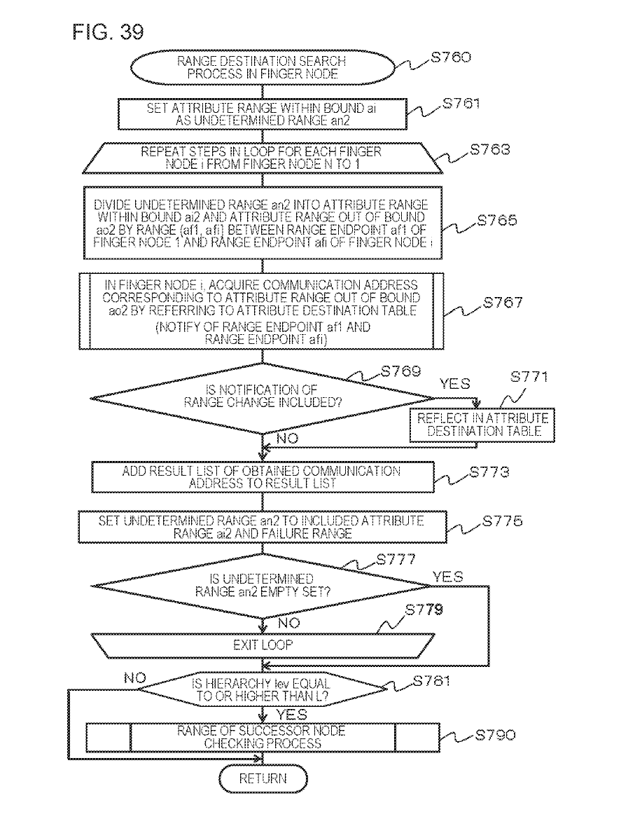

Referring to FIG. 37 again, if the hierarchy lev is neither 1 nor L in the determination in step S739 (others in step S739), a range destination search process S760 is performed in a finger node illustrated in FIG. 39. In addition, the process S760 is also performed after the above-described range checking process S750 of the own node.

As illustrated in FIG. 39, in the range destination search process S760 in the finger node, first, the range destination resolving unit 344 sets the attribute range within bound ai as an undetermined range set an2 (step S761). In addition, the range destination resolving unit 344 changes the finger node i from the finger node N to the finger node 1 and repeatedly performs a loop process between step S763 and step S779 on each finger node. If the process for each of all the finger nodes is completed, this loop process exits.

In the loop process, first, the range destination resolving unit 344 divides the undetermined range set an2 into a range which is included in a range (af1, afi] of the range endpoint af1 of the finger node 1 and the range endpoint afi of the finger node i, and a range which is not included therein. In addition, the range destination resolving unit 344 sets the range within bound as ai2, and sets the range out of bound as ao2 (step S765).

Subsequently, the range destination resolving unit 344 inquires the finger node i about notification addresses corresponding to the attribute range out of bound ao2 (step S767). At this time, the range destination resolving unit 344 notifies the finger node of the range endpoint af1 and the range endpoint afi recognized by the own node m. The finger node i refers to the attribute destination table 464 and returns a result list of notification addresses corresponding to the attribute range out of bound ao2.

If a notification of range change is included in the result obtained from the finger node i (YES in step S769), the range destination resolving unit 344 reflects the information on the notification of range change in the attribute destination table 464 (step S771). If the notification of range change is not included therein (NO in step S769), the flow proceeds to step S773.

In addition, the range destination resolving unit 344 adds the result list of communication addresses obtained from the finger node to the result list in this procedure (step S773), and sets a sum of sets of the attribute range within bound ai2 and the failure range as an undetermined range set an2 (step S775).

If there is no undetermined range an2 (empty set) (YES in step S777), the loop process on the finger node exits, and the flow proceeds to step S781. If there is the undetermined range an2 (NO in step S777), the loop process is performed on the next finger node.

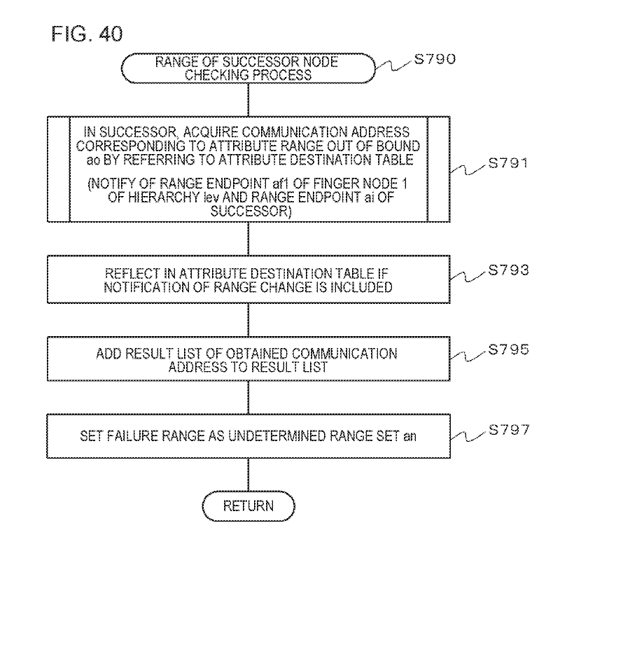

If the undetermined range an2 is an empty set (YES in step S777), the range destination resolving unit 344 determines whether or not the hierarchy lev is L or higher (step S781). If the hierarchy lev is L or higher (YES in step S781), the range destination resolving unit 344 performs a range checking process S790 of the successor node of FIG. 40.

In the range checking process S790 of the successor node illustrated in FIG. 40, first, the range destination resolving unit 344 inquires the successor node about communication addresses corresponding to the attribute range out of bound ao and acquires the communication addresses (step S791). At this time, the range destination resolving unit 344 notifies the successor node of the range endpoint af1 of the first finger node 1 and the range endpoint ai of the successor node in the same hierarchy lev, recognized by the own node.

In addition, if the notification of range change is included in the result obtained from the successor node, the range destination resolving unit 344 reflects the information on the notification of range change in the attribute destination table 464 for update (step S793). Further, the range destination resolving unit 344 records the result list obtained from the successor node to the result list in this procedure (step S795). Furthermore, the range destination resolving unit 344 sets the failure range as an undetermined range set an (step S797), and the flow returns to the flow of FIG. 39.

In FIG. 39, if the hierarchy lev is not L or higher (NO in step S781), or after step S790, the flow returns from the process S760 to the flow of FIG. 37 and proceeds to the above step S743.

Due to the above-described process, the information system 1 of the present exemplary embodiment can specify a node corresponding to a destination of an access request from an attribute value of the access-requested data.

As described above, according to the information system 1 of the present exemplary embodiment, a transmission and reception relation is constructed on the basis of the Koorde algorithm, and thus the following effects are achieved.

In addition, the number of nodes (order) stored in a destination table of each node can be made variable. Further, in the same order, the number of hops relayed by the relay unit tends to be reduced. As above, according to the information system 1 of the present exemplary embodiment, since the number of nodes in the attribute destination table which is required to be updated in each node may be small, it is possible to increase a frequency of confirming an autonomous range change or the number of nodes of which a notification is sent from the smoothing control unit.

### Fourth Exemplary Embodiment

An information system according to the exemplary embodiment of the present invention is different from the information system of the above-described exemplary embodiment in that a notification condition can be set in a multi-dimensional attribute through range retrieval or range designation.

Among a range endpoint, an attribute value, and an attribute range, which are treated in the attribute destination table 414, the single destination resolving unit 342, the range destination resolving unit 344, and the range update unit 406 of the above-described exemplary embodiment, the range endpoint stored in the attribute destination table 414, the attribute value input to the single destination resolving unit 342, or the range endpoint which is a comparison target is treated as a value obtained by converting a multi-dimensional attribute value into a one-dimensional attribute value through a space-filling curve process. An attribute range input to the range destination resolving unit 344 is treated as an original multi-dimensional attribute range, and division of an attribute range which is a data access target or a comparison operation is different from division of a one-dimensional attribute range or a comparison operation of the first to third exemplary embodiments.

In the present exemplary embodiment, unlike in the above-described exemplary embodiment, a notification condition is not set through range retrieval or range designation on a one-dimensional attribute, but a notification condition can be set through range retrieval or range designation on a multi-dimensional attribute. Accordingly, in the present exemplary embodiment, range retrieval is not performed on a one-dimensional attribute multiple times, but range retrieval is performed once on a multi-dimensional attribute, and thus it is possible to reduce an amount of data or a data quantity to be processed.

For example, in relation to data (single index) which is indexed by latitude and longitude separately, a data set obtained through range retrieval regarding latitude and a data set obtained through range retrieval regarding longitude are taken as a product set. In addition, in relation to data (composite index) which is indexed by latitude and longitude together, a data set is obtained through range retrieval regarding latitude and longitude, and is the same as the product set as a result. However, an amount of data or a data quantity to be processed is smaller in the former case than in the latter case.

The information system 1 of the present exemplary embodiment may further include a preprocessing unit 320 which calculates a value obtained by converting a multi-dimensional attribute value into a one-dimensional attribute value through a space-filling curve process as a range, and generates an attribute destination table 474, which will be described later, in addition to the configuration of the above-described exemplary embodiment of FIG. 4.

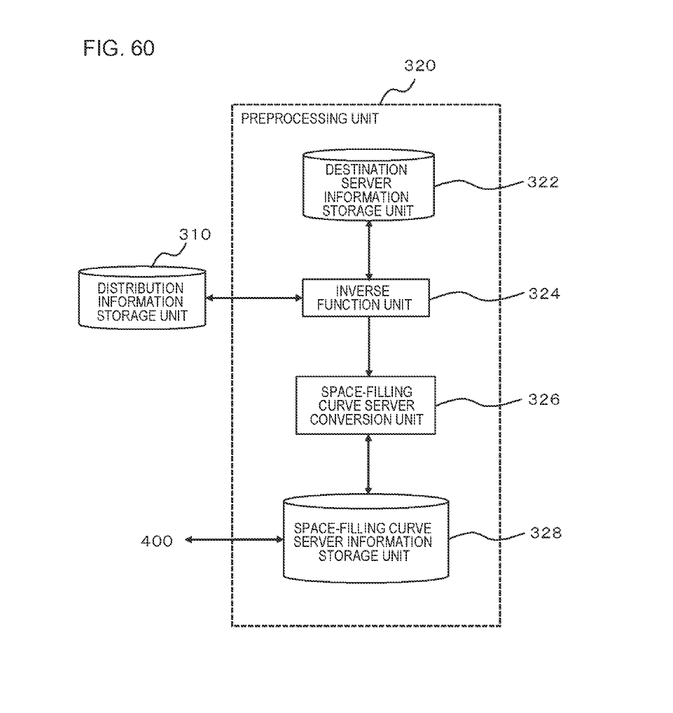

FIG. 60 is a functional block diagram illustrating a configuration of the preprocessing unit 320 of the information system 1 of the present exemplary embodiment.

In the information system 1 of the present exemplary embodiment, the preprocessing unit 320 includes a destination server information storage unit 322, an inverse function unit 324, a space-filling curve server conversion unit 326, and a space-filling curve server information storage unit 328, and may have a function of creating a space-filling curve server information.

Here, in the present exemplary embodiment, the preprocessing unit 320 is provided, and thus it is possible to distribute a load statically through an inverse function process based on a histogram when the system is initialized, and then to distribute a load dynamically through a range change of the present invention during use of the system online.

The destination server information storage unit 322 stores a plurality of correspondences between a set of logical identifiers and destination addresses of nodes, for determining a data storage destination or a message transfer destination, described above. For example, in a case of consistent hashing or a distributed hash table, a hash value, an IP address of a destination node, and the like are stored in the destination server information storage unit. The destination server information storage unit 322 is provided in each node.

The space-filling curve server information storage unit 328 stores a plurality of destination addresses of other computers, for partial spaces of a multi-dimensional attribute space. In relation to a method of expressing the partial spaces of the multi-dimensional attribute space, for example, the partial spaces may be expressed by enumerating one-dimensional values of a starting point of the multi-dimensional attribute space, may be expressed by enumerating a sum of sets of attribute ranges corresponding to the number of dimensions, and may be expressed by enumerating a sum of sets of conditions such as a value of an nth bit in any dimension.

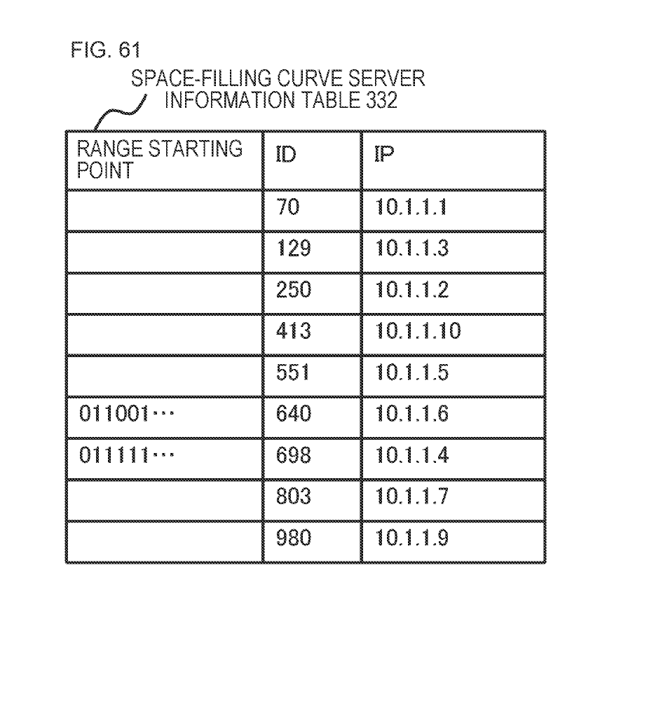

In the present exemplary embodiment, the space-filling curve server information storage unit 328 stores a space-filling curve server information table 332 as illustrated in FIG. 61. The space-filling curve server information table 332 correlates a value which expresses a starting point of a range (attribute space) of a logical identifier (ID) corresponding to a destination address (IP) in a one-dimensional manner, with the destination address. In addition, in FIG. 61, the logical identifier (ID) is included in the space-filling curve server information table 332, but may not be included therein.

In the present exemplary embodiment, the space-filling curve server information storage unit 328 stores a space-filling curve server information table 332 as illustrated in FIG. 61. The space-filling curve server information table 332 correlates a value of a starting point of a one-dimensional attribute range obtained by converting a multi-dimensional attribute space into a one-dimensional value, with a destination address (IP) and further with a logical identifier (ID). In addition, in FIG. 61, the logical identifier (ID) is included in the space-filling curve server information table 332, but may not be included therein. Further, in a case where a correspondence table of the logical identifier (ID) and the destination address (IP) is provided separately, the space-filling curve server information table 332 may include either of the logical identifier (ID) and the destination address (IP).

The inverse function unit 324 obtains a distribution function indicating distribution information of data of a data constellation, and applies an inverse function of the distribution function by using the logical identifier of each of the nodes as an input so as to output a one-dimensional value.

The inverse function unit 324 uses cumulative distribution information stored in the distribution information storage unit 310, and outputs a one-dimensional value for an input value so that the one-dimensional value corresponds to a value obtained by applying an inverse function v=ICDF(r) of a cumulative distribution function r=CDF(v) which represents the cumulative distribution information as a function. In a case of using a cumulative histogram, a cumulative distribution ratio of the segment i is denoted by r[i], and a one-dimensional value is denoted by v[i].

For example, if a given input value is r from a table which is sorted in an ascending order in advance, in a case where there is a segment i where r[i]=r, v[i] is output. Otherwise, a segment i where r[i−1]<r<r[i] is found out, and then a corresponding one-dimensional value is calculated using the following Expression (1).

[Math. 2]

v=(r−r[i−1])(v[i]−v[i−1])/(r[i]−r[i−1])+v[i−1] Expression (2)

The space-filling curve server conversion unit 326 converts the one-dimensional value for each destination server, calculated by the inverse function unit 324, into a multi-dimensional value through a space-filling curve conversion process by using the one-dimensional value as an input. In addition, the space-filling curve server conversion unit 326 converts the one-dimensional value for each server to have a predetermined form of the space-filling curve server information in accordance with the above-described form of the space-filling curve server information table 332 stored in the space-filling curve server information storage unit 328, so as to create the space-filling curve server information table 332 which is stored in the space-filling curve server information storage unit 328. Further, the conversion of a format may not be performed, and information including a pair of an address of each server and a one-dimensional value obtained by the inverse function unit 324 may be used as is.

In the present exemplary embodiment, the range update unit 406 generates an attribute destination table on the basis of the space-filling curve server information table 332 generated in this way, for storage in the attribute destination table storage unit 404. Here, there is a configuration in which the space-filling curve server information table 332 is first generated, and then the attribute destination table is generated, but the present exemplary embodiment is not limited thereto. An attribute destination table may be generated on the basis of a correspondence relation between the one-dimensional value generated by the space-filling curve server conversion unit 326 and the logical identifier ID, so as to be stored in the attribute destination table storage unit 404.

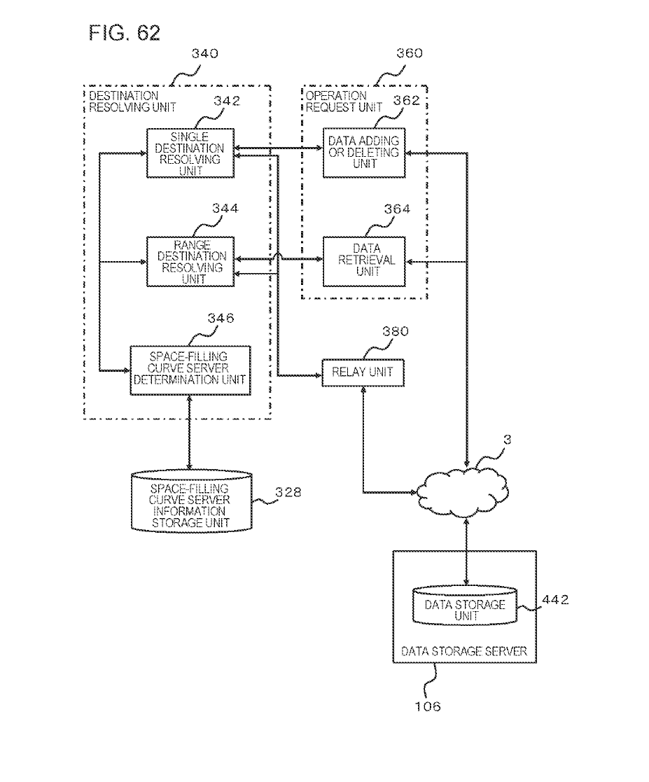

FIG. 62 is a functional block diagram illustrating a main part configuration of the information system 1 of the present exemplary embodiment.

As illustrated in FIG. 62, the destination resolving unit 340 further includes a space-filling curve server determination unit 346 in addition to the configuration of the above-described exemplary embodiment of FIG. 7.

The space-filling curve server determination unit 346 acquires the space-filling curve server information stored in the space-filling curve server information storage unit 328, and, while referring to the space-filling curve server information, returns one or a plurality of destinations of computers corresponding to the multi-dimensional attribute value or the multi-dimensional attribute range of which the single destination resolving unit 342 or the range destination resolving unit 344 has notified, to the single destination resolving unit 342 or the range destination resolving unit 344.

An operation of the information system 1 of the present exemplary embodiment configured in this way will now be described.

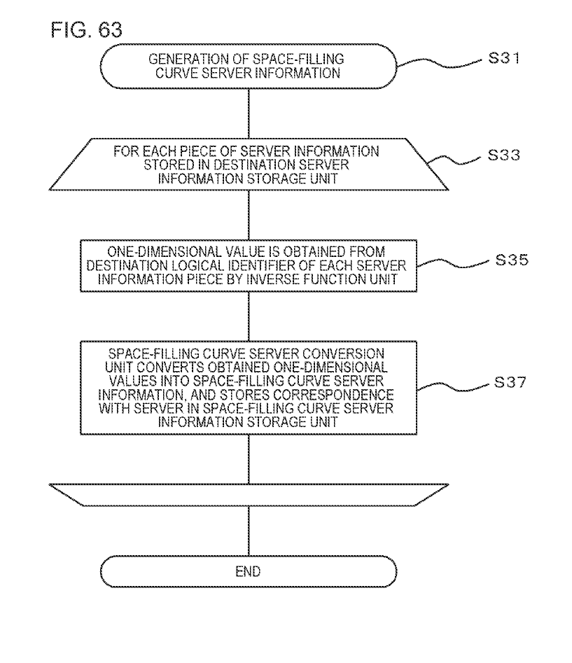

Here, an operation of the preprocessing unit 320 of the information system 1 of the present exemplary embodiment will be described. FIG. 63 is a flowchart illustrating an example of a process (step S31) of generating space-filling curve server information in the preprocessing unit 320 of the information system 1 of the present exemplary embodiment. Hereinafter, a description thereof will be made with reference to FIGS. 60 and 63.

First, the preprocessing unit 320 (FIG. 60) repeatedly performs the following steps S35 and S37 on each piece of the destination server information stored in the destination server information storage unit 322 (FIG. 60) (step S33). The inverse function unit 324 (FIG. 60) normalizes logical identifiers of destinations, and applies an inverse function to the normalized logical identifiers so as to obtain one-dimensional values (step S35). Alternatively, the space-filling curve server conversion unit 326 (FIG. 60) converts the one-dimensional values obtained in step S35 into multi-dimensional attribute values, and stores space-filling curve server information obtained by performing this process for each of all pieces of server information, in the space-filling curve server information storage unit 328 (FIG. 60) (step S37).

The present exemplary embodiment is the same as the above-described exemplary embodiment except that a value obtained by converting a multi-dimensional attribute value into a one-dimensional attribute value through the space-filling curve process is used as a range endpoint, and, hereinafter, detailed description will not be repeated.

As described above, according to the information system 1 of the exemplary embodiment of the present invention, it is possible to set a notification condition through range retrieval or range designation on a multi-dimensional attribute. Accordingly, in the present exemplary embodiment, range retrieval is not performed on a one-dimensional attribute multiple times, but range retrieval is performed once on a multi-dimensional attribute, and thus it is possible to reduce an amount of data or a data quantity to be processed.

As described above, according to the present exemplary embodiment, even in a system in which a distribution of data which is stored or of which a notification is sent varies, it is possible to perform a process based on efficient ordering of attributes.

As above, although the exemplary embodiments of the present invention have been described with reference to the drawings, various other configurations may be employed.

### EXAMPLES

### Example 1

Example 1 of the first exemplary embodiment will now be described.

In this example, in the information system 1, the destination resolving process is performed using the full mesh algorithm.

As illustrated in FIG. 2, a description will be made of an example of operating data stored in a plurality of data computers 208 from the access computer 202. It is assumed that the access computer 202 includes the data operation client 104 of FIG. 1, and the data computer 208 includes the data storage server 106 of FIG. 1.

In this example, it is assumed that the computers illustrated in the ID destination table 412 of FIG. 11 are present as the data computers 208, and the access computer 202 preliminarily constructs the ID destination table 412 of FIG. 11 so that a relational database management system (RDBMS) accesses the data computer 208.

It is assumed that the RDBMS of the access computer 202 is given information on data stored in the data computer 208, from a database manager in a language (a data definition language (DDL) in a SQL language) which declares a schema. For example, a member table which has an age attribute and is declared as an 8-bit integer value without a sign, and the declaration is made so that the age attribute is indexed, and a member ID which is a primary key of the table can be acquired from the age attribute.

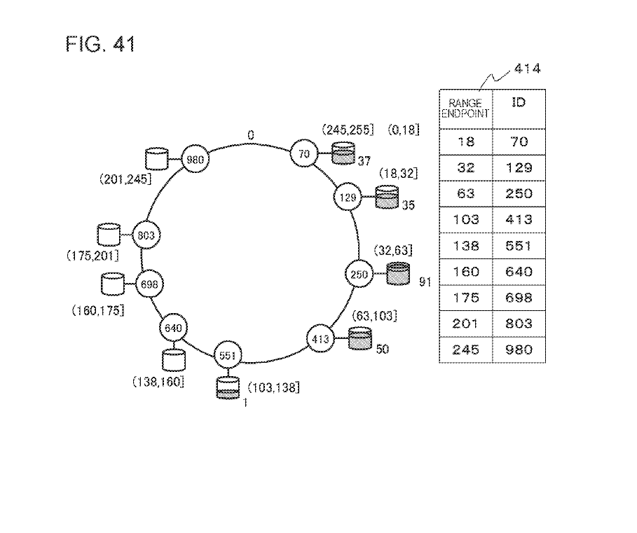

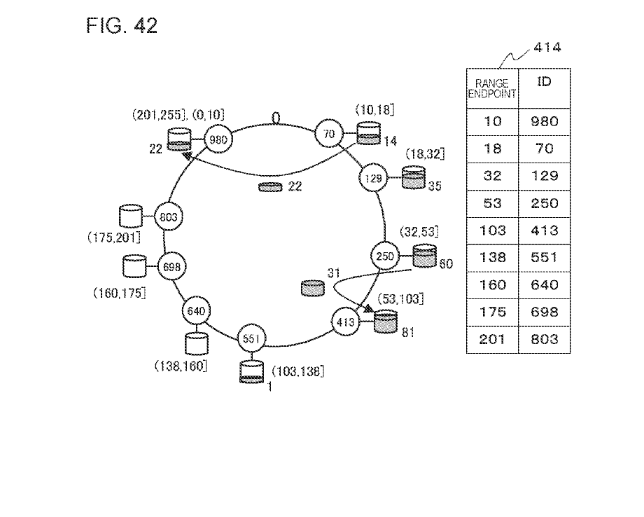

The RDBMS stores the age attribute index in the data computer 208 by a predetermined trigger before data access is performed. For this reason, as illustrated in FIG. 41, the attribute destination table 414 is constructed by setting a range endpoint, and by dividing a 8-bit integer space into a plurality of spaces so as to be proportional to a logical identifier ID interval of each node which is obtained from an ID destination table. If two million one hundred forty thousand Japanese data are stored in the member table of the RDBMS, as illustrated in FIG. 42, a bias occurs in a data amount or a data quantity stored in each node. For example, initially (FIG. 41), three hundred seventy thousand data are stored in a node which has a logical identifier ID of 70 and manages ranges (245, 255] and (0, 18], three hundred fifty thousand data are stored in a node which manages a range (0, 18] and has a logical identifier ID of 129, and nine hundred ten thousand data are stored in a node which manages a range (32, 63] and has a logical identifier ID of 250. On the other hand, data is not registered in four nodes such as a node which manages a range (201, 245] and has a logical identifier ID of 980.

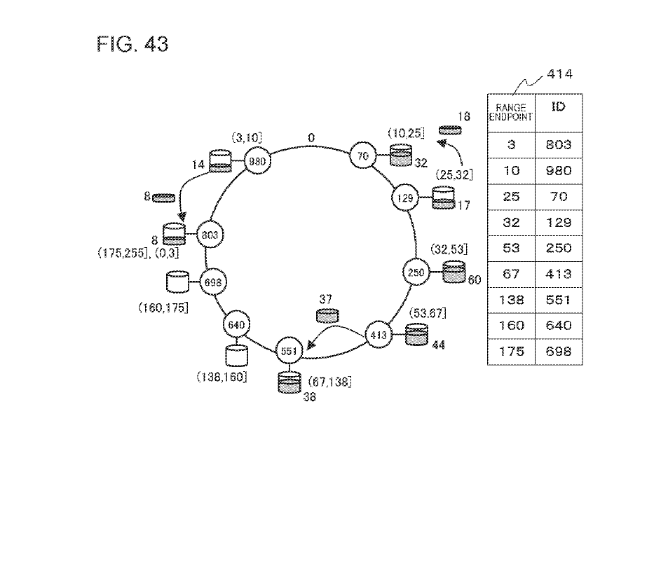

The smoothing control unit 422 (FIG. 8) is operated so that a successor node corresponding to an adjacent logical identifier ID and a data storage amount are proportional to the ID interval, and thus the unbalance of a data amount or a data quantity illustrated in FIG. 42 is corrected by a data movement illustrated in FIG. 43 and a data amount or a data quantity after being moved. For example, in the node corresponding to the logical identifier ID of 980, in the operation of the smoothing control unit 422 illustrated in FIG. 15, the node which has the logical identifier ID of 70 and is a successor thereof is inquired about a data amount or a data quantity, and three hundred seventy thousand data are obtained therefrom. In the operation of the smoothing control unit 422 of the node illustrated in FIG. 16, when a data amount or a data quantity to be moved from the own node to the successor node is calculated on the basis of the above Expression (1) (step S201), this leads to (0*(70−980)−37*(980−803))/(70−803)=−22.

Therefore, a load distribution plan is calculated as Import (step S211), and the successor node has the logical identifier ID of 70 and thus receives two hundred twenty thousand data. Among the data stored in the node corresponding to the logical identifier ID of 70, data to be moved is two hundred twenty thousandth data from the smaller value in this case, and an attribute value of the boundary is treated as a new range endpoint.

In this case, even when all the access computers 202 is preliminarily registered in the notification destination table 430 (FIG. 14) of the data computer 208 having the logical identifier ID of 980, there is no guarantee that the access computer 202 holds the same attribute destination table 414 as the attribute destination table 414 of FIG. 43. The access computer 202, in which a data access process occurs before a notification of range change is reflected, refers to the old attribute destination table 414 (FIG. 41) in order to access data on the attribute value of 0 according to the operation of FIG. 20, and thus accesses the node corresponding to the logical identifier ID of 70.

However, due to the operation illustrated in FIG. 17 in the data access unit having the logical identifier ID of 70, an updated range endpoint and information on a node to be accessed next are obtained. In other words, the node corresponding to the logical identifier ID of 70 compares the received attribute value of 0 with a new range (10, 18], and since the attribute value is smaller in this comparison, a range endpoint of 10 is returned as a notification of range change and a communication address is returned as a redirect destination, to a predecessor node corresponding to the logical identifier ID of 980.

For example, in FIG. 21, if a notification of range change is received (YES in step S417), the notification is reflected in the attribute destination table 414 (step S419). Even if data access fails (YES in step S421), the node 980 which is a redirect destination can be accessed (step S423), and thus the access computer 202 can perform a data access process on the attribute value of 0 even in circumstances in which the range is updated after the load smoothing operation is performed.

In addition, another access computer 202 which has not received the notification of range change from the data computer 208 having the logical identifier ID of 980 can also obtain the attribute destination table 414 illustrated in FIG. 43 from the attribute destination table 414 illustrated in FIG. 42 due to the operation of FIG. 20. In other words, this node acquires a node from the attribute destination table 414 at random at constant intervals, and transmits a range endpoint of 245 to the node corresponding to the logical identifier ID of 980 if the node is extracted at a certain time. In the node corresponding to the logical identifier ID of 980, the range endpoint of the own node is 10 and is thus different therefrom, and thus the range endpoint of 10 is returned. Therefore, the attribute destination table 414 of FIG. 42 is updated.

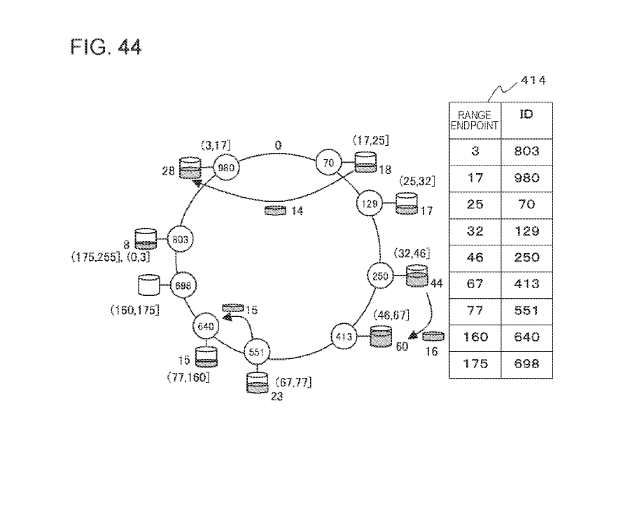

As above, with the operation of the smoothing control unit 422, sharing circumstances of the range of each node illustrated in FIG. 41 vary as illustrated in FIGS. 42 to 44, and a data amount or a data quantity of each node is uniformized. At that time, the attribute destination table 414 held by each access computer 202 is also updated during data access, by autonomous update checking, a notification from the smoothing control unit, and the like.

### Example 2

Example 2 of the second exemplary embodiment will now be described.

In this example, in the information system 1, the destination resolving process is performed using the Chord algorithm.

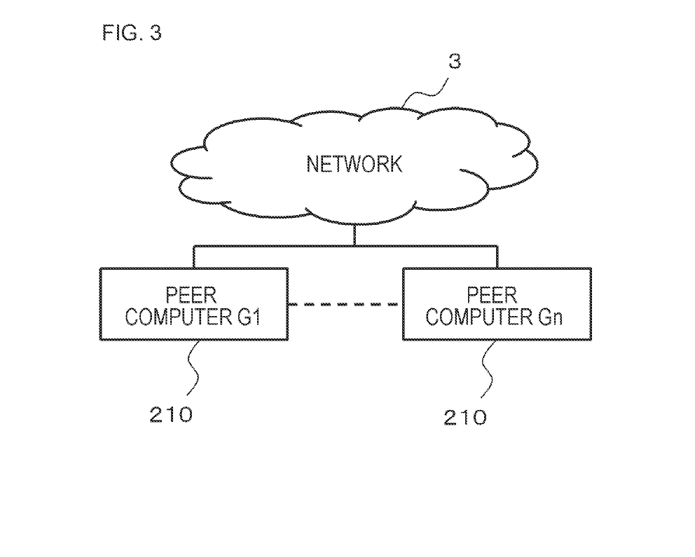

In this example, as illustrated in FIG. 3, a description will be made of an example in which the plurality of peer computers 210 mutually operate data stored in the peer computers 210. It is assumed that the peer computer 210 includes the data operation client 104, the operation request relay server 108, and the data storage server 106.

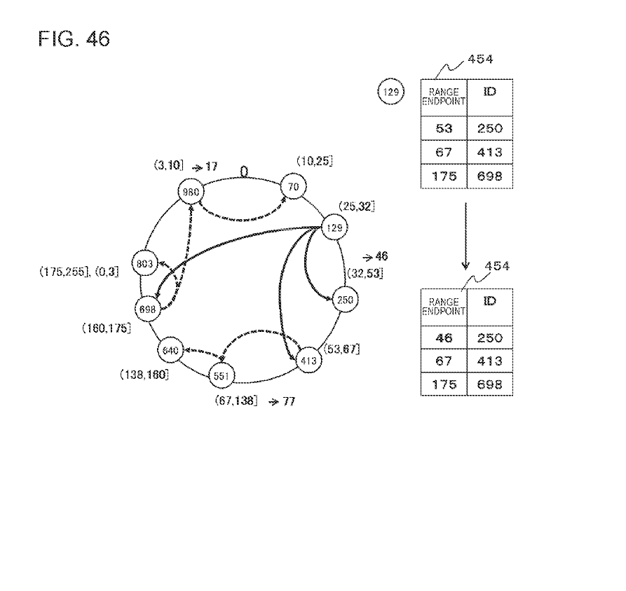

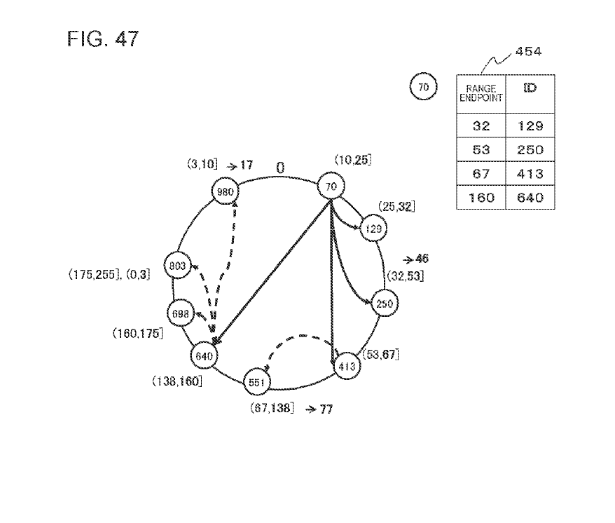

Data stored in the information system 1 is data illustrated in FIGS. 45 to 47. It is assumed that a data movement is performed with an adjacent node on the logical identifier ID space by the smoothing control unit 422, and, particularly, a range managed by each node is currently changed from a state of FIG. 45 to a state of FIG. 47 due to a data movement illustrated in FIG. 46.

FIGS. 45 to 47 also illustrate the attribute destination table stored in the attribute destination table storage unit 404 of the present exemplary embodiment. Each attribute destination table includes a successor node in the first row, and a finger node in and after the second row. For example, FIG. 45 illustrates the attribute destination table of the node corresponding to the logical identifier ID of 980.

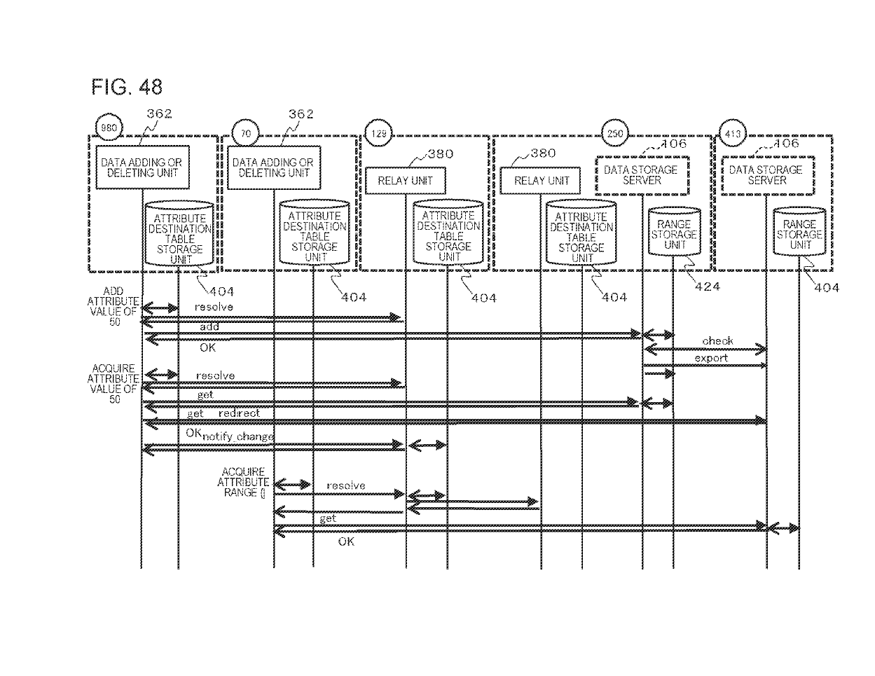

Here, referring to a sequence diagram of FIG. 48, a description will be made of a procedure in which the node corresponding to the logical identifier ID of 980 registers and acquires data on an attribute value of 50 and another node corresponding to the logical identifier ID of 70 retrieves a range including the data, and of an update of a range endpoint stored in the attribute storage unit.

When an operation is described before data is moved by the smoothing control unit 422 (FIG. 8), the node corresponding to the logical identifier ID of 980 calls the single destination resolving unit 342 (FIG. 7) in order to register data on an attribute value of 50. First, the single destination resolving unit 342 refers to the successor node of the attribute destination table, and determines whether or not the attribute value of 50 is included in (10, 25] between the range endpoint of 10 of the own node and the range endpoint of 25 of the node which has the logical identifier ID of 70 and is a successor.

As illustrated in FIG. 45, the attribute value is not included here. Therefore, the single destination resolving unit 342 refers to the finger table of the attribute destination table and determines whether or not a range endpoint of 138 of the node which has the logical identifier ID of 551 and is the most distant is included in (10, 50) between own node of 10 and the attribute value of 50. Since the range endpoint is not also included here, the single destination resolving unit 342 determines whether or not a range endpoint of 53 of the node which has the logical identifier ID of 250 and is the next finger is included in (10, 50).

Since the range endpoint is not also included here, the single destination resolving unit 342 performs comparison with a range endpoint of 32 of the node which has the logical identifier ID of 129 and is the next finger. Since the range endpoint is included here, the single destination resolving unit 342 acquires a destination for the attribute value of 50 from the node which is a finger thereof and has the logical identifier ID of 129. The node corresponding to the logical identifier ID of 129 manages the attribute destination table of FIG. 46, and determines whether or not the attribute value of 50 is included in (32, 53] between the range endpoint of 32 of the own node and the range endpoint of 53 of the successor node corresponding to the logical identifier ID of 250. Since the attribute value of 50 is included here, information including the communication address of the successor node (250) is returned to the node which is a call source and has the logical identifier ID of 980. The node corresponding to the logical identifier ID of 980 receives the successor node (250), and registers data on the attribute value of 50 in the successor node (250).

After the node corresponding to the logical identifier ID of 980 performs the registration, the data movement illustrated in FIG. 46 is performed (the data corresponding to the attribute value of 50 is moved from the node corresponding to the logical identifier ID of 250 to the node of having the logical identifier ID of 413). In addition, it is assumed that the node corresponding to the logical identifier ID of 980 acquires the data on the attribute value of 50 again thereafter. However, it is assumed that the acquisition is not reflected in the attribute destination table of the own node (980).

In this case, in the same procedure, the logical identifier ID of 250 is acquired as a communication address. If access to the node is performed with the attribute value of 50, 46 is obtained as a new range endpoint of the node corresponding to the logical identifier ID of 250 through a notification of range change, and the node corresponding to the logical identifier ID of 413 is returned as a redirect destination. In this way, the node corresponding to the logical identifier ID of 980 can perform data access process on the destination to which the data has been moved.

In addition, it is assumed that, in order to retrieve an attribute range (45, 55], the node corresponding to the logical identifier ID of 70 inquires the attribute range destination resolving unit about a plurality of communication destination addresses which store data in the range. First, the attribute range (45, 55] is divided into a range included in a range (25, 32] of the range endpoint of 25 of the own node and the range endpoint of 32 of the successor node, and a range which is not included therein, but, here, may be divided into ranges both of which are not included therein. Next, by using the finger table, the attribute range (45, 55] is divided into a range included in the range (25, 160] of the range endpoint of 160 of the node corresponding to the logical identifier ID of 640 which is the most distant finger node and the range endpoint of the own node, and a range which is not included therein.

Since both of the ranges are included here, in relation to the next node corresponding to the logical identifier ID of 413, the attribute range is divided into a range included in (25, 67] and a range not included in (25, 67]. Since both of the ranges are also included here, in relation to the next node corresponding to the logical identifier ID of 250, the attribute range is divided into a range included in (25, 53] and a range not included in (25, 53], and is thus divided into a range within bound (45, 53] and a range out of bound (53, 55]. Here, in relation to the attribute range (53, 55], a data access request is transferred to a finger node corresponding to the logical identifier ID of 250 through the relay unit.

When an inquiry about a destination corresponding to the attribute range (53, 55] is processed in the node corresponding to the next logical identifier ID of 250, the range endpoint of 25 of the call source having the logical identifier ID of 70 and the range endpoint of 53 of the call destination recognized by the call source are given. At this time, the range endpoint of the logical identifier ID of 250 is changed to 46, and is thus stored in a notification of range change. Subsequently, the attribute range is divided into a range included in a range (25, 46] of the range endpoint of 25 of the call source and the range endpoint of 46 of the call destination and a range not included therein. Since neither of the ranges are included here, there is no failure range, and the process on this range (53, 55] is continuously performed. The received attribute range (53, 55] is included in (46, 67] between own node and the successor node, and thus the logical identifier ID of 413 which is a successor thereof is returned to the node corresponding to the logical identifier ID of 70.

Next, when a description is made with reference to FIG. 47, in the node corresponding to the logical identifier ID of 70 which has called the logical identifier ID of 250, the range (45, 53] included between the node and the finger is divided into a range included in an attribute range (25, 32] with the node corresponding to the logical identifier ID of 129 and a range not included therein. Since neither of the ranges are included here, and thus the node corresponding to the logical identifier ID of 129 is inquired about the attribute range (45, 53]. At this time, a notification of a range endpoint is sent, but the range endpoints of the call source and destination do not vary, and thus a notification of range change is not sent.

In the node corresponding to the logical identifier ID of 129, the attribute range is divided at (32, 46] between own node and the successor node, and, in relation to an attribute range (45, 46], the node corresponding to the logical identifier ID of 250 which is a successor is returned. The remaining range (46, 53] is divided into ranges by using the finger table. However, both of the ranges are relayed to the finger node corresponding to the logical identifier ID of 250, and, in the node corresponding to the logical identifier ID of 250, both of the ranges are included in a range (46, 67] between own node and the successor node (413). For this reason, in this range (46, 53], the node corresponding to the logical identifier ID of 413 which is a successor is returned.

As a result, the node corresponding to the logical identifier ID of 70 which has performed range retrieval accesses the node corresponding to the logical identifier ID of 413 in relation to the attribute range (46, 53] and the attribute range (53, 55], and accesses the node corresponding to the logical identifier ID of 250 in relation to the attribute range (45, 46]. Each access result is included in the range of each node, and thus a retrieval process is performed. In addition, a result thereof is returned to the node corresponding to the logical identifier ID of 70.

### Example 3

Example 3 of the third exemplary embodiment will now be described.

In this example, in the information system 1, the destination resolving process is performed using the Koorde algorithm.

In this example, the peer computers 210 of FIG. 3 are configured in the same manner as in the above the example 2, and it is assumed that data stored in the information system 1 is currently changed to a state of FIG. 33 due to a data movement illustrated in FIG. 33.

In order to describe an example of an operation of the range update unit, an attribute destination table of each node and a constructing procedure thereof will be described using a specific example of the attribute destination table.

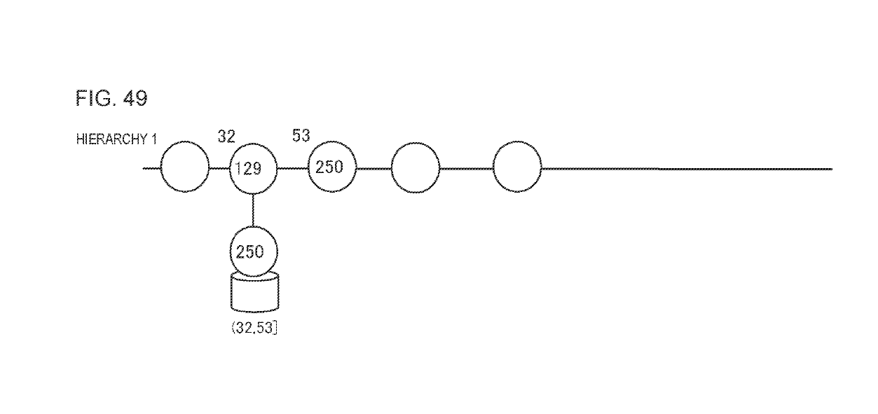

FIG. 30 illustrates attribute destination tables 464 constructed in each of nodes whose logical identifier IDs are 129, 640, 551, 250, and 413. As illustrated in FIG. 49, the node corresponding to the logical identifier ID of 129 acquires a range endpoint of the own node and a range endpoint of 53 of the node corresponding to the logical identifier ID of 250 which is a successor in the hierarchy 1, and sets the range endpoints as a hierarchy range in the hierarchy 1. Subsequently, in the hierarchy 2, a finger node of the node, which is obtained by referring to the ID destination table which is constructed in advance, is inquired about a range endpoint of the node.

If the successor is inquired about a range endpoint in the hierarchy 2, the successor node corresponding to the logical identifier ID of 250 inquires the node corresponding to the logical identifier ID of 413 which is a finger node thereof about a range endpoint in the hierarchy 1, and the node corresponding to the logical identifier ID of 413 returns 67. The node corresponding to the logical identifier ID of 250 holds this value 67 as a range endpoint for the logical identifier ID of 413 in the hierarchy 1, and returns the value to the node corresponding to the logical identifier ID of 129 which is a call source. The node corresponding to the logical identifier ID of 129 holds this value as a range endpoint of the successor node in the hierarchy 2.

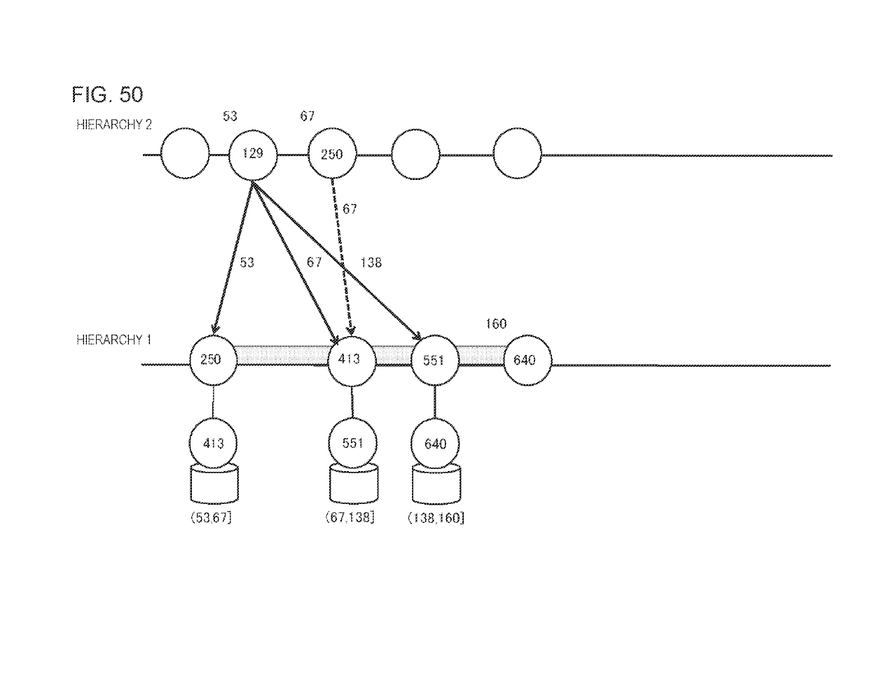

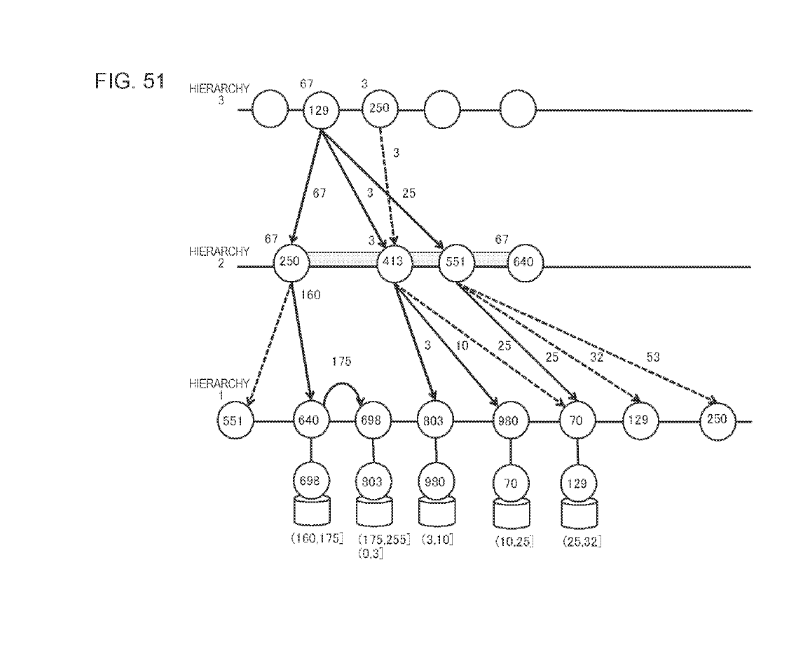

Subsequently, the node corresponding to the logical identifier ID of 129 inquires the node corresponding to the logical identifier ID of 250 which is the first finger node about a range endpoint in the hierarchy 1, and the node corresponding to the logical identifier ID of 250 returns the prestored value. When this process is repeated to the hierarchy 3, a sum of sets of the hierarchy ranges from the hierarchy 1 to the hierarchy 3 include the entire attribute space, and thus the process finishes. In the attribute destination table constructed in this way, the underlined range endpoint illustrated in FIG. 30 is assumed to be changed due to the variation from FIG. 49 to FIG. 51 by the smoothing control unit 422. In addition, in the attribute destination table of each node, it is assumed that only information on the own node and a node which is a successor node is updated, and information on other nodes is not updated.

In order to describe an example of an operation of the single destination resolving unit 342, the attribute destination table of each node is illustrated in FIG. 30.

A description will be made of an example in which the node corresponding to the logical identifier ID of 129 inquires the single destination resolving unit 342 in order to access data on an attribute value of 15 and an attribute value of 0.

In the node corresponding to the logical identifier ID of 129, first, it is determined whether or not the attribute value of 15 is included in a range (32,46] between own node and the successor node, which is a hierarchy range of the hierarchy 1. In FIG. 30, a range endpoint of the successor node is 53, but is thus assumed to be updated since this node is a successor. In this determination, the attribute value of 15 is not included therein, and thus it is determined whether or not the attribute value is included in the hierarchy range (46, 160] of the hierarchy 2.

The node corresponding to the logical identifier ID of 250 is not only a finger node but also a successor node, and thus the change is reflected therein. Also in this determination, the attribute value of 15 is not included therein, and thus it is determined whether or not the attribute value is included in the hierarchy range (67, 67] of the hierarchy 3, which is the entire attribute range. Therefore, it can be seen that the attribute value of 15 is included therein, and it is determined whether or not the attribute value is included in a management region of each finger in relation to the hierarchy 3. The range endpoint of 25 of the third finger is not included in a range [67, 15) of the first finger and the attribute value, and thus it is determined whether or not the attribute value of 3 of the second finger is included in this range. Since the attribute range of 3 is included here, the node corresponding to the logical identifier ID of 413 which is a second finger is inquired about the resolution of a destination of the attribute value of 15 in the hierarchy 2.

In the node corresponding to the logical identifier ID of 413, the same procedure is performed, and, first, it is determined whether or not the attribute value is included in (67, 138] which is the hierarchy range of the hierarchy 1. Since the attribute value of 15 is not included here, subsequently, it is determined whether or not the attribute value is included in the hierarchy range (3, 32] of the hierarchy 2. Since the attribute value of 15 is included here, it is determined whether or not the range endpoint of 25 of the third finger is included in [3, 15) between the range endpoint of 3 of the first finger and the attribute value of 15 in relation to the hierarchy 2. Since the range endpoint of 25 is not included here, it is determined whether or not the range endpoint of 10 of the second finger is included therein. Since the range endpoint of 10 is included here, the node corresponding to the logical identifier ID of 980 which is the second finger is inquired about the attribute value of 15 in the hierarchy 1. At this time, the range endpoint of 3 of the first finger node and the range endpoint of 10 of the logical identifier ID of 980 are also given, and an inquiry thereabout is made.

The node corresponding to the logical identifier ID of 980 performs a process of determining whether or not the received attribute value of 15 is included in the range (17, 25] of the hierarchy 1, but checks a range change before the process. In other words, here, the range endpoint of the own node is updated from 10 to 17. In addition, in the procedure for the single destination resolving process S650 of FIG. 33, it is determined whether or not the range endpoint of 17 of the own node is included in [3, 15) between the received range endpoint of 3 of the finger node and the attribute value of 15 in the hierarchy 1 of the node corresponding to the logical identifier ID of 980. Since the range endpoint of 17 is not included here, the range endpoint of 17 is stored in a notification of range change, and is returned to the node corresponding to the logical identifier ID of 413 as a failure.

The node corresponding to the logical identifier ID of 413 reflects the notification of attribute change, and determines whether or not the finger node 1 is included in [3, 15) between the first finger node which is the next finger and the attribute value of 15, because of the failure. Since the finger node 1 is included here, an access request regarding the attribute value of 15 is relayed (transferred) to the node corresponding to the logical identifier ID of 803.

In the node corresponding to the logical identifier ID of 803, the attribute value is included in (3, 17] between the own node and the successor node, which is a hierarchy range of the hierarchy 0, and thus a communication address of the node corresponding to the logical identifier ID of 413 which is a successor node thereof is returned as the access request regarding the attribute value of 15.

In addition, if the node corresponding to the logical identifier ID of 129 performs data access process on the attribute value of 0, it is sequentially checked whether or not the attribute value is included in the range (32, 46] of the hierarchy 1, is included in the range (46, 160] of the hierarchy 2, and is included in the range (67, 67] of the hierarchy 3. Further, since the hierarchy is the hierarchy 3, a request is further given to the finger node corresponding to the logical identifier ID of 250 in the same procedure. The node corresponding to the logical identifier ID of 250 is included in the range (67, 3] of the hierarchy 2, and the range endpoint of 160 of the finger node 3 is not included in the range [67, 0). For this reason, a request is given to the node corresponding to the logical identifier ID of 640 which is the finger node 3.

The node corresponding to the logical identifier ID of 640 determines whether or not the attribute value is included in the hierarchy range (160, 175] of the hierarchy 1, and the attribute value of 0 is not included here. However, since the hierarchy L given from the logical identifier ID of 250 is 1, the node corresponding to the logical identifier ID of 698 which is a successor transmits a request for acquiring a communication address corresponding to the attribute of 0 in the hierarchy 1. Since the attribute value of 0 is included in (175, 3] between the range endpoint of the own node and the range endpoint of the successor node, the node corresponding to the logical identifier ID of 698 returns the logical identifier ID of 803 thereof as a communication address for the attribute value of 0.

In this way, the logical identifier ID of 129 can reach the overall attribute space through the communication once to four times as illustrated in FIGS. 38 to 40. In addition, as long as the data stored in the logical identifier ID of 129 itself is updated so as to have consistency of a range endpoint of the predecessor node, a destination may be resolved before the hierarchy 1 as the hierarchy 0.

Next, in order to describe an example of an operation of the range destination resolving unit 344, the attribute destination table of each node is illustrated in FIG. 30.

The node corresponding to the logical identifier ID of 129 performs range retrieval on the attribute range (5, 20]. First, an undetermined range set an is set as this range, and is divided into a range included in the hierarchy range (32, 46] of the hierarchy 1 and a range ao not included in the range (32, 46]. Since all of the ranges are given as the range ao not included in the range (32, 46] here, this is set as an undetermined range again, and is divided into a range included in the hierarchy range (46, 138] of the hierarchy 2 and a range not included in the range (46, 138]. In addition, the range is not included in the hierarchy range (46, 138] of the hierarchy 2, and is thus divided again into a range included in the hierarchy range (67, 67] of the hierarchy 3 and a range not included in the range (67, 67]. Since both of the ranges are included here, these are set as an undetermined range set an2, which is divided into a range included in a range (67, 25] of the finger node 1 and the node corresponding to the logical identifier ID of 551 which is the finger node 3 and a range not included in the range (67, 25].

Since both of the ranges are included here, an inquiry about the range not included in the range (67, 25] is not made. In addition, the range is divided into a range included in the range (67, 3] and a range included in the range in (67, 3] in relation to the node corresponding to the logical identifier ID of 413 which is the next finger node. Since neither thereof are included here, the node corresponding to the logical identifier ID of 413 which is the finger node 3 is inquired about the attribute range (5, 20] in the hierarchy 2. In the node corresponding to the logical identifier ID of 413, the attribute range is not included in the hierarchy 1 and is included in the hierarchy 2. Further, the attribute range is divided into a range included in the range (3, 25] of the finger node 1 and the finger node 3 and a range not included in the range (3, 25]. In addition, since both of the ranges are included therein, the range is divided into a range (5, 10] included in the range (3, 10] of the finger node 1 and the finger node 2 and a range (10, 20] not included in the range (3, 10]. On the other hand, in relation to the range not included in the range (3, 10], the node corresponding to the logical identifier ID of 980 which is the finger node 2 is inquired about the range (10, 20] in the hierarchy 1.

At this time, a notification of the range endpoint of 3 of the finger node 1 and the range endpoint of 10 of the finger node 2 is sent. The node corresponding to the logical identifier ID of 980 determines whether or not the range endpoints are included in the hierarchy range (17, 25] of the hierarchy 1. However, since the range endpoint of 3 and the range endpoint of 10 are not included here, and the hierarchy is given as L=1 from the logical identifier ID of 980, it is determined whether or not the range endpoint of 10 as the finger node 2 of which a notification has been sent matches a starting point of the hierarchy range of the hierarchy 1 of the own node, that is, the range endpoint of 17 of the own node. In addition, since the values do not match each other, this is included in a notification of range change. Further, division into a range (10, 17] included in the range (3, 17] and a range (17, 20] not included in the range (3, 17] is performed, and the range (10, 17] included in the range (3, 17] is set as a failure range.

In addition, in relation to the included range (17, 20], the range and a communication address of the successor node are included in a result list. The list is returned to the node corresponding to the logical identifier ID of 413, and the range endpoint of the finger node 2 is updated to 17 in accordance with the notification of range change. Further, the failure range (10, 17] forms an undetermined range set an2 along with a range (5, 10] included in the range regarding the finger node 2. The undetermined range set an2 is not included in (3, 3] which is the next finger range, and thus the node corresponding to the logical identifier ID of 803 inquires about a destination corresponding to the range. The node corresponding to the logical identifier ID of 803 determines whether or not the set is included in the hierarchy range (3, 17] of the hierarchy 1, which is the range endpoint of 3 of the own node and the range endpoint of the successor node. Since the set is included here, this range is set as the node corresponding to the logical identifier ID of 980.

### Example 4

Example 4 of the fourth exemplary embodiment will now be described.

In this example, in the information system 1, a value, which is obtained by converting a multi-dimensional attribute value into a one-dimensional attribute value through a space-filling curve process, is calculated as a range, and an attribute destination table is generated.

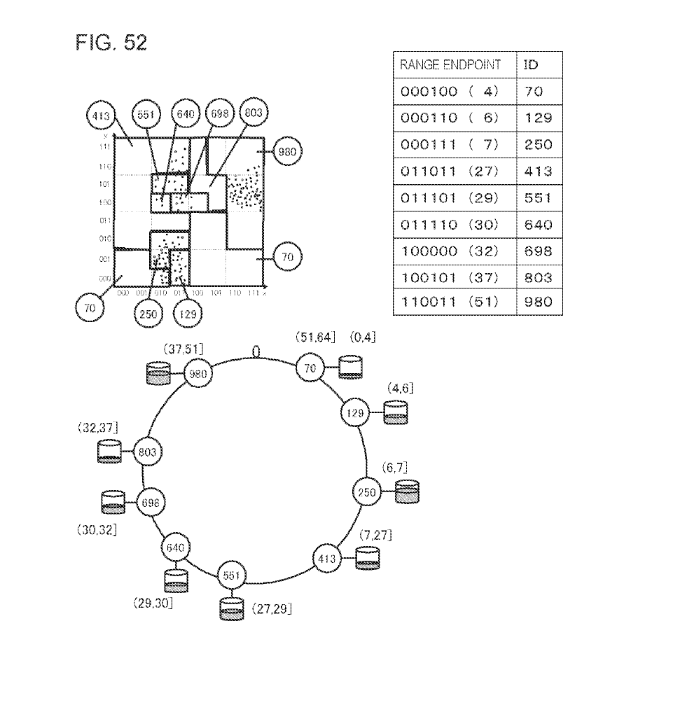

As illustrated in FIGS. 52 to 56, in this example, the attribute destination table stores a value, which is obtained by converting a multi-dimensional attribute value into a one-dimensional attribute value through a space-filling curve process, as a range endpoint.

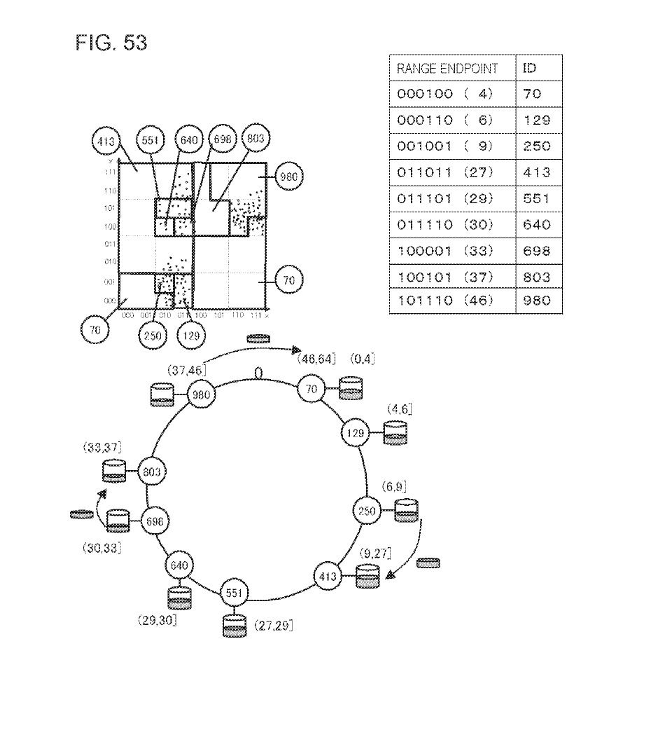

FIGS. 52 and 53 illustrate an example in which an algorithm of the destination resolving process corresponds to the full mesh algorithm of the first exemplary embodiment, and thus the operation request relay server 108 is not provided, and all the nodes have a common attribute destination table.

It is assumed that, when it is defined that a multilayer film attribute is stored in the information system 1, distribution information of data thereon is obtained, and the range endpoint illustrated in the table of FIG. 52 is obtained. This table is an attribute destination table which correlates an IP address of each node with an endpoint of a range managed by the node, and a range endpoint uses a one-dimensional value which is calculated from a logical identifier ID of each node and distribution information by the inverse function unit. In addition, here, in a case where a one-dimensional value which is a range endpoint of each node is converted into a multi-dimensional value through the space-filling curve process, a multi-dimensional partial space which is a range managed by each node is illustrated in FIG. 52. The multi-dimensional range illustrated here may be stored as an attribute destination table. If a distribution varies due to registration of data, and thus a data amount managed by each node varies, as illustrated in FIG. 53, each node performs a range change with an adjacent node. Here, the one-dimensional value which is a range endpoint is changed, and thus a data amount held by each node is changed.

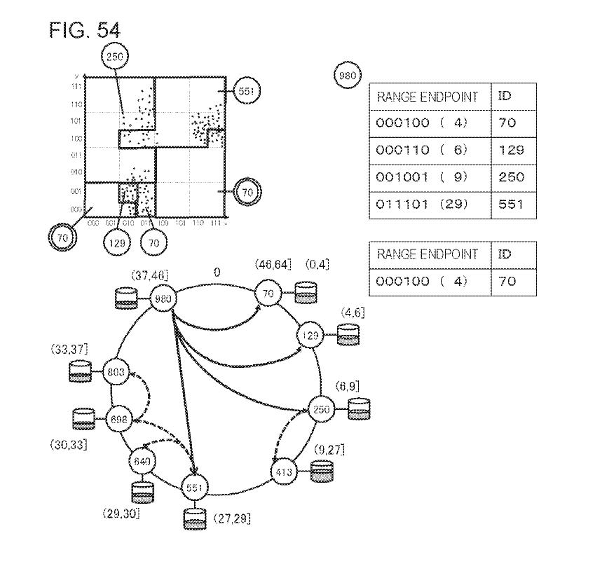

FIGS. 54 to 56 illustrate a request path, for example, when data access is performed by the node 980 on a two-dimensional attribute value (011,100) which is represented in a binary expression. In addition, a one-dimensional value corresponding thereto is 011111 (31). An attribute destination table held by the node 980 is illustrated in FIG. 54. Here, in the attribute destination table, the upper table is a list of a plurality of finger nodes of the node 980, and the lower table includes a successor node.

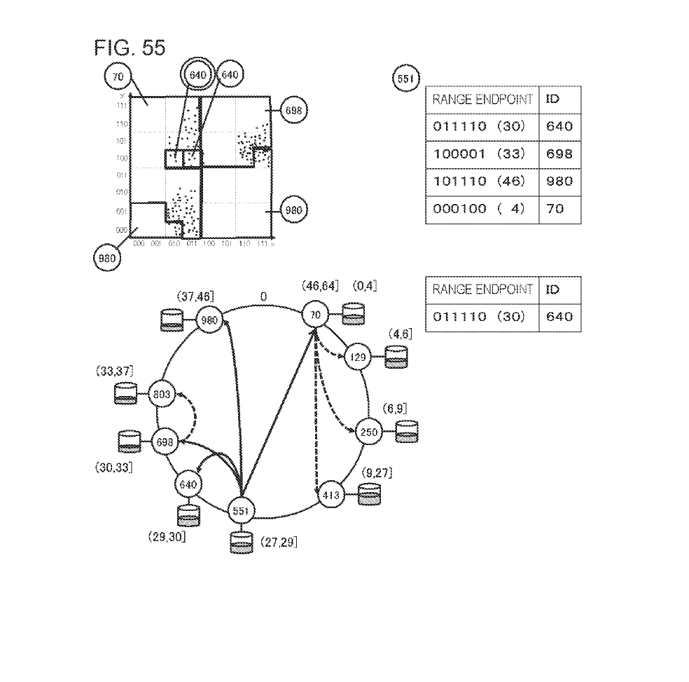

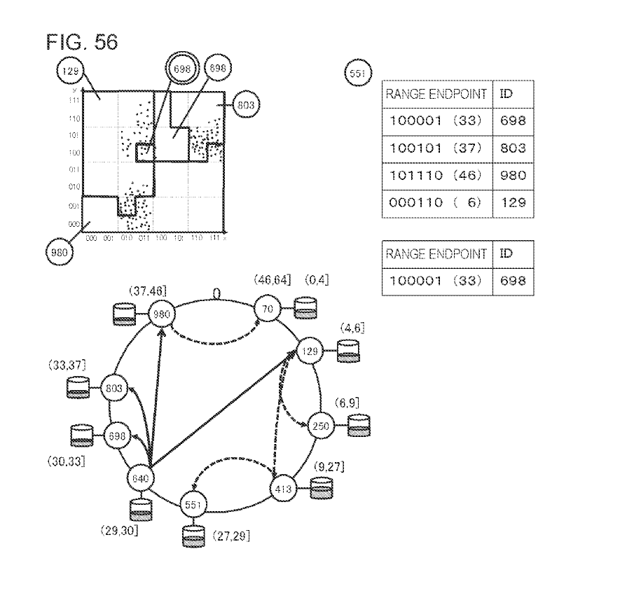

It is checked whether or not a destination of the multi-dimensional attribute value (0111, 1000) corresponds to a value of or after the one-dimensional value 011101 which is the last entry of the attribute destination table by performing the space-filling curve process. Since the value corresponds thereto here, a request is transmitted to the node 551 of this entry. An attribute destination table held by the node 551 is illustrated in FIG. 55. Also here, it is checked whether or not the multi-dimensional attribute value corresponds to a value of or after the last entry 000100 of the attribute destination table, and it is checked that the value does not correspond thereto. Subsequently, the multi-dimensional attribute value is compared with the entries whose range endpoints are 101110, 100001, and 011110, and as the attribute value is a value of or after 011110, a request is transferred to the node 640. An attribute destination table of the node 640 is illustrated in FIG. 56. Here, since the aimed multi-dimensional attribute value (0111, 1000) is present between a range endpoint 100001 of the successor node 698 and a range endpoint 011101 of the own node 640, data access is performed on this node.

As above, the present invention has been described using the exemplary embodiments and the examples, but the present invention is not limited to the exemplary embodiments and the examples. Configurations and details of the present invention may have various modifications that can be understood by those skilled in the art within the scope of the present invention.

This application is based upon and claims the benefit of priority from Japanese Patent Application No. 2011-211132, filed Sep. 27, 2011; the entire contents of which are incorporated herein by reference.

1. An information system comprising:
a plurality of nodes that manage a data constellation in a distributed manner, the plurality of nodes respectively having destination addresses being identifiable on a network;
an identifier assigning unit that assigns logical identifiers to the plurality of nodes on a logical identifier space;
a range determination unit that correlates a range of values of data in the data constellation with the logical identifier space, and determines a range of the data managed by each of the nodes in correlation with the logical identifier of each of the nodes; and
a destination determination unit that obtains, when searching for a destination of a node which stores any data having any attribute value or any attribute range, a logical identifier corresponding to a range of the data which matches at least a part of the attribute value or the attribute range, on the basis of a correspondence relation among the range of the data, the logical identifier, and the destination address, with respect to each of the nodes, and determines the destination address of the node corresponding to the logical identifier as a destination.

2. The information system according to claim 1, further comprising:
a correspondence relation storage unit that stores the correspondence relation for each of the nodes.

3. The information system according to claim 2,
wherein the correspondence relation storage unit of the node holds the correspondence relation for each attribute of the data managed by the node.

4. The information system according to claim 1, further comprising:
a correspondence relation update unit that updates the correspondence relation in accordance with a change of the range of the data managed by the node.

5. The information system according to claim 4, further comprising:
a smoothing control unit that moves at least a part of the data between the nodes having the adjacent logical identifiers in order to manage the data in a distributed manner; and
a range update unit that updates the range of the data which is moved due to the movement of the data,
wherein the correspondence relation update unit updates the correspondence relation in accordance with the update of the range.

6. The information system according to claim 5,
wherein the smoothing control unit compares an amount of data on any attribute managed by the node with an amount of data on the same attribute as the attribute, managed by the other nodes adjacent to the node, and moves the data on the attribute among the node and the other nodes in accordance with a comparison result, and
wherein the range update unit updates the range of the data which is moved due to the movement of the data on the attribute.

7. The information system according to claim 5,
wherein the smoothing control unit determines an amount of data on the attribute to be moved according to a ratio of intervals of the respective logical identifiers of the nodes adjacent to each other.

8. The information system according to claim 4,
wherein the correspondence relation update unit updates the correspondence relation in an asynchronous manner for each of the nodes.

9. The information system according to claim 4, further comprising:
a reception unit that receives an access request to the data and the attribute value or the attribute range related to the data which is a target for the access along with the access request;
a determination unit that determines whether or not the attribute value or the attribute range corresponding to the data which has been received along with the access request is included in a range of the attribute of managed data when the data is accessed on the basis of the access request;
a discrimination unit that compares the range with the attribute value when the determination unit determines that the attribute value or the attribute range is not included in the range of the attribute of the data, and discriminates an adjacent node which manages data of a range of the attribute corresponding to the data which has been received along with the access request on the basis of the comparison result; and
a notification unit that sends a notification of range change indicating a change of the range of the discriminated adjacent node or own node to an access request source or the other nodes.

10. The information system according to claim 9,
wherein the correspondence relation update unit changes the correspondence relation in accordance with the notification of range change.

11. The information system according to claim 4,
wherein the correspondence relation update unit compares an endpoint of the range of all attributes of the data managed by a certain node in the correspondence relation with an endpoint of the range of an attribute of the data which is actually managed by the node, and changes a range of an attribute of the data of the correspondence relation on the basis of the comparison result.

12. The information system according to claim 1, further comprising:
a transfer unit that transfers an access request to the data and the attribute value or the attribute range related to the data to another node,
wherein the destination determination unit determines a destination of a node for accessing the data having the attribute value or the attribute range of the access-requested data, and delivers the determined destination to the transfer unit, and
wherein the transfer unit transfers the access request and the attribute value or the attribute range related to the data to the node corresponding to the destination determined by the destination determination unit.

13. The information system according to claim 1, further comprising:
a unit that allows each node to divide a difference of the logical identifiers between own node and the respective other nodes by a size of the logical identifier space to obtain a remainder as a distance between the own node and the respective other nodes in the logical identifier space so as to select: a node having a minimum distance as an adjacent node; and another node closest to the own node, as a link destination of the own node, from among the other nodes to which are assigned the respective logical identifiers more or equal to a distance apart from the own node by an exponentiation of 2, and
wherein each of the nodes has the link destination and the adjacent node which are at least selected by the own node as destination nodes of own node, and holds, as the correspondence relation, a first correspondence relation between the destination node and the logical identifier of the destination node, and a second correspondence relation between the logical identifier of the destination node and the range for each attribute of the data managed by the node.

14. The information system according to claim 1, further comprising:
a unit that allows each node to divide a difference of the logical identifiers between own node and the respective other nodes by a size of the logical identifier space to obtain a remainder as a distance between the own node and the respective other nodes in the logical identifier space so as to select: a node having the minimum distance as an adjacent node; and nodes, as link destinations of the own node, including one node with the shortest distance from a logical identifier corresponding to a remainder which is obtained by dividing a logical identifier of an integer multiple of own node by the size of the logical identifier space, and the other nodes of a specific number with the shortest distance from the one node,
wherein each of the nodes has the link destination which is at least selected by the own node as a destination node, and holds, as a correspondence relation, a first correspondence relation between the destination node and the logical identifier of the destination node and a second correspondence relation between the logical identifier of the destination node and a range for each attribute of the data managed by the node, and
wherein the second correspondence relation holds a range for each attribute of the data in every hierarchies of the destination nodes.

15. A method for processing data of a management apparatus which manages a plurality of nodes that manages a data constellation in a distributed manner, the plurality of nodes respectively having destination addresses being identifiable on a network, the method for processing data comprising:
assigning, the management apparatus, logical identifiers to the plurality of nodes on a logical identifier space;
correlating, the management apparatus, a range of values of data in the data constellation with the logical identifier space so as to determine a range of the data managed by each of the nodes in correlation with the logical identifier of each of the nodes; and
obtaining, when searching for a destination of a node which stores any data having any attribute value or any attribute range, the management apparatus, a logical identifier corresponding to a range of the data which matches at least a part of the attribute value or the attribute range, on the basis of a correspondence relation among the range of the data, the logical identifier, and the destination address, with respect to each of the nodes, and determines the destination address of the node corresponding to the logical identifier as a destination.

16. A method for processing data of a terminal apparatus which is connected to the management apparatus according to claim 15 and accesses the data through the management apparatus, the method for processing data comprising:
notifying, by the terminal apparatus, an access request for data having an attribute value or an attribute range to the management apparatus; and
accessing, by the terminal apparatus, a destination of the node managing the access-requested data in a range which matches at least a part of the attribute value or attribute range, through the management apparatus on the basis of correspondence relations among destination addresses of the plurality of nodes, logical identifiers assigned to the respective nodes, and ranges of the data managed by the respective nodes, so as to operate the data.

17. A data structure of a destination table which is referred to when determining destinations of a plurality of nodes which manage a data constellation in a distributed manner,
wherein the plurality of nodes respectively have destination addresses being identifiable on a network,
wherein the destination table includes correspondence relations among destination addresses of the plurality of nodes which manage the data constellation in a distributed manner, logical identifiers assigned to the respective nodes on a logical identifier space, and ranges of values of data managed by the respective nodes,
wherein the destination table includes correspondence relations between destination addresses of the plurality of nodes which manage the data constellation in a distributed manner, logical identifiers assigned to the respective nodes on a logical identifier space, and ranges of data managed by the respective nodes, and
wherein, in relation to the ranges of the data of each of the nodes, a range of values of the data in the data constellation is correlated with the logical identifier space, and a range of the data corresponding to the logical identifier of each node is assigned to each node.

18. The data structure according to claim 17,
wherein the correspondence relation of the destination table is held for each of the nodes.

19. The data structure according to claim 17,
wherein the correspondence relation of the destination table is updated in accordance with a change of the range of the data managed by the node.

20. The data structure according to claim 17,
wherein, when at least a part of the data is moved between the nodes of which the logical identifiers are adjacent to each other in order to manage the data in a distributed manner, the range of the data managed by the node is changed, and the correspondence relation of the destination table is updated in accordance with the change of the range.

21. The data structure according to claims 17,
wherein the data structure held in each of the nodes in the destination table as the correspondence relation which is obtained by:
dividing a difference of the logical identifiers between own node and the respective other nodes by a size of the logical identifier space to obtain a remainder as a distance between the own node and the respective other nodes in the logical identifier space;
selecting a node having a minimum distance as an adjacent node, and another node closest to the own node, as a link destination of the own node, from among the other nodes to which are assigned the respective logical identifiers more or equal to a distance apart from the own node by an exponentiation of 2;
setting the link destination and the adjacent node which are at least selected by the own node as destination nodes of own node; and
setting, as the correspondence relation, a first correspondence relation between the destination nodes and the logical identifier of the destination node, and a second correspondence relation between the logical identifier of the destination node and the range for each attribute of the data managed by the node.

22. The data structure according to claim 17,
wherein the data structure held in each of the nodes in the destination table as a correspondence relation which is obtained by:
dividing a difference of the logical identifiers between own node and the respective other nodes by a size of the logical identifier space to obtain a remainder as a distance between the own node and respective other nodes in the logical identifier space;
selecting a node having the minimum distance as an adjacent node, and nodes, as link destinations of the own node, including a node with the shortest distance from a logical identifier corresponding to a remainder which is obtained by dividing a logical identifier of an integer multiple of own node is divided by the size of the logical identifier space, and the other nodes of a specific number with the shortest distance from the one node, as link destinations of own node,
setting the link destination which is at least selected by own node as a destination node; and
setting, as the correspondence relation, a first correspondence relation between the destination node and the logical identifier of the destination node and a second correspondence relation between the logical identifier of the destination node and a range for each attribute of the data managed by the node; and
wherein the second correspondence relation holds a range for each attribute of the data at every hierarchy of the destination node.

23. The data structure according to claim 17,
wherein the correspondence relation of the destination table is updated in an asynchronous manner for each of the nodes.

24. A non-transitory computer-readable storage medium with a program for a computer stored thereon, the program realizing a management apparatus which manages a plurality of nodes that manage a data constellation in a distributed manner, the plurality of nodes respectively having destination addresses being identifiable on a network, the program causing the computer to execute:
a procedure for assigning logical identifiers to the plurality of nodes on a logical identifier space;
a procedure for correlating a range of values of data in the data constellation with the logical identifier space so as to determine a range of the data managed by each of the nodes in correlation with the logical identifier of each node; and
a procedure for obtaining, when searching for a destination of a node which stores any data having any attribute value or any attribute range, the logical identifier corresponding to the range of the data which matches at least a part of the attribute value or the attribute range, on the basis of a correspondence relation among the range of the data, the logical identifier, and the destination address, with respect to each of the nodes so as to determine the destination address of the node corresponding to the logical identifier as a destination.

25. The non-transitory computer-readable storage medium with a program for a computer stored thereon according to claim 24, the program causing the computer to further execute:
a procedure for detecting a change of the range of the data managed by the node; and
a procedure for updating the correspondence relation when the change of the range is detected.

26. The non-transitory computer-readable storage medium with a program for a computer stored thereon according to claim 24, the program causing the computer to further execute:
a procedure for moving at least a part of the data between the nodes having the adjacent logical identifiers in order to manage the data in a distributed manner; and
a procedure for updating the range of the data which is moved due to the movement of the data,
wherein, in the procedure for updating the correspondence relation, the correspondence relation is updated in accordance with the update of the range.

27. A computer readable program recording medium recording thereon the program according to claim 24.

28. A management apparatus which manages a plurality of nodes that manage a data constellation in a distributed manner, the plurality of nodes respectively having destination addresses being identifiable on a network, the management apparatus comprising:
an identifier assigning unit that assigns logical identifiers to the plurality of nodes on a logical identifier space;
a range determination unit that correlates a range of values of data in the data constellation with the logical identifier space, and determines a range of the data managed by each of the nodes in correlation with the logical identifier of each of the nodes; and
a destination determination unit that obtains, when searching for a destination of a node which stores any data having any attribute value or any attribute range, a logical identifier corresponding to a range of the data which matches at least a part of the attribute value or the attribute range, on the basis of a correspondence relation among the range of the data, the logical identifier, and the destination address of each of the nodes, and determines the destination address, with respect to the node corresponding to the logical identifier as a destination.
